(19) United States
(12) Patent Application Publication
(10) Pub. No.: US 2026/0323700 A1
(43) Pub. Date: Oct. 15, 2026

(54) PREEMPTION COORDINATION FOR MULTI-ACCESS POINT COMMUNICATION

(71) Applicant: Ofinno, LLC, Reston, VA (US)

(72) Inventors: Jiayi Zhang, Rockville, MD (US); Leonardo Alisasis Lanante, Reston, VA (US); Esmael Hejazi Dinan, McLean, VA (US); Jeongki Kim, Fairfax, VA (US); Serhat Erkucuk, Reston, VA (US); Tuncer Baykas, Reston, VA (US)

(73) Assignee: Ofinno, LLC, Reston, VA (US)

(21) Appl. No.: 19/685,857

(22) Filed: May 22, 2026

Related U.S. Application Data
(63) Continuation of application No. PCT/US2024/056659, filed on Nov. 20, 2024.
(60) Provisional application No. 63/601,772, filed on Nov. 22, 2023.
(60) Provisional application No. 63/635,654, filed on Apr. 18, 2024.
(60) Provisional application No. 63/643,475, filed on May 7, 2024.

(51) Int. Cl. H04W 74/0816; H04W 76/14

(52) U.S. Cl. CPC H04W 74/0816; H04W 76/14

(57) ABSTRACT

A first access point (AP) receives, from a second AP, a first frame during a transmit opportunity (TXOP) obtained by the second AP. The first frame includes a first field indicating a first duration, within the TXOP, allocated to the first AP, and a second field used to determine whether preemption within the first duration is allowed. The first AP transmits, during the first duration, a second frame including a third field used to determine whether preemption of a third frame following the second frame is allowed, wherein a value of the third field is based on a value of the second field.

### CROSS-REFERENCE TO RELATED APPLICATIONS

This application is a continuation of International Application No. PCT/US2024/056659, filed Nov. 20, 2024, which claims the benefit of U.S. Provisional Application No. 63/601,772, filed Nov. 22, 2023, U.S. Provisional Application No. 63/635,654, filed Apr. 18, 2024, and U.S. Provisional Application No. 63/643,475, filed May 7, 2024, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example Medium Access Control (MAC) frame format.

FIG. 4 illustrates an example management frame which may be used as an action frame.

FIG. 5 illustrates an example control frame which may be used as a trigger frame.

FIG. 6 illustrates an example data frame which may be used as a Quality of Service (QoS) null frame.

FIG. 7 illustrates an example format of a physical layer (PHY) protocol data unit (PPDU).

FIG. 8 illustrates an example multi-AP network.

FIG. 9 illustrates an example network that includes a coordinated AP set.

FIG. 10 illustrates an example multi-AP operation procedure.

FIG. 11 illustrates an example multi-AP sounding phase.

FIG. 12 illustrates an example multi-AP downlink data transmission phase.

FIG. 13 illustrates an example multi-AP uplink data transmission phase.

FIG. 14 illustrates enhanced distributed channel access (EDCA) and coordinated time-division multiple access (CTDMA).

FIG. 15 illustrates an example clear to send (CTS) frame format.

FIG. 16 illustrates an example of a multi-user request-to-send (MU-RTS) trigger frame which may be used in a triggered transmit opportunity (TXOP) sharing (TXS) procedure.

FIG. 17 illustrates an example of a triggered TXS procedure (Mode=1).

FIG. 18 illustrates an example of a triggered TXS procedure (Mode=2).

FIG. 19 illustrates an example of multi-AP operation procedure using CTDMA.

FIG. 20 illustrates another example of an existing CTDMA procedure.

FIG. 21 is an example that illustrates an uplink preemption procedure.

FIG. 22 is an example that illustrates a downlink preemption procedure.

FIG. 23 is an example that illustrates an uplink preemption procedure using a preemption request.

FIG. 24 is an example that illustrates a downlink preemption procedure using a preemption release.

FIG. 25 is an example that illustrates an existing CTDMA procedure.

FIG. 26 is an example that illustrates another existing CTDMA procedure.

FIG. 27 is an example that illustrates a preemption coordination procedure according to an embodiment.

FIG. 28 is an example that illustrates a preemption coordination procedure according to an embodiment.

FIG. 29 is an example that illustrates a preemption coordination procedure according to an embodiment.

FIG. 30 is an example that illustrates a preemption coordination procedure according to an embodiment.

FIG. 31 is an example that illustrates a preemption coordination procedure according to an embodiment.

FIG. 32 illustrates an example trigger frame which may be used according to embodiments.

FIG. 33 illustrates an example action frame which may be used according to embodiments.

FIG. 34 illustrates an example process according to an embodiment of the present disclosure.

FIG. 35 illustrates an example process according to an embodiment of the present disclosure.

FIG. 36 illustrates an example process according to an embodiment of the present disclosure.

FIG. 37 illustrates an example process according to an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

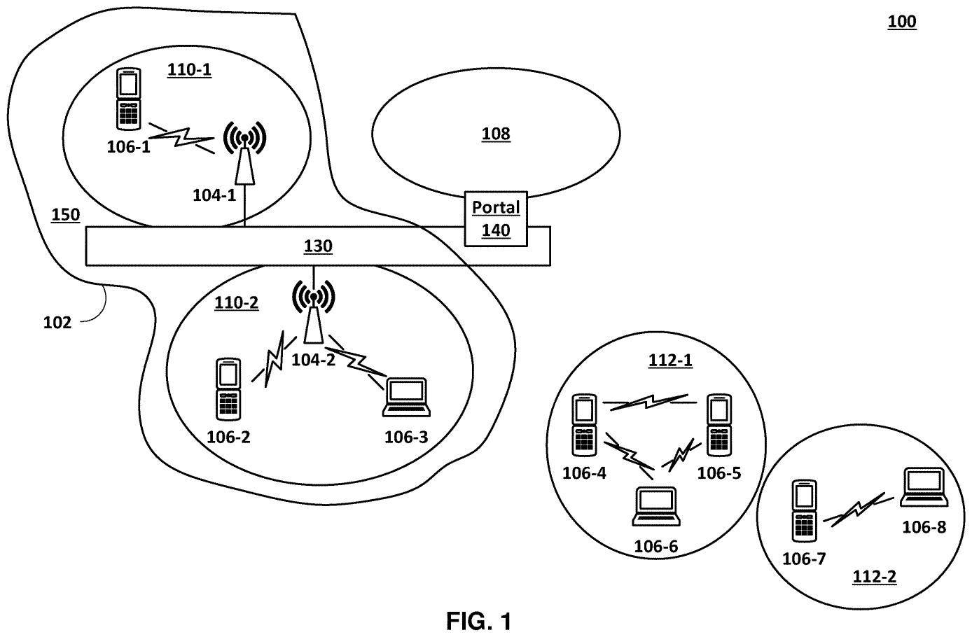

FIG. 1 illustrates example wireless communication networks 100 in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

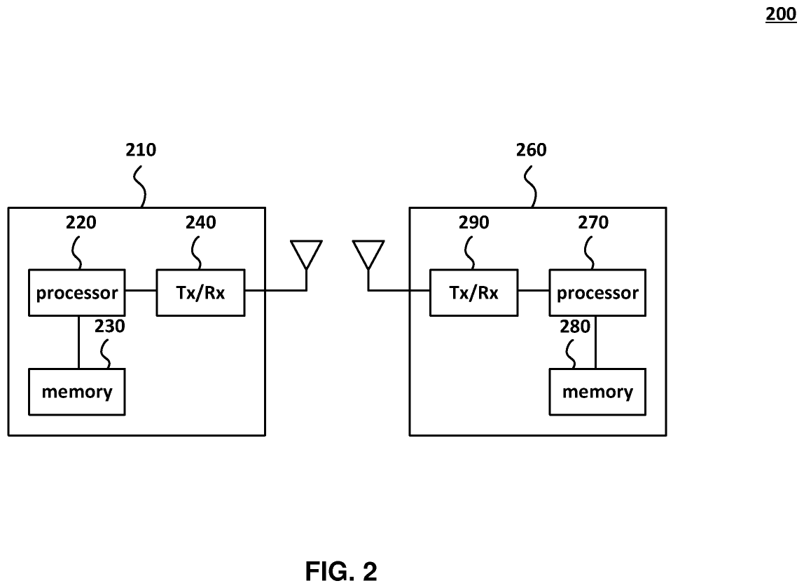

FIG. 2 is a block diagram illustrating example implementations 200 of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

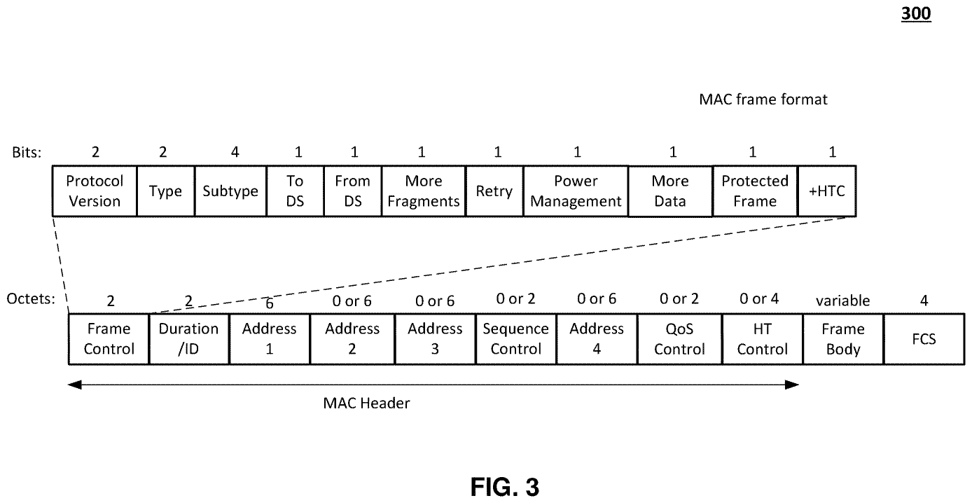

FIG. 3 illustrates an example format of a MAC frame 300. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, MAC frame 300 includes a MAC header, a variable length frame body, and a frame check sequence (FCS).

The MAC header includes a frame control field, an optional duration/ID field (not in PS-Poll frames), address fields, an optional sequence control field, an optional QoS control field (only in QoS Data frames), and an optional high throughput (HT) control field (only in +HTC frames).

The frame control field includes the following subfields: protocol version, type, subtype, To DS, From DS, more fragments, retry, power management, more data, protected frame, and high throughput control (+HTC).

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contains no frame body field.

The To DS subfield indicates whether a data frame is destined to the DS. The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (BUs) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that MAC frame 300 contains an HT control field. A frame that contains the HT Control field is referred to as a +HTC frame. A Control Wrapper frame is a +HTC frame.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that indicates to a STA an amount of time during which it must defer from accessing the shared medium.

There can be up to four address fields in the format of MAC frame 300. These fields are used to indicate the basic service set identifier (BSSID), source address (SA), destination address (DA), transmitter address (TA), and receiver address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which MAC frame 300 belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field. The control frame subtype for which HT control field is present is the control wrapper frame. A control frame that is described as +HTC (e.g., a request to send (RTS)+HTC, clear to send (CTS)+HTC, block acknowledgment (BlockAck)+HTC or block acknowledgment request (BlockAckReq)+HTC frame) implies the use of the control wrapper frame to carry that control frame.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

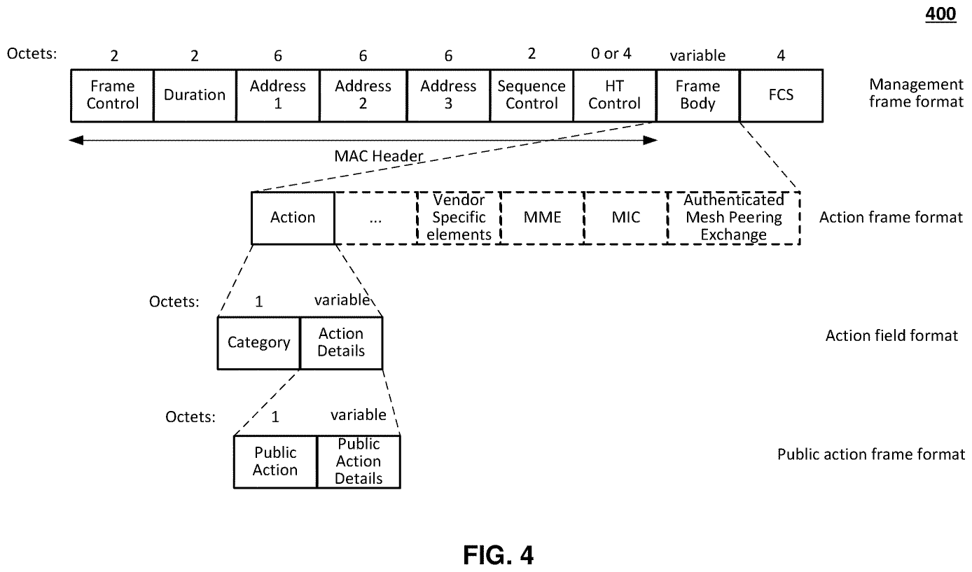

FIG. 4 illustrates an example management frame 400 which may be used as an action frame. In an example, management frame 400 includes a MAC header, a variable length frame body, and a frame check sequence (FCS). The MAC header includes a frame control field, a duration field, an address 1 field, an address 2 field, an address 3 field, a sequence control field, and an optional HT control field. The presence of the HT control field is determined by the setting of a +HTC subfield of the frame control field.

As shown in FIG. 4, when used as an action frame, the frame body of management frame includes an action field, vendor specific elements, management message integrity code element (MME), message integrity code (MIC), and an authenticated mesh peering exchange element.

The action field includes a category field and an action details field. The action field provides a mechanism for specifying extended management actions. The category field indicates a category of the action frame. The action details field contains the details of the action requested by the action frame. For example, the action frame may be a public action frame. As shown in FIG. 4, in the public action frame format, the action details field includes a public action field, in the octet immediately after the category field, followed by a variable length public action details field.

One or more vendor specific elements are optionally present. These elements are absent when the category subfield of the Action field is vendor-specific.

The MME is present when management frame protection is negotiated, the frame is a group addressed robust Action frame, and (MBSS only) the category of the action frame does not support group addressed privacy as indicated by category values; otherwise not present.

The MIC element is present in a self-protected action frame if a shared pairwise master key (PMK) exists between the sender and recipient of this frame; otherwise not present.

The authenticated mesh peering exchange element is present in a self-protected action frame if a shared PMK exists between the sender and recipient of this frame; otherwise not present.

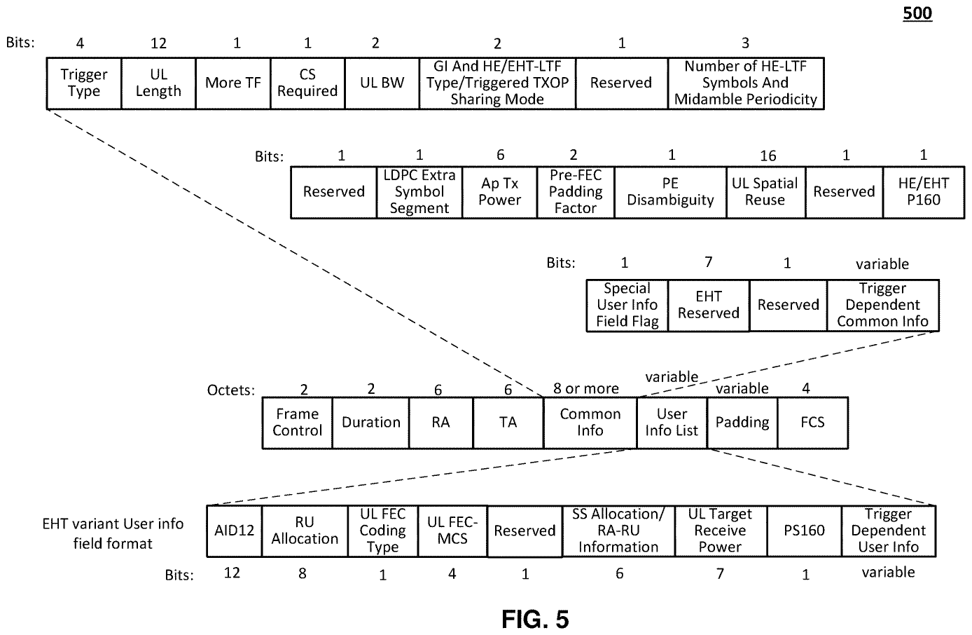

FIG. 5 illustrates an example format of a trigger frame 500. Trigger frame 500 may be used by an AP to allocate resources for and solicit one or more TB PPDU transmissions from one or more STAs. Trigger frame 500 may also carry other information required by a responding STA to transmit a TB PPDU to the AP.

As shown in FIG. 5, trigger frame 500 includes a Frame Control field, a Duration field, a receiver address (RA) field, a transmitter address (TA) field, a Common Info field, a User Info List field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 500 if trigger frame 500 is addressed to STAs that belong to a single BSS. The TA field is the transmitted BSSID if trigger frame 500 is addressed to STAs from at least two different BSSs of the multiple BSSID set.

The Common Info field specifies a trigger frame type of trigger frame 500, a transmit power of trigger frame 500 in dBm, and several key parameters of a TB PPDU that is transmitted by a STA in response to trigger frame 500. The trigger frame type of a trigger frame used by an AP to receive QoS data using UL MU operation is referred to as a basic trigger frame. A non-EHT non-AP HE STA interprets the Common Info field as HE variant. A non-AP EHT STA interprets the Common Info field as HE variant if B54 and B55 in the Common Info field are equal to 1; and interprets the Common Info field as EHT variant otherwise. The HE variant Common Info field and the EHT variant Common Info field use the same encoding method for the Trigger Type, UL Length, More TF, CS Required, LDPC Extra Symbol Segment, AP TX Power, Pre-FEC Padding Factor, PE Disambiguity, and Trigger Dependent Common Info subfields.

The User Info List field contains zero or more User Info fields. There are three variants for the User Info field, which are the Special User Info field, the EHT variant User Info field, and the HE variant User Info field.

The Special User Info field is a User Info field that does not carry the user specific information but carries the extended common information not provided in the Common Info field. If the Special User Info field is included in the Trigger frame, then the Special User Info Field Flag subfield of the EHT variant Common Info field is set to 0, otherwise it is set to 1. The Special User Info field is identified by an AID12 value of 2007 and is optionally present in a Trigger frame that is generated by an EHT AP. The Special User Info field, if present, is located immediately after the Common Info field of the Trigger frame and carries information for the U-SIG field of a solicited EHT TB PPDU. The PHY Version Identifier subfield indicates the PHY version of the solicited TB PPDU that is not an HE TB PPDU. The PHY Version Identifier subfield is set to 0 for EHT. Other values from 1 to 7 are reserved. The UL Bandwidth (BW) Extension subfield, together with the UL BW subfield in the Common Info field, indicates the bandwidth of the solicited TB PPDU from the addressed EHT STA (i.e., the bandwidth in the U-SIG field of the EHT TB PPDU). The EHT Spatial Reuse n subfield carries the values to be included in the corresponding Spatial Reuse n subfield in the U-SIG field of the EHT TB PPDU. The U-SIG Disregard And Validate subfield carries the values to be included in the Disregard and Validate subfields of the U-SIG field of the solicited EHT TB PPDUs. The presence and length of the Trigger Dependent User Info subfield in the Special User Info field depends on the variant of the Trigger frame.

The EHT variant User Info field contains a User Info field per STA addressed in trigger frame 500. The per STA User Info field includes, among others, an AID12 subfield, an RU Allocation subfield, a UL FEC Coding Type subfield, a UL EHT-MCS subfield, a Reserved subfield, a Spatial Stream (SS) Allocation/RA-RU information subfield, a UL Target Receive Power subfield, and a Power Save (PS) 160 subfield to be used by a STA in a TB PPDU transmitted in response to trigger frame 500, and a Trigger Dependent User Info subfield. The RU Allocation subfield in an EHT variant User Info field in a Trigger frame that is not an MU-RTS Trigger frame, along with the UL BW subfield in the Common Info field, the UL BW Extension subfield in the Special User Info field, and the PS160 subfield in the EHT variant User Info field, identifies the size and the location of the RU or MRU. The values of PS160 subfield and B0 of RU Allocation subfield indicate the 80 MHz frequency subblock in which the RU or MRU is located for 26-tone RU, 52-tone RU, 106-tone RU, 242-tone RU, 484-tone RU, 996-tone RU, 52+26-tone RU, and 106+26-tone RU. The values of PS160 subfield indicates the 160 MHz segment in which the RU or MRU is located for 2□996-tone RU, 996+484-tone MRU, and 996+484+242-tone MRU. The UL FEC Coding Type subfield of the User Info field indicates the code type of the solicited EHT TB PPDU. The UL FEC Coding Type subfield is set to 0 to indicate BCC and set to 1 to indicate LDPC. The UL EHT-MCS subfield of the User Info field indicates the EHT-MCS of the solicited EHT TB PPDU. The SS Allocation subfield of the EHT variant User Info field indicates the spatial streams of the solicited EHT TB PPDU. The UL Target Receive Power subfield indicates the expected receive signal power, measured at the AP's antenna connector and averaged over the antennas, for the EHT portion of the EHT TB PPDU transmitted on the assigned RU. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA. The RA-RU Information subfield is reserved in the EHT variant User Info field.

The Padding field is optionally present in trigger frame 400 to extend the frame length to give recipient STAs enough time to prepare a response for transmission one SIFS after the frame is received. The Padding field, if present, is at least two octets in length and is set to all 1s.

The FCS field is used by a STA to validate a received frame and to interpret certain fields from the MAC headers of a frame.

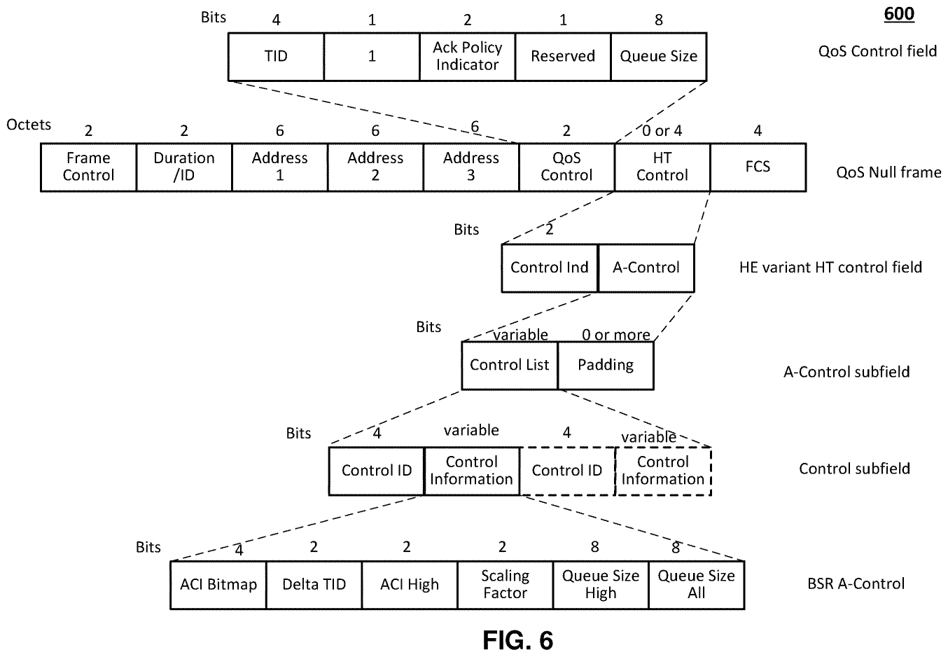

FIG. 6 illustrates an example data frame 600 which may be used as a QoS null frame. A QoS null frame refers to a QoS data frame with an empty frame body. QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an acknowledgment (Ack) policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the Ack policy followed upon delivery of the MPDU (e.g., normal Ack, implicit block Ack request, no Ack, block Ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine the TXOP duration assigned to the STA or to determine the uplink (UL) resources assigned to the STA.

In a frame sent by or to a non-high efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:
QS=
   16×UV, If SF is equal to 0;
   1024+256×UV, if SF is equal to 1;
   17 408+2048×UV, if SF is equal to 2;
   148 480+32 768×UV, if SF is equal to 3 and UV is less than 62;
   2 147 328, if SF equal to is 3 and UV is equal to 62;
   Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include an aggregated control (A-Control) subfield. The A-Control subfield may include a control list subfield including one or more control subfields.

The control subfield may be a BSR control subfield, which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

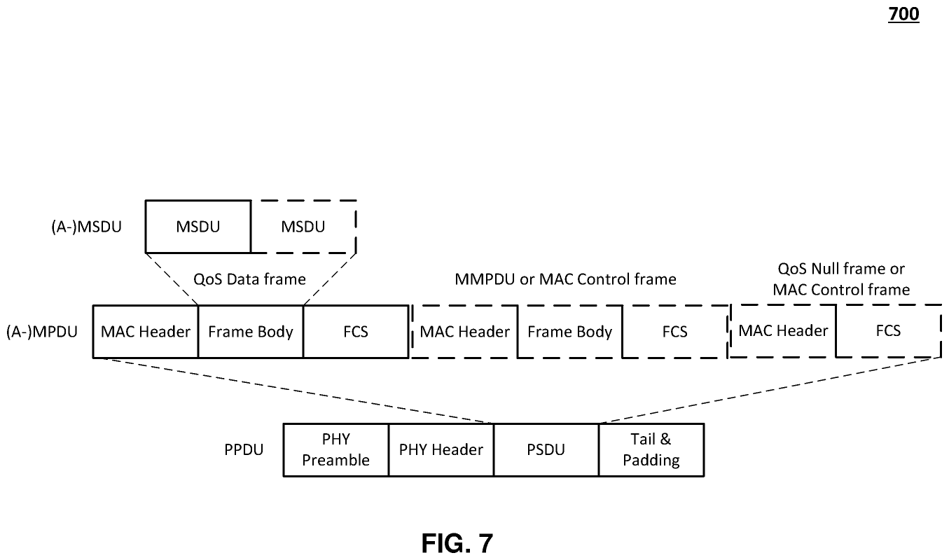

FIG. 7 illustrates an example format 700 of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in an UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

A multi-link device (MLD) is an entity capable of managing communication over multiple links. The MLD may be a logical entity and may have more than one affiliated station (STA). An MLD may be an access point MLD (AP MLD) where a STA affiliated with the MLD is an AP STA (or an AP). An MLD may be a non-access point MLD (non-AP MLD) where a STA affiliated with the MLD is a non-AP STA (or an STA).

Communication across different frequency bands/channels may occur simultaneously, or not, depending on the capabilities of both the communicating AP MLD and non-AP MLD.

An MLD may have a single MAC service access point (MAC-SAP) to the LLC layer, which includes a MAC data service. The MLD may support multiple MAC sublayers, coordinated by a sublayer management entity (SME). Each AP STA (or non-AP STA) affiliated with an AP MLD (or non-AP MLD) has a different MAC address within the MLD.

The SME is responsible for coordinating the MAC sublayer management entities (MLMEs) of the affiliated STAs of the MLD to maintain a single robust security network association (RSNA) key management entity as well as a single IEEE 802.1X Authenticator or Supplicant for multi-link operation (MLO).

Multi-link operation (MLO) procedures allow a pair of MLDs to discover, synchronize, (de)authenticate, (re)associate, disassociate, and manage resources with each other on any common bands or channels that are supported by both MLDs. The Authenticator and the MAC-SAP of an AP MLD may be identified by the same AP MLD MAC address. The Supplicant and the MAC-SAP of a non-AP MLD may be identified by the same non-AP MLD MAC address.

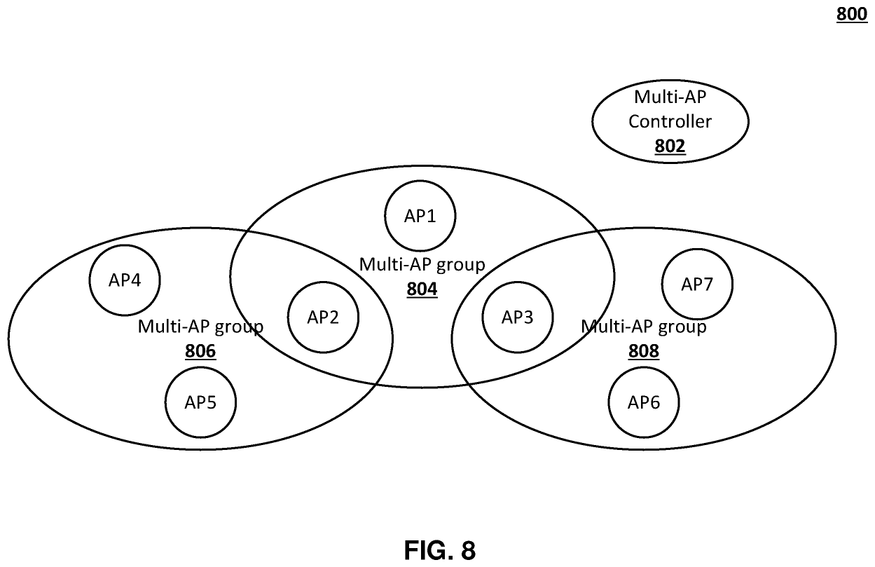

FIG. 8 illustrates an example multi-AP network 800. Example multi-AP network 800 may be a multi-AP network in accordance with the Wi-Fi Alliance standard specification for multi-AP networks. As shown in FIG. 8, multi-AP network 800 may include a multi-AP controller 802 and a plurality of multi-AP groups (or multi-AP sets) 804, 806, and 808.

Multi-AP controller 802 may be a logical entity that implements logic for controlling the APs in multi-AP network 800. Multi-AP controller 802 may receive capability information and measurements from the APs and may trigger AP control commands and operations on the APs. Multi-AP controller 802 may also provide onboarding functionality to onboard and provision APs onto multi-AP network 800.

Multi-AP groups 804, 806, and 808 may each include a plurality of APs. APs in a multi-AP group are in communication range of each other and may coordinate their transmissions and/or transmissions from their associated STAs. Coordinated transmissions may involve all or a subset of the APs in a multi-AP group. A multi-AP group may also be referred to as an AP candidate set as APs in a multi-AP group are considered candidates for a coordinated transmission initiated by an AP. The APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, a multi-AP group may be established by a coordinator AP in a multi-AP setup phase prior to any multi-AP coordination. APs of the multi-AP group, other than the coordinator AP, may be referred to as the coordinated APs. A coordinator AP may establish one or more multi-AP groups. A coordinated AP may likewise be a member of multiple multi-AP groups. A coordinator AP of a multi-AP group may be a coordinated AP of another multi-AP group, and vice versa. In another approach, a multi-AP group may be established by a network administrator manually by configuring APs as part of the multi-AP group. In yet another approach, a multi-AP group may be established in a distributed manner by APs without a central controller. In this case, an AP may advertise its multi-AP capability in a beacon or other management frame (e.g., public action frame). Other APs that receive the frame with the multi-AP capability information may perform a multi-AP setup with the AP that advertised the multi-AP capability.

In one approach, one of the APs in a multi-AP group may be designated as a master AP. The designation of the master AP may be done by multi-AP controller 802 or by the APs of the multi-AP group. The master AP of a multi-AP group may be fixed or may change over time between the APs of the multi-AP group. An AP that is not the master AP of the multi-AP group is known as a slave AP.

In one approach, APs in a multi-AP group may perform coordinated transmissions together. One aspect of coordination may include coordination to perform coordinated transmissions within the multi-AP group. As used herein, a coordinated transmission, also referred to as a multi-AP transmission, is a transmission event in which multiple APs (of a multi-AP group or a multi-AP network) transmit in a coordinated manner over a time period. Coordinated transmissions may involve simultaneous transmissions of a plurality of APs in a multi-AP group. The time period of simultaneous AP transmission may be a continuous period. The multi-AP transmission may use different transmission techniques, such as Coordinated OFDMA (COFDMA), Coordinated Spatial Reuse (CSR), Joint Transmission or Reception (JT/JR), Coordinated Beamforming (CBF), and CTDMA, or a combination of two or more of the aforementioned techniques.

Multi-AP group coordination may be enabled by the multi-AP controller and/or by the master AP of the multi-AP group. In one approach, the multi-AP controller and/or the master AP may control time and/or frequency sharing in a transmission opportunity (TXOP). For example, when one of the APs (e.g., the master AP) in the multi-AP group obtains a TXOP, the multi-AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Different multi-AP transmission schemes may be suitable for different use cases in terms of privacy protection, including whether transmitted data may be shared with other BSSs in the multi-AP group. For example, some multi-AP transmission schemes, such as CSR, CDTMA, coordinated frequency division multiple access (CFDMA), COFDMA, and CBF, enable a master AP to coordinate slave APs by sharing control information among APs, without requiring the sharing of user data among APs. The control information may include BSS information of APs, link quality information of channels between each AP and its associated STAs, and information related to resources to be used to achieve multiplexing in power, time, frequency, or special domains for multi-AP transmission. The control information exchanged among a master AP and slave APs may be used for interference avoidance or nulling to avoid or null co-channel interference introduced to neighboring BSSs in a multi-AP network. Interference avoidance or interference nulling requires that data transmissions between an AP and STAs are only within the same BSS. In other words, each AP transmits or receives data frames to or from its associated STAs, while each STA receives or transmits data frames to or from its associating AP.

By contrast, other multi-AP transmission schemes may enable a master AP to coordinate slave APs by sharing both control information and user data among APs in a multi-AP group. Control information may include BSS information related to APs and link quality information of channels between each AP and its associated STAs. By having user data exchanged over backhaul, the master AP and slave APs may perform data transmissions jointly to achieve spatial diversity, e.g., using distributed MIMO, for example, joint transmission (JT) for downlink transmissions and joint reception (JR) for uplink transmissions. The data transmissions between APs and STAs may include transmissions within the same BSS and/or across different BSSs. In other words, an AP may transmit or receive data frames to or from its associated STAs as well STAs associated with other APs participating in multi-AP transmission. Similarly, a STA may transmit or receive data frames to or from multiple APs.

Different multi-AP transmission schemes may be suitable for different use cases in terms of signal reception levels at STAs or APs within a multi-AP group. For example, CBF and JT/JR require that each STA involved in a multi-AP transmission be located within a common area of signal coverage of the APs involved in the multi-AP transmission. Generally, CBF may be suitable when a receiving STA suffers from potential interference from other APs in the multi-AP group. By using channel related information such as channel state information (CSI), channel quality indication (CQI), or compressed beamforming (BF) feedback exchanged among APs, an AP may pre-code a signal to be transmitted to form a beam that increases power toward a target STA while reducing the power that interferes with a STA associated with a neighboring AP. Use cases of JT/JR may require a sufficient received signal power at receiving STAs for JT and a sufficient received signal power at receiving APs for JR. By contrast, CSR may perform multi-AP transmission in an interference coordination manner. The received signal power at a STA associated with an AP transmitting data may be required to be much higher than the received interference power.

Different multi-AP transmission schemes may require different synchronization levels and may operate with or without a backhaul between a master AP and slave APs in a multi-AP group. For example, CSR may require PPDU-level synchronization, whereas CBF may require symbol-level synchronization. On the other hand, JT/JR may require tight time/frequency/phase-level synchronization as well as a backhaul for data sharing between APs in the multi-AP group.

Different multi-AP transmission schemes may have different complexity levels with regard to coordination between a master AP and slave APs in a multi-AP group. For example, JT/JR may require very high complexity due to both CSI and user data being shared between APs. CBF may require medium complexity due to the sharing of CSI. CFDMA, COFDMA and CTDMA may require medium or relatively low complexity due to the CSI and time/frequency resources to be shared between APs. CSR may require low complexity as the amount of information related to spatial reuse and traffic that needs to be exchanged between APs may be low.

A multi-AP group may adopt a static multi-AP operation including a static multi-AP transmission scheme. A multi-AP network may also be dynamic due to various reasons. For example, a STA may join or leave the multi-AP network, a STA may switch to a power save mode, or an AP or a STA may change its location. Such changes may lead to changes in the conditions underlying the selection of the multi-AP transmission scheme and may cause certain requirements (e.g., synchronization, backhaul, coordination, etc.) for the multi-AP transmission scheme to be lost. This results in an inferior quality of transmissions in the multi-AP network.

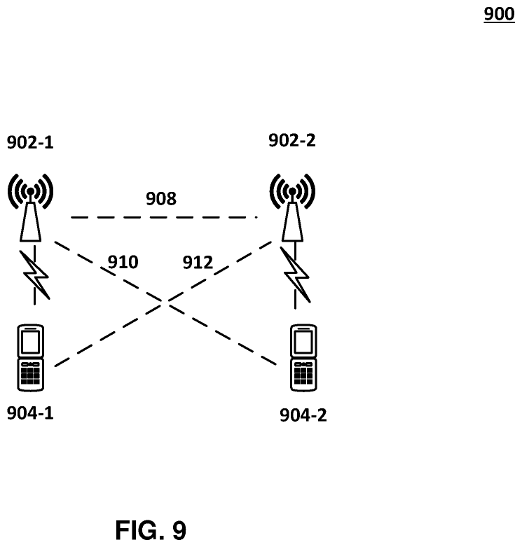

FIG. 9 illustrates an example network 900 that includes a coordinated AP set. As shown in FIG. 9, the coordinated AP set may include AP 902-1 and AP 902-2. The coordinated AP set may be a subset of an established multi-AP group. At least one STA may be associated with each of APs 902-1 and 902-2. For example, a STA 904-1 may be associated with AP 902-1, and a STA 904-2 may be associated with AP 902-2.

APs 902-1 and 902-2 may belong to the same ESS as described above in FIG. 1. In such a case, APs 902-1 and 902-2 may be connected by a DS to support ESS features. In addition, as part of a coordinated AP set, APs 902-1 and 902-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 902-1 and 902-2 may act as a Master AP and the other as a Slave AP. The Master AP is the AP that is the owner of the TXOP. The Master AP shares frequency resources during the TXOP with the Slave AP. When there are more than two APs in the coordinated set, a Master AP may share its TXOP with only a subset of the coordinated AP set. The role of the Master AP may change over time. For example, the Master AP role may be assigned to a specific AP for a duration of time. Similarly, the Slave AP role may be chosen by the Master AP dynamically or can be pre-assigned for a duration of time.

Depending on the capability of APs in a coordinated AP set, the APs may only do certain type of coordinated transmissions. For example, in FIG. 9, if AP 902-1 supports JT and CSR while AP 902-2 supports CSR and CBF, both APs may only perform CSR as a coordinated transmission scheme. An AP may also prefer to perform single AP transmissions for a duration of time if the benefit of coordinated transmission does not outweigh some disadvantages with coordinated transmission such as reduced flexibility and increased computational power required.

CSR is one type of multi-AP coordination that may be supported by AP 902-1 and AP 902-2 as shown in FIG. 9. Spatial reuse using CSR can be more stable than non-AP coordinated spatial reuse schemes such as overlapping basic service set (OBSS) packet detect (PD)-based SR and PSR-based SR. For example, in an example network 900, APs 902-1 and 902-2 may perform a joint sounding operation in order to measure path loss (PL) on paths of network 900. For example, the joint sounding operation may result in the measurement of PL 908 for the path between APs 902-1 and 902-2, path loss 910 for the path between AP 902-1 and STA 904-2, and path loss 912 for the path between AP 902-2 and STA 904-1. The measured path loss information may then be shared between APs 902-1 and 902-2 (e.g., using the backhaul) to allow for simultaneous transmissions by APs 902-1 and 902-2 to their associated STAs 904-1 and 904-2 respectively. Specifically, one of APs 902-1 and 902-2 obtains a TXOP to become the Master AP. The Master AP may then send a CSR announcement frame to the other AP(s). In an embodiment, the Master AP may perform a polling operation, before sending the CSR announcement frame, to poll Slave APs regarding packet availability for transmission. If at least one Slave AP responds indicating packet availability, the Master AP may proceed with sending the CSR announcement frame. In the CSR announcement, the Master AP may limit the transmit power of a Slave AP in order to protect its own transmission to its target STA. The Slave AP may similarly protect its own transmission to its target STA by choosing a modulation scheme that enables a high enough Signal to Interference Ratio (SIR) margin to support the interference due to the transmission of the Master AP to its target STA.

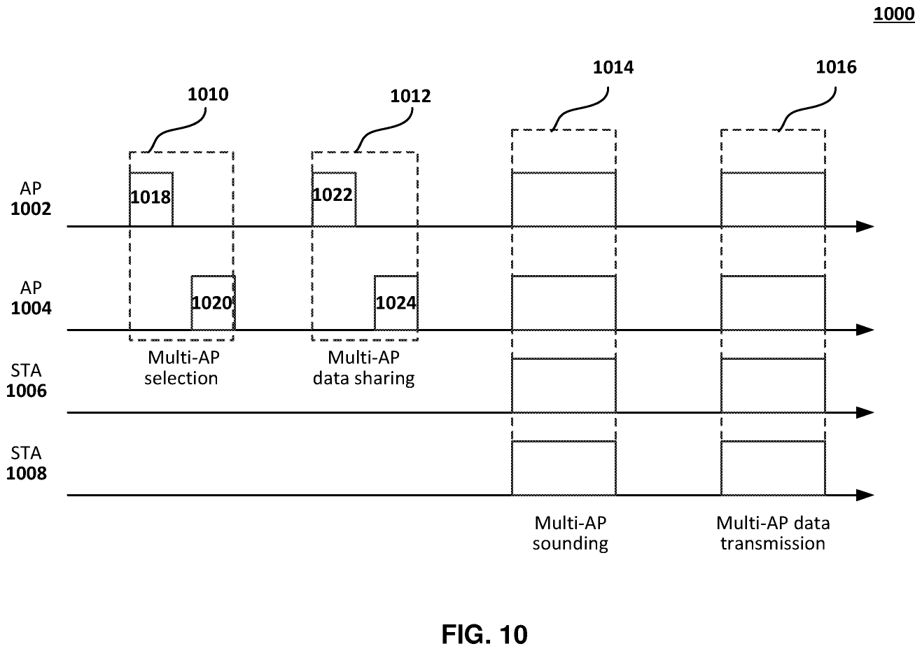

FIG. 10 illustrates an example 1000 of a multi-AP operation procedure. In example 1000, the multi-AP operation procedure is illustrated with respect to a multi-AP network that includes APs 1002 and 1004 and STAs 1006 and 1008. In an example, APs 1002 and 1004 may form a multi-AP group. AP 1002 may be the master AP and AP 1004 may be a slave AP of the multi-AP group. For example, AP 1002 may obtain a TXOP making it the master AP of the multi-AP group. Alternatively, AP 1002 may be designated as the master AP by a multi-AP controller.

As shown in FIG. 10, the multi-AP operation procedure may include a series of phases in time, each of which may contain a plurality of frame exchanges within the multi-AP network. Specifically, the multi-AP operation procedure may include a multi-AP selection phase 1010, a multi-AP data sharing phase 1012, a multi-AP sounding phase 1014, and a multi-AP data transmission phase 1016.

A multi-AP network may carry out a multi-AP operation based on a specific multi-AP transmission scheme. The multi-AP transmission scheme may be chosen by the master AP based on the capabilities of the slave APs in a multi-AP group. Prior to a multi-AP operation, a slave AP may inform the master AP of capability information related to the slave AP, including the capabilities of supporting one or more multi-AP transmission schemes. The slave AP may also inform the master AP of BSS information of the BSS of the slave AP and of link quality information for STAs associated with the slave AP. The master AP may receive information related to all available slave APs. The information related to slave APs may include capability information, BSS information, and link quality information. Based on the information provided by available slave APs, the master AP may determine during a multi-AP selection phase the slave APs to be designated for a multi-AP transmission and a specific multi-AP transmission scheme to be used during the multi-AP transmission.

Multi-AP selection phase 1010 may include procedures for soliciting, selecting, or designating slave AP(s) for a multi-AP group by a master AP. As seen in FIG. 10, the multi-AP selection phase may include transmissions of frame 1018 from AP 1002 and frame 1020 from AP 1004. AP 1002 may transmit frame 1018 to solicit information regarding the buffer status of AP 1004. In response, AP 1004 may transmit frame 1020 to inform AP 1002 of its and its associated STAs buffer status and/or whether it intends to join multi-AP operation. Multi-AP selection phase 1010 may also be used to exchange information related to multi-AP operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, information regarding MIMO capabilities of the AP, etc. Link quality information may include received signal strength indicator (RSSI), signal-to-noise ratio (SNR), signal-to-interference-plus-noise-ratio (SINR), channel state information (CSI), channel quality indicator (CQI).

Multi-AP data sharing phase 1012 may include procedures for sharing data frames to be transmitted by APs to associated STAs among the master AP and selected slave AP(s) via direct connections between APs. Phase 1012 may be optional for some multi-AP data transmission schemes. For example, phase 1012 may be required for JT/JR as data frames may be exchanged between APs before or after multi-AP data transmission phase 1016.

Multi-AP data sharing phase 1012 may be performed using a wired backhaul, an in-channel wireless backhaul, or an off-channel wireless backhaul. In some cases, multi-AP data sharing phase 1012 may be performed over an in-channel backhaul, e.g., using the same wireless channel used to transmit/receive data to/from STAs. For example, as shown in FIG. 10, in phase 1012, AP 1002 may transmit a frame 1022, which may be received by AP 1004. Frame 1022 may include MPDUs that AP 1002 wishes to transmit to associated STAs using a multi-AP operation. Similarly, AP 1004 may transmit a frame 1024, which may be received by AP 1002. Frame 1024 may include MPDUs that AP 1004 wishes to transmit to associated STAs using a multi-AP operation.

Multi-AP sounding phase 1014 may include procedures for multi-AP channel sounding, including channel estimation and feedback of channel estimates among the master AP, candidate slave AP(s), and associated STAs. Phase 1014 may be optional for some multi-AP transmission schemes, such as COFDMA, CDTMA, and CSR. For example, phase 1014 may be performed by the master AP to aid in resource unit allocation when orchestrating a COFDMA transmission.

Multi-AP data transmission phase 1016 may include exchange of data frames between the master AP, slave AP(s), and their associated STAs based on multi-AP transmission scheme(s) determined by the master AP. Depending on the multi-AP transmission scheme(s) to be used, phase 1016 may include optional synchronization between APs of the multi-AP group, before exchange of data frames between APs and STAs within the multi-AP group.

The order of phases 1010, 1012, 1014 and 1016 may be different than shown in FIG. 10. For example, in COFDMA, phase 1016 may occur immediately after phase 1010, whereas, in JT/JR, phase 1012 may occur after phase 1010. Further, as mentioned above, some phases may be optional and may or may not be present. For example, phase 1014 may not be required for COFDMA but may be required for JT/JR.

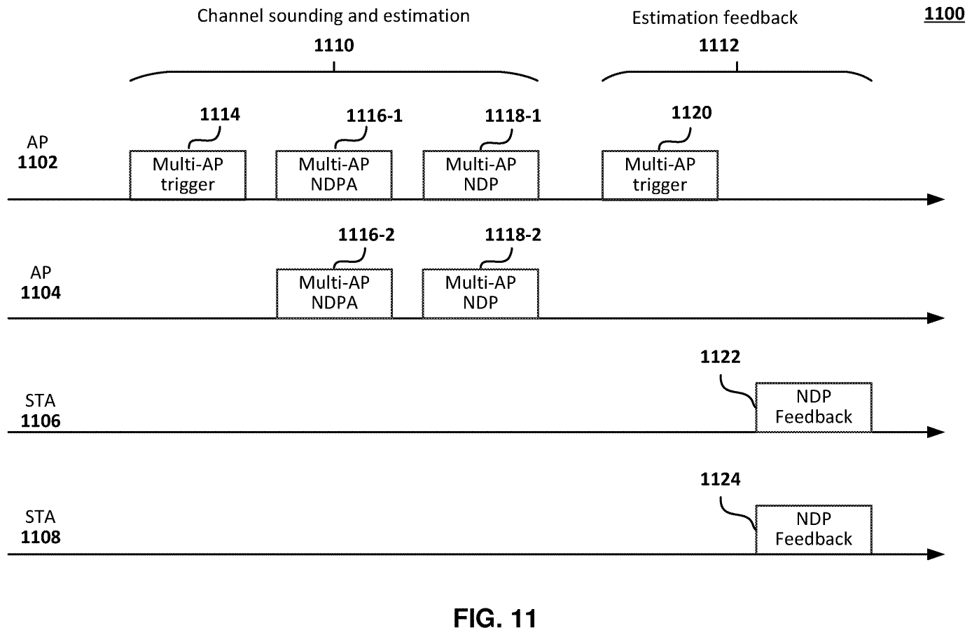

FIG. 11 illustrates an example 1100 of a multi-AP sounding phase. Multi-AP sounding phase 1100 may be an example of multi-AP sounding phase 1014. As shown in FIG. 11, example 1100 may include a master AP 1102 and a slave AP 1104 of a multi-AP group. Example 1100 may further include a STA 1106 associated with AP 1102 and a STA 1108 associated with AP 1104.

As shown in FIG. 11, multi-AP sounding phase 1100 may include frame exchanges to allow AP 1102 (the master AP) to acquire channel state information (CSI) of channels in the multi-AP group. In an implementation, phase 1100 may include a first subphase 1110 and a second subphase 1112.

During the first subphase 1110, APs may initiate channel sounding and STAs may estimate CSI. For example, AP 1102 may transmit a frame 1114 to AP 1104 (the slave AP) to trigger multi-AP sounding. Frame 1114 may comprise a multi-AP trigger frame. Subsequently, APs 1102 and 1104 may transmit respectively announcement frames 1116-1 and 1116-2 to their respective associated STAs 1106 and 1108 to announce the transmission of sounding frames. Frames 1116-1 and 1116-2 may comprise multi-AP null data PPDU announcement (NDPA) frames. Frames 1116-1 and 1116-2 may be transmitted simultaneously. Next, APs 1102 and 1104 may transmit respectively frames 1118-1 and 1118-2 to STAs 1106 and 1108, respectively. Frames 1118-1 and 1118-2 may comprise multi-AP null data PPDU (NDP) frames. STAs 1106 and 1108 receive frames 1118-1 and 1118-2 respectively and perform channel estimation of the channels from AP 1102 to STA 1106 and from AP 1104 to STA 1108, respectively.

During the second subphase 1112, APs may initiate a procedure for STAs to feed back channel estimates to the APs. For example, AP 1102 may transmit a frame 1120 to trigger STAs 1106 and 1108 to transmit their channel estimates to APs 1102 and 1104, respectively. Frame 1120 may comprise a multi-AP trigger frame. In response, STAs 1106 and 1108 may transmit respectively frames 1122 and 1124 including feedback of channel estimates to APs 1102 and 1104, respectively. Frames 1122 and 1124 may comprise NDP feedback frames. The feedback of channel estimates may include NDP feedback, CSI-related information, a beamforming report (BFR), or a channel quality indication (CQI) report.

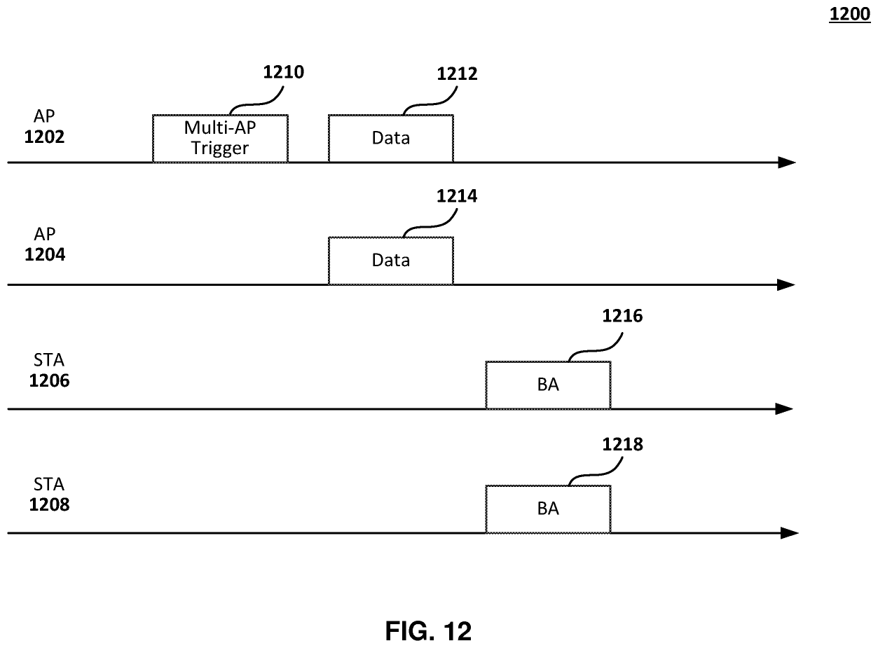

FIG. 12 illustrates an example 1200 of a multi-AP downlink data transmission phase. Multi-AP downlink data transmission phase 1200 may be an example of multi-AP data transmission phase 1016. As shown in FIG. 12, example 1200 may include a master AP 1202 and a slave AP 1204 of a multi-AP group. Example 1200 may further include a STA 1206 associated with AP 1202, and a STA 1208 associated with AP 1204.

As shown in FIG. 12, multi-AP downlink data transmission phase 1200 may include frame exchanges to enable master AP 1202 to coordinate with slave AP 1204 to perform specific multi-AP transmission schemes with their associated STAs 1206 and 1208, respectively. The multi-AP transmission schemes may include COFDMA, CTDMA, CSR, CBF, JT/JR, or a combination of two or more of the aforementioned schemes.

As shown in FIG. 12, master AP 1202 may begin phase 1200 by transmitting a frame 1210 to AP 1204. Frame 1210 may include information related to AP 1204 (e.g., an identifier of AP 1204), synchronization information, information related to a specific multi-AP transmission scheme to be used, and/or information related to a resource unit (RU) for use by AP 1204 to acknowledge frame 1210. Frame 1210 may comprise a control frame. For example, frame 1210 may comprise a multi-AP trigger frame.

Slave AP 1204 may receive frame 1210 and may use the synchronization information to synchronize with master AP 1202. Subsequently, APs 1202 and 1204 may perform data transmission to their associated STAs 1206 and 1208, respectively. Specifically, AP 1202 may transmit a data frame 1212 to its associated STA 1206, and AP 1204 may transmit a data frame 1214 to its associated STA 1208. Depending on the multi-AP transmission scheme being used, APs 1202 and 1204 may transmit frames 1212 and 1214 respectively to STAs in different BSSs. For example, when the multi-AP transmission scheme is JT/JR, AP 1202 may also transmit frame 1212 to STA 1208 associated with slave AP 1204, and AP 1204 may also transmit frame 1214 to STA 1208 associated with AP 1204. The resources for transmitting and receiving frames 1212 and 1214 may depend on the specific multi-AP transmission scheme adopted.

STAs 1206 and 1208 may acknowledge frames 1212 and 1214, respectively. For example, STA 1206 may transmit a frame 1216 to AP 1202, and STA 1208 may transmit a frame 1218 to AP 1204. Frames 1216 and 1218 may comprise block ack (BA) frames. STAs 1206 and 1208 may also transmit frames 1216 and 1218 to APs in different BSSs, when required by the used multi-AP transmission scheme. For example, when the multi-AP transmission scheme is JT/JR, STA 1206 may also transmit frame 1216 to AP 1204, and STA 1208 may also transmit frame 1218 to AP 1202. The resources for transmitting and receiving frames 1216 and 1218 may depend on the specific multi-AP transmission scheme adopted.

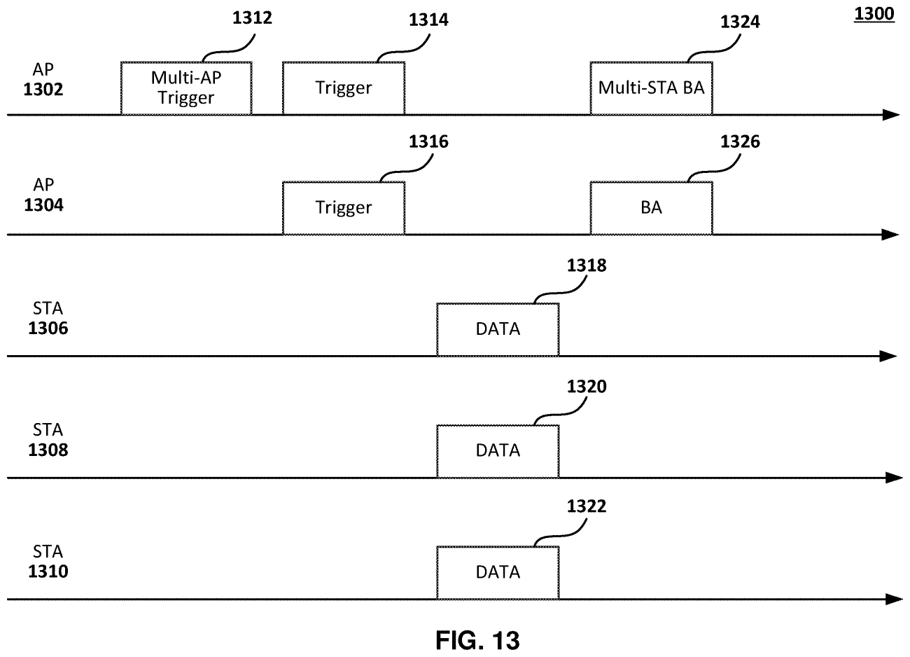

FIG. 13 illustrates an example 1300 of a multi-AP uplink data transmission phase. Multi-AP uplink data transmission phase 1300 may be an example of multi-AP data transmission phase 1016. As shown in FIG. 13, example 1300 may include a master AP 1302 and a slave AP 1304 of a multi-AP group. Example 1300 may further include STAs 1306 and 1308 associated with AP 1302, and a STA 1310 associated with AP 1304.

As shown in FIG. 13, multi-AP uplink data transmission phase 1300 may include frame exchanges to enable master AP 1302 to coordinate with slave AP 1304 to perform specific multi-AP transmission schemes with STAs 1306, 1308, and 1310. The multi-AP transmission schemes may include COFDMA, CTDMA, CSR, CBF, JT/JR, or a combination of two or more of the aforementioned schemes.

As shown in FIG. 13, master AP 1302 may begin phase 1300 by transmitting a frame 1312 to AP 1304. Frame 1312 may include information related to AP 1304 (e.g., an identifier of AP 1304), synchronization information, information related to a specific multi-AP transmission scheme to be used, and/or information related to an RU for use by AP 1304 to acknowledge frame 1312. Frame 1312 may comprise a control frame. For example, frame 1312 may comprise a multi-AP trigger frame.

Slave AP 1304 may receive frame 1312 and may use the synchronization information to synchronize with master AP 1302. Subsequently, APs 1302 and 1304 may solicit uplink data transmissions from their associated STAs 1306, 1308 and 1310 using trigger frames. Specifically, AP 1302 may transmit a trigger frame 1314 to its associated STAs 1306 and 1308, and AP 1304 may transmit a trigger frame 1316 to its associated STA 1310. Depending on the multi-AP transmission scheme being used, APs 1302 and 1304 may also transmit frames 1314 and 1316 respectively to STAs in different BSSs. For example, when the multi-AP transmission scheme is JT/JR, AP 1302 may also transmit frame 1314 to STA 1310 associated with slave AP 1304, and AP 1304 may also transmit frame 1316 to STAs 1306 and 1308 associated with AP 1302. The resources for transmitting and receiving frames 1314 and 1316 may depend on the specific multi-AP transmission scheme adopted.

STAs 1306 and 1308 may respond to frame 1314, STA 1310 may respond to frame 1316. For example, STAs 1306 and 1308 may transmit frames 1318 and 1320 respectively to AP 1302, while STA 1310 may transmit a frame 1322 to AP 1304. Frames 1318, 1320, and/or 1322 may be transmitted simultaneously. Frames 1318, 1320, and 1322 may comprise data frames or null data frames. STAs 1306, 1308, and 1310 may also transmit frames 1318, 1320, and 1322 respectively to APs in different BSSs, when required by the used multi-AP transmission scheme. For example, when the multi-AP transmission scheme is JT/JR, STAs 1306 and 1308 may also transmit respective frames 1318 and 1320 to AP 1304, and STA 1310 may also transmit frame 1322 to AP 1302. The resources for transmitting and receiving frames 1318, 1320, and 1322 may depend on the specific multi-AP transmission scheme adopted. AP 1302 may acknowledge frames 1318 and 1320 by transmitting a multi-STA BA frame 1324 to STAs 1306 and 1308. AP 1304 may acknowledge frame 1322 by transmitting a BA frame 1326 to STA 1310.

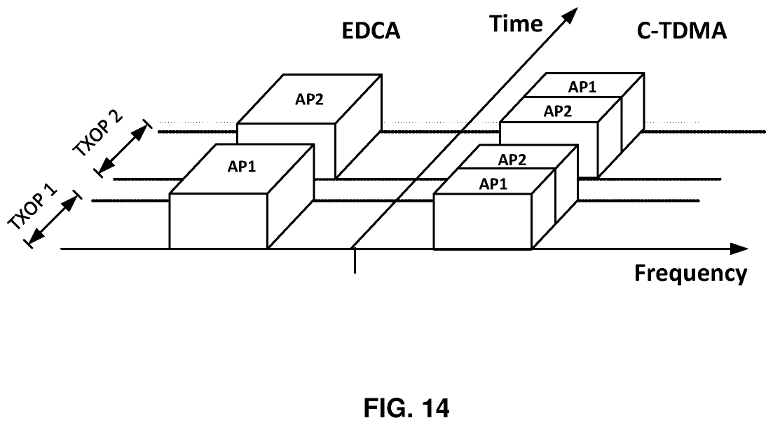

FIG. 14 illustrates enhanced distributed channel access (EDCA) and coordinated time division multiple access (CTDMA). In CTDMA, an AP (generally referred to as a master AP or a sharing AP) may share a portion of its TXOP with one or more APs (generally referred to as slave APs or shared APs). Specifically, the sharing AP may assign/allocate each of the one or more APs a respective time period within the TXOP of the sharing AP. A shared AP may use its allocated time period to communicate with one or more STA. CTDMA is illustrated in FIG. 14 as a multi-AP channel access scheme, compared with enhanced distributed channel access (EDCA). As shown in FIG. 14, in EDCA, channel access by multiple APs (e.g., AP1, AP2) may occur in consecutive time periods (e.g., TXOPs), where each AP has its own TXOP. During a given channel access, the channel in its entirety may be used by a single AP for the duration of the TXOP. In contrast, in CTDMA, access by multiple APs may take place in a same TXOP over consecutive time periods. For example, as shown in FIG. 14, a TXOP may be divided into two non-overlapping time periods, each assigned to a respective AP of the multiple APs. The multiple APs may transmit in a coordinated manner in the same TXOP consecutively. In an example, as shown in FIG. 14, a master/sharing AP (e.g., AP1) may use itself a first portion of a first TXOP and may share a second portion of the first TXOP with a slave/shared AP (e.g., AP2). In another example, the master/shared AP (e.g., AP1) may share a first portion of a second TXOP with a slave/shared AP (e.g., AP2) and may use itself a second portion of the second TXOP.

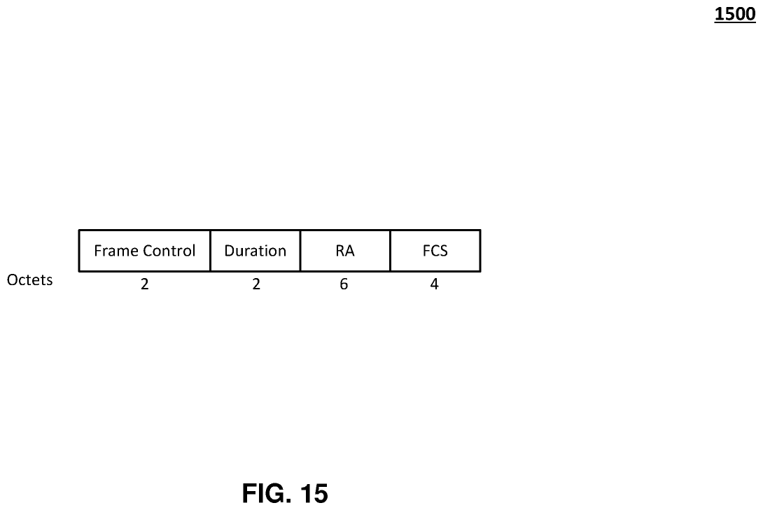

FIG. 15 illustrates an example clear to send (CTS) frame format 1500. As shown in FIG. 15, the CTS frame format may comprise a Frame Control field, a Duration field, an RA field, and an FCS field. The Frame Control field may be similar to the Frame Control field described in FIG. 3 above.

If the CTS frame is a response to a request to send (RTS) frame, the RA field of the CTS frame is set to the address from the TA field of the RTS frame with the Individual/Group bit set to 0. If the CTS frame is the first frame in a frame exchange, the RA field is set to the MAC address of the transmitter. If the CTS frame is a response to an MU-RTS Trigger frame, the RA field of the CTS frame is set to the address from the TA field of the MU-RTS Trigger frame.

For all CTS frames transmitted by a non-QoS STA in response to RTS frames, the Duration field is the value obtained from the Duration field of the immediately previous RTS frame, minus the time, in microseconds, required to transmit the CTS frame and its SIFS. If the calculated duration includes a fractional microsecond, that value is rounded up to the next higher integer.

At a non-QoS STA, if the CTS frame is the first frame in the exchange and the pending Data or Management frame requires acknowledgment, the Duration field is the time, in microseconds, required to transmit the pending Data or Management frame, plus two SIFSs plus one Ack frame. At a non-QoS STA, if the CTS frame is the first frame in the exchange and the pending Data or Management frame does not require immediate acknowledgment, the Duration field is the time, in microseconds, required to transmit the pending Data or Management frame, plus one SIFS. If the calculated duration includes a fractional microsecond, that value is rounded up to the next higher integer.

For other CTS frame transmissions by a QoS STA, the Duration field is set as defined in section 9.2.5 (Duration/ID field (QoS STA)) of the IEEE 802.11 standard (“IEEE P802.11-REVme™/D4.1, October 2023”).

A CTS-to-self frame is a CTS frame in which the RA field is equal to the transmitter's MAC address. A CTS-to-AP frame is a CTS frame that is not transmitted in response to an RTS frame and in which the RA field is equal to the MAC address of the AP with which the STA is associated.

Triggered TXOP sharing (TXS) is a technique introduced in the IEEE 802.11be standard amendment. TXS allows an AP to allocate a time duration within an obtained TXOP to a STA for transmitting one or more non-trigger-based (non-TB) PPDUs. For the TXS procedure, the AP may transmit a multi-user request-to-send (MU-RTS) trigger frame with a triggered TXOP sharing mode subfield set to a non-zero value. The MU-RTS trigger frame is a trigger frame for triggering CTS frame(s) from multiple users. An MU-RTS trigger frame with the triggered TXOP sharing mode subfield set to a non-zero value is called an MU-RTS TXS trigger (MRTT) frame.

In an example, when the triggered TXOP sharing mode subfield is set to 1, the STA may transmit the one or more non-TB PPDUs to the AP during the allocated time duration. In an example, when the triggered TXOP sharing mode subfield is set to 2, the STA may transmit the one or more non-TB PPDUs to the AP or a peer STA during the allocated time duration. The peer STA may be a STA with a connection for peer-to-peer (P2P) communication or direct communication with the STA. In an example, the direct wireless link is established according to the tunneled direct link setup (TDLS) protocol.

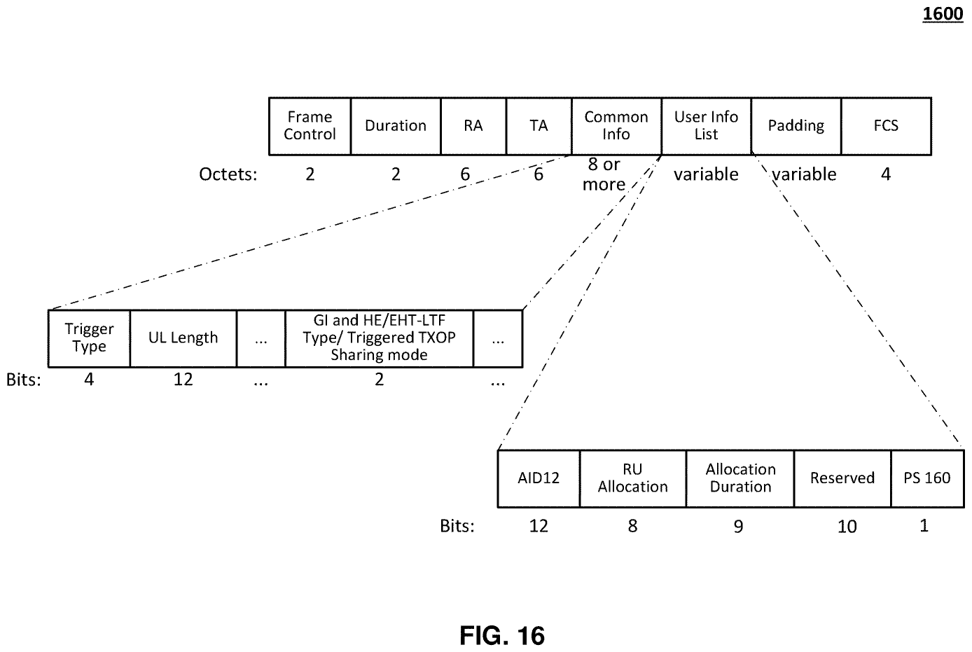

FIG. 16 illustrates an example of a MRTT frame 1600 which may be used in a TXS procedure. As shown in FIG. 16, example MRTT frame 1600 may comprise a frame control field, a duration field, a receiver address (RA) field, a transmitter address (TA) field, a common info field, a user info list field, a padding field, and/or frame check sequence (FCS) field.

In an example, the common info field may be a high-efficiency (HE) variant common info field or an extremely high throughput (EHT) variant common info field. An EHT variant common info field may comprise, as shown in FIG. 16, one or more of the following subfields: trigger type, UL length, more TF, CS required, UL BW, GI and HE/EHT-LTF Type/Triggered TXOP sharing mode, number of HE/EHT-LTF symbols, LDPC extra symbol segment, AP Tx Power, Pre-FEC padding factor, PE disambiguity, UL spatial reuse, HE/EHT P160, special user info field flag, EHT reserved, reserved, or trigger dependent common info.

The trigger type subfield indicates that frame 1600 is an MRTT frame.

The GI and HE/EHT-LTF Type/Triggered TXOP sharing mode subfield may include a triggered TXOP sharing mode subfield. In an example, the triggered TXOP sharing mode subfield may be set to a non-zero value (e.g., 1 or 2). In an example, the triggered TXOP sharing mode subfield may be set to 1. As such, the triggered TXOP sharing mode subfield may indicate that a STA indicated by an AID12 subfield of a user info field (of the user info list field) may transmit one or more non-TB PPDUs to the AP during a time indicated in the allocation duration subfield of the user info field. In another example, the triggered TXOP sharing mode subfield may be set to 2. As such, the triggered TXOP sharing mode subfield may indicate that a STA indicated by an AID12 subfield of a user info field (of the user info list field) may transmit one or more non-TB PPDUs to the AP or to a peer STA during the time indicated by the allocation duration subfield of the user info field. In an example, the peer STA may be a STA with a connection for P2P communication or direct communication with the STA.

The user info list field may include one or more user info fields. In an example, an EHT variant user info field may comprise, as shown in FIG. 16, one or more of the following subfields: AID12, RU allocation, allocation duration, reserved, or PS160.

The AID12 subfield may indicate an association identifier (AID) of a STA that may use a time indicated by the allocation duration subfield.

The RU allocation subfield may indicate the location and size of the RU allocated for a STA indicated by the AID12 subfield.

The allocation duration subfield may indicate a time allocated by an AP transmitting MRTT frame 1600. The allocated time may be a portion a TXOP obtained by the AP. In an example embodiment, the allocation duration subfield may indicate a first time period.

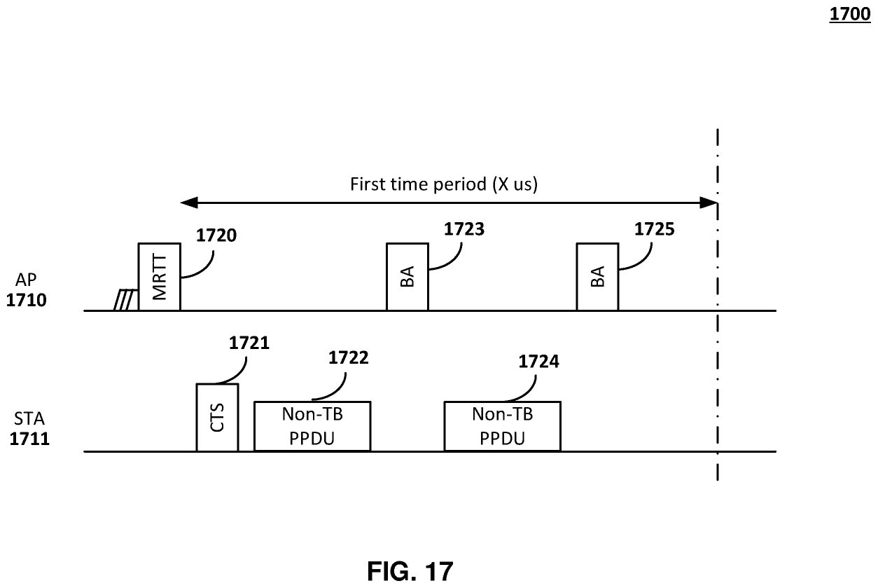

FIG. 17 illustrates an example 1700 of a TXS procedure (Mode=1). As shown in FIG. 17, the TXS procedure may begin by an AP 1710 transmitting an MRTT frame 1720 to a STA 1711. MRTT frame 1720 may allocate a portion of a TXOP obtained by AP 1710 to STA 1711 and may indicate a TXS mode equal to 1. STA 1711 receiving MRTT frame 1720 may use the allocated time to transmit one or more non-TB PPDUs to AP 1710. The one or more non-TB PPDUs may comprise a data frame, a control frame, a management frame, or an action frame.

In an example, MRTT frame 1720 may comprise a triggered TXOP sharing mode subfield that indicates the TXS mode and/or subfield that indicates a first time period corresponding to the allocated time. In an example, the first time period may be set to a value of X microseconds (us).

STA 1711 may respond to MRTT frame 1720 by transmitting a CTS frame 1721 to AP 1710. Subsequently, STA 1711 may transmit non-TB PPDUs 1722, 1724 comprising one or more data frame to AP 1710 during the first time period indicated in MRTT frame 1720. In an example, AP 1710 may transmit one or more Block Ack (BA) frames 1723, 1725 in response to the one or more data frames contained in non-TB PPDUs 1722, 1724 received from STA 1711.

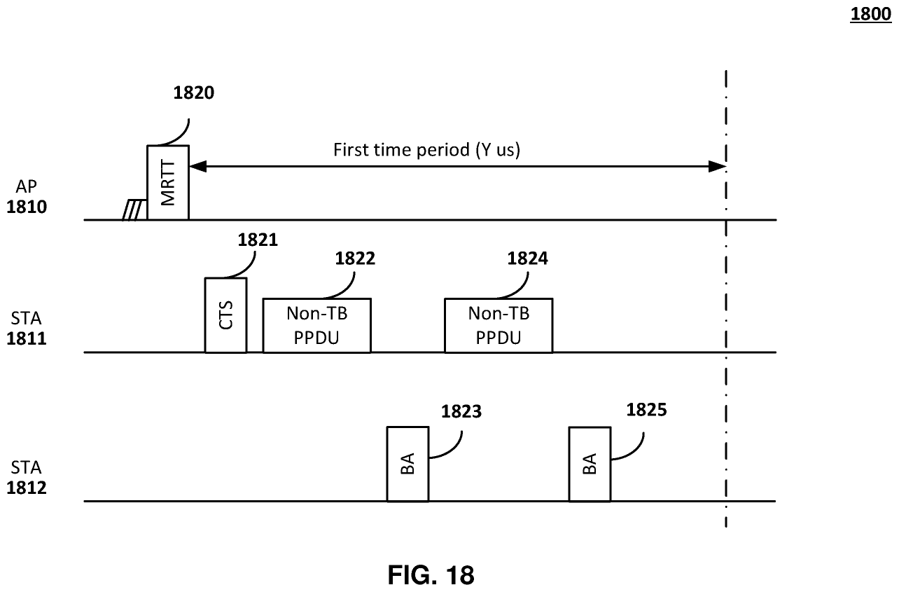

FIG. 18 illustrates an example 1800 of a TXS procedure (Mode=2). As shown in FIG. 18, the TXS procedure may begin by an AP 1810 transmitting an MRTT frame 1820 to a STA 1811. MRTT frame 1820 may allocate a portion of a TXOP obtained by AP 1810 to STA 1811 and may indicate a TXS mode equal to 2. STA 1811 receiving MRTT frame 1820 may use the allocated time to transmit one or more non-TB PPDUs to STA 1812. The one or more non-TB PPDUs may comprise a data frame, a control frame, a management frame, or an action frame.

In an example, MRTT frame 1820 may comprise a triggered TXOP sharing mode subfield that indicates the TXS mode and/or subfield that indicates a first time period corresponding to the allocated time. In an example, the first time period may be set to a value of Y microseconds (us).

STA 1811 may respond to MRTT frame 1820 by transmitting a CTS frame 1821 to AP 1810. Subsequently, STA 1811 may transmit non-TB PPDUs 1822, 1824 comprising one or more data frame to STA 1812 during the first time period indicated in MRTT frame 1820. In an example, STA 1812 may transmit one or more BA frames 1823, 1825 in response to the one or more data frames contained in non-TB PPDUs 1822, 1824 received from STA 1811.

In CTDMA, one approach for TXOP sharing may be achieved via the TXS procedure described above. The TXS procedure may be used to allow a sharing AP, which obtains a TXOP and is the TXOP owner, to allocate a time duration within its obtained TXOP to a shared AP for downlink and/or uplink transmission between the shared AP and its associated STAs.

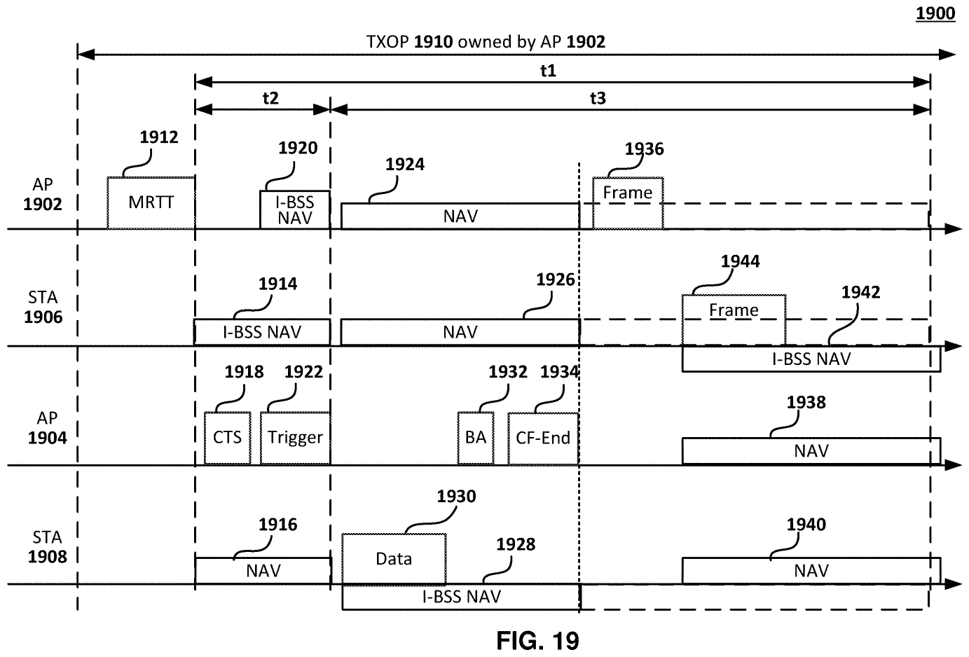

FIG. 19 illustrates an example 1900 of an multi-AP operation procedure using CTDMA. As shown in FIG. 19, example 1900 may include APs 1902 and 1904 and STAs 1906 and 1908. AP 1902 and AP 1904 may be members of a multi-AP group. AP 1902 may be a sharing/master AP of the multi-AP group. AP 1904 may be a shared/slave AP of the multi-AP group. STA 1906 may be associated with AP 1902, and STA 1908 may be associated with AP 1904. In example 1900, it is assumed that APs 1902, 1904 and STAs 1906, 1908 are within communication range of each other.

In an implementation, an AP, such as APs 1902 and 1904, or a STA, such as STAs 1906 and 1908, may maintain two NAVs: an intra-BSS NAV and a basic NAV. The intra-BSS NAV is updated (set or reset) based on intra-BSS PPDUs (i.e., PPDUs received from the BSS to which the STA/AP belongs). The basic NAV is updated (set or reset) based on inter-BSS PPDUs (i.e., PPDUs received from a different BSS than the BSS to which the STA/AP belongs (also referred to as inter-BSS or OBSS)) or PPDUs that cannot be classified as intra-BSS or inter-BSS.

For a STA to access the channel using EDCA, both NAVs must be non-zero. The basic NAV of the STA is not updated by transmissions from the AP with which the STA is associated so that if the basic NAV of the STA is nonzero and the STA receives, from the AP, a Trigger frame with the CS Required subfield equal to 1, the STA does not respond. The STA does not consider the intra-BSS NAV in determining whether to respond to a Trigger frame sent by the AP with which the STA is associated. The STA considers the basic NAV in determining whether to respond to a Trigger frame sent by the AP with which the STA is associated.

As shown in FIG. 19, the procedure may begin with AP 1902 transmitting an MRTT frame 1912 after obtaining a TXOP 1910. In an embodiment, MRTT frame 1912 may comprise an allocation for AP 1904. An allocation of MRTT frame 1912 may comprise an identifier of a shared AP and a duration (within the TXOP) allocated to the shared AP. In example 1900, MRTT frame 1912 may comprise an allocation for AP 1904. The allocation may comprise a first duration (denoted t1 in FIG. 19) of the TXOP allocated to AP 1904. The first duration may be indicated in an allocation duration subfield of a user info list field of MRTT frame 1912. In an embodiment, a duration field of MRTT frame 1912 may indicate a second duration (denoted t2 in FIG. 19). The second duration indicated in the duration field of MRTT frame 1912 may be shorter than the first duration. This is to avoid having an associated STA of a shared AP, which is an OBSS STA for the sharing AP, set its basic NAV for a long duration (e.g., the first duration) after hearing the MRTT frame, which would cause the associated STA not to respond to a trigger frame from its associated shared AP, which owns the TXOP during the first duration. In an implementation, setting the duration field of MRTT frame 1912 to the second duration allows AP 1902 to protect a CTS frame and/or trigger frame of the shared AP.

In example 1900, on receiving MRTT frame 1912, STA 1906 may set its intra-BSS NAV (as shown by I-BSS NAV 1914 in FIG. 19) to the second duration t2 indicated in MRTT frame 1912. On receiving MRTT frame 1912, STA 1908 may set its basic NAV (as shown by NAV 1916 in FIG. 19) to the second duration t2. On receiving MRTT frame 1912, AP 1904 may determine that AP 1902 has shared TXOP 1910 with AP 1904 for the duration t1. AP 1904 may transmit a CTS frame 1918 to AP 1902, in response to MRTT frame 1912.

On receiving CTS frame 1918, AP 1902 may set its intra-BSS NAV (as shown by I-BSS NAV 1920 in FIG. 19) for the remaining duration of t2. After transmitting CTS frame 1918, AP 1904 may use the TXOP for the remaining duration of t1. In an example, AP 1904 may transmit a downlink frame to STA 1908 (not shown in FIG. 19). In another example, AP 1904 may trigger STA 1908 to transmit an uplink frame to AP 1904.

In example 1900, after transmitting CTS frame 1918, AP 1904 may transmit a trigger frame 1922 to STA 1908 to trigger an uplink transmission from STA 1908. In an embodiment, a duration field of trigger frame 1922 may indicate a third duration t3. On receiving trigger frame 1922, an OBSS AP or an OBSS STA may set its basic NAV based on the duration field of trigger frame 1922. Specifically, in example 1900, on receiving trigger frame 1922, AP 1902 may set its basic NAV (as shown by NAV 1924 in FIG. 19) to the third duration indicated in trigger frame 1922. Similarly, on receiving trigger frame 1922, STA 1906 may set its basic NAV (as shown by NAV 1926 in FIG. 19) to the third duration indicated in trigger frame 1922.

In an implementation, on receiving trigger frame 1922 and seeing its own address in the RA field of trigger frame 1922, STA 1908 may determine that it is to transmit an uplink frame to AP 1904. In an embodiment, with trigger frame 1922 transmitted by AP 1904 with which STA 1908 is associated, STA 1908 may set its intra-BSS NAV (as shown by I-BSS NAV 1928 in FIG. 19) to the third duration indicated in trigger frame 1922. In another embodiment, STA 1908 may not set its intra-BSS NAV. Subsequently, STA 1908 may transmit a data frame 1930 to AP 1904. Data frame 1930 may include a duration field that indicates the remaining duration of the third duration. In response to data frame 1930, AP 1904 may transmit a BA frame 1932 to STA 1908.

In an example, after transmitting BA frame 1932 to STA 1908, AP 1904 may not have further uplink and/or downlink transmissions to perform within the remainder of the first duration allocated to AP 1904. In an implementation, AP 1904 may return the remainder of the first duration to AP 1902 (also referred to as truncating the first duration). In example 1900, AP 1904 may transmit a frame 1934 indicating a return by AP 1904 of the first duration to AP 1902 (or indicating truncation by AP 1904 of the first duration). In an example, frame 1934 may be a contention free-end (CF-end) frame. In an example, frame 1934 may comprise a transmitter address (TA) indicating AP 1904. In an example, frame 1934 may be a broadcast frame.

In example 1900, on receiving CF-end frame 1934, AP 1902 may reset its basic NAV to zero before the end of the third duration. AP 1902 may further determine that AP 1904 has returned the first duration to AP 1902. With the return of the first duration to AP 1902, AP 1902 (which is the owner of the TXOP) returns to being the holder of the TXOP. Similarly, on receiving CF-end frame 1934, STA 1906 may reset its basic NAV before the end of the third duration. On receiving CF-end frame 1934, STA 1908 may reset its intra-BSS NAV before the end of the third duration.

In an example, with the return of the first duration to AP 1902, AP 1902 may initiate uplink and/or downlink transmissions for the remaining duration of TXOP 1910 (which includes the remainder of the first duration). In an example, AP 1902 may transmit a frame 1936 to STA 1906 to initiate an uplink transmission. In an example, frame 1936 may be a trigger frame. On receiving frame 1936, an OBSS AP or an OBSS STA may set its basic NAV. As such, AP 1904 may set its basic NAV (as shown by NAV 1938 in FIG. 19) to a duration indicated in frame 1936. Similarly, STA 1908 may set its basic NAV (as shown by NAV 1940 in FIG. 19) to the duration indicated in frame 1936.

On receiving frame 1936 and seeing its own address in the RA field of frame 1936, STA 1906 may determine that it is to transmit an uplink frame to AP 1902. STA 1906 may set its intra-BSS NAV (as shown by I-BSS NAV 1942 in FIG. 19) to the duration indicated in frame 1936. In another embodiment, STA 1906 may not set its intra-BSS NAV. In response to frame 1936, STA 1906 may transmit a frame 1944 to AP 1902. In an example, frame 1944 may be a data frame. In an implementation, frame 1944 may include a duration field that indicates the remainder of the duration indicated frame 1936. In an example, after receiving frame 1944, AP 1902 may continue uplink and/or downlink transmissions within TXOP 1910. In another example, AP 1902 may share a remaining portion of TXOP 1910 with another shared AP.

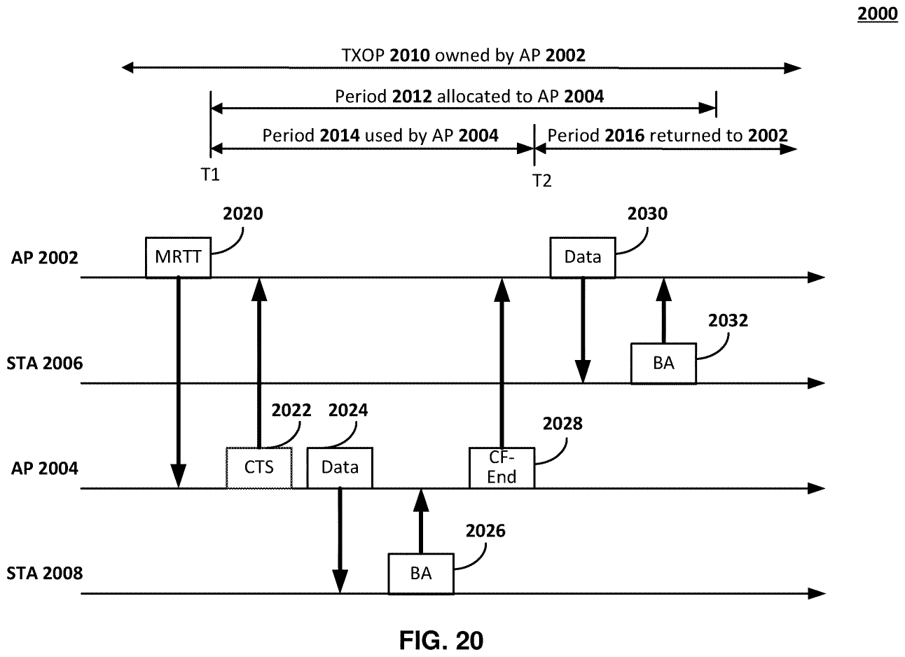

FIG. 20 illustrates another example 2000 of an existing CTDMA procedure. As shown in FIG. 20, example 2000 may include APs 2002 and 2004 and STAs 2006 and 2008. AP 2002 and AP 2004 may be members of a multi-AP group. AP 2002 may be a sharing/master AP of the multi-AP group. AP 2004 may be a shared/slave AP of the multi-AP group. STA 2006 may be associated with AP 2002, and STA 2008 may be associated with AP 2004. In example 2000, it is assumed that APs 2002, 2004 and STAs 2006, 2008 are within communication range of each other.

As shown in FIG. 20, the procedure may begin with AP 2002 transmitting an MRTT frame 2020 after obtaining a TXOP 2010. In an embodiment, MRTT frame 2020 may comprise an allocation for AP 2004. An allocation of MRTT frame 2020 may comprise an identifier of a shared AP and a duration (within the TXOP) allocated to the shared AP. In example 2000, MRTT frame 2020 may comprise an allocation for AP 2004. The allocation may comprise a period 2012 of TXOP 2010 allocated to AP 2004. Period 2012 may have a first duration starting at a time T1. The first duration of period 2012 may be indicated in an allocation duration subfield of a user info list field of MRTT frame 2020.

On receiving MRTT frame 2020, AP 2004 may determine that AP 2002 has shared TXOP 2010 with AP 2004 for the first duration of period 2012. AP 2004 may transmit a CTS frame 2022 to AP 2002, in response to MRTT frame 2020.

After transmitting CTS frame 2022, AP 2004 may use the TXOP for the remaining duration of the first duration of period 2012. In an example, AP 2004 may transmit a downlink frame to STA 2008. In another example, AP 2004 may trigger STA 2008 to transmit an uplink frame to AP 1804 (not shown in FIG. 20). In example 2000, after transmitting CTS frame 2022, AP 2004 may transmit a data frame 2024 to STA 2008 for transmission. Data frame 2024 may include a duration field that indicates the remaining duration of the first duration of period 2012. In response to data frame 2024, AP 2004 may transmit a BA frame 2026 to AP 2004.

In an example, after receiving BA frame 2026 from STA 2008, AP 2004 may not have further uplink and/or downlink transmissions to perform within the remainder of the first duration of period 2012 allocated to AP 2004. In an implementation, AP 2004 may return the remainder of period 2012 to AP 2002 (also referred to as truncating period 2012). In example 2000, AP 2004 may transmit a frame 2028 indicating a return by AP 2004 of period 2012 to AP 2002 (or indicating truncation by AP 2004 of period 2012). In an example, frame 2028 may be a contention free-end (CF-end) frame. In an example, CF-end frame 2028 may comprise a transmitter address (TA) indicating AP 2004. In an example, CF-end frame 2028 may be a broadcast frame. As shown in FIG. 20, AP 2004 may return period 2012 after using only a period 2014 of period 2012. Period 2014 may have a second duration starting at time T1 and ending at a time T2.

In an example, with the return of period 2012 to AP 2002, AP 2002 may initiate uplink and/or downlink transmissions for the remaining duration of TXOP 2010 (which includes the remainder of the first duration of period 2012) starting at time T2. As shown in FIG. 20, the remaining duration of TXOP 2010 may include a period 2016, which may comprise the returned portion of period 2012. In an example, AP 2002 may transmit a frame 2030 to STA 2006 to initiate a downlink transmission. In an example, frame 2030 may be a data frame. In response to frame 2030, STA 2006 may transmit a frame 2032 to AP 2002. In an example, frame 2032 may be a BA frame.

In an example, after receiving frame 2032, AP 2002 may continue uplink and/or downlink transmissions within TXOP 2010. In another example, AP 2002 may share a remaining portion of TXOP 2010 with another shared AP.

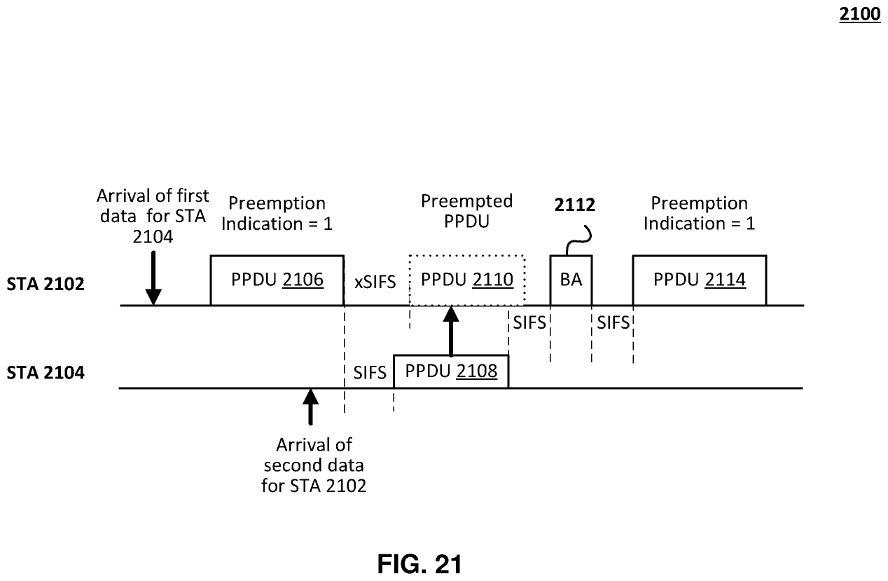

FIG. 21 is an example 2100 that illustrates an uplink preemption procedure. As shown in FIG. 21, example 2100 includes STAs 2102 and 2104. STAs 2102 and 2104 may each be an AP STA or a non-AP STA. For example, STA 2102 may be an AP STA and STA 2104 may be a non-AP STA, or vice versa. In another example, STAs 2102 and 2104 may be both AP STAs or both non-AP STAs.

As shown in FIG. 21, example 2100 begins with the arrival at STA 2102 of first data for transmission to STA 2104. The first data may be non-low latency data. To transmit the first data to STA 2104, STA 2102 may transmit an RTS frame (not shown in FIG. 21) to STA 2104. The RTS frame may indicate a duration of a TXOP to transmit the first data to STA 2104 (and including any intervening interframe spaces and the transmission time of an ACK frame, if required). In an implementation, the first data may be transmitted using multiple PPDUs. In an implementation, the PPDUs may be designed to be shorter than a pre-defined size (e.g., 2 milliseconds). The multiple PPDUs may be configured to be transmitted successively on the wireless medium, separated from one another by an interframe space, xIFS. In an implementation, the interframe space xIFS may be chosen as larger than a short interframe space (SIFS). For example, the interframe space xIFS may be equal to a SIFS plus one or more slot times (a slot time is 9 μs in the 5 GHz band). As such, the duration indicated in the RTS frame may be based on the transmission times of the multiple PPDUs, the intervening interframe spaces, and the transmission time of an ACK frame, if required, from STA 2104. In an implementation, the PPDUs may be configured to include an indication of whether preemption of the PPDUs is allowed. When preemption is allowed, a preempting PPDU may be transmitted in between the multiple PPDUs. Transmission of the remaining PPDUs may resume after transmission of the preempting PPDU. In example 2100, it is assumed that the multiple PPDUs include a preemption indication set to 1 to indicate that preemption of the PPDUs is allowed.

On receiving the RTS frame, and assuming that its NAV indicates idle, STA 2104 may respond to STA 2102 by transmitting a CTS frame (not shown in FIG. 21) to STA 2102. In an implementation, STA 2104 transmits the CTS frame SIFS after receiving the RTS frame. Subsequently, STA 2102 may begin transmitting one or more PPDUs comprising the first data to STA 2104. For example, STA 2102 may transmit a PPDU 2106 comprising a first portion of the first data to STA 2104. In an implementation, STA 2102 may transmit PPDU 2106 an xIFS after receiving the CTS frame from STA 2104.

In example 2100, while STA 2102 transmits PPDU 2106 to STA 2104, STA 2104 may have second data arrive for transmission to STA 2102. In an example, the second data may be low latency data that requires urgent transmission to STA 2102. In an implementation, based on PPDU 2106 comprising a preemption indication set to 1, STA 2104 may begin transmitting a PPDU 2108 comprising the second data a SIFS after receiving PPDU 2106 from STA 2102. In an implementation, as STA 2102 separates successive ones of the multiple PPDUs by an xIFS, STA 2104 begins transmitting PPDU 2108 before STA 2102 may begin transmitting a next PPDU 2110 to STA 2104. PPDU 2108 from STA 2102 to STA 2104 thus preempts PPDU 2110 from STA 2102 to STA 2104. PPDU 2108 may be of the same size, shorter, or longer than PPDU 2110.

In an implementation, STA 2102 may acknowledge PPDU 2108 by transmitting a BA frame 2112 to STA 2104. STA 2102 may then resume transmission of the multiple PPDUs to STA 2104. For example, STA 2102 may transmit a PPDU 2114 comprising a second portion of the first data to STA 2104. In an implementation, STA 2102 may transmit PPDU 2114 an xIFS or a SIFS after transmitting BA frame 2112 to STA 2104. In an example, when PPDU 2114 is the final PPDU of the multiple PPDUs transmitted to STA 2104, STA 2104 may send a BA frame (not shown in FIG. 21) to STA 2102 on receiving PPDU 2114, marking the end of the TXOP.

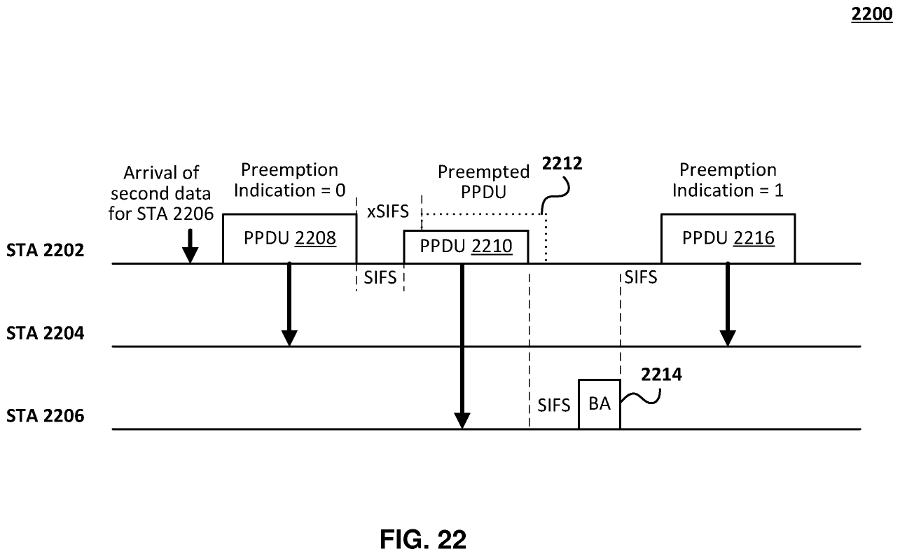

FIG. 22 is an example 2200 that illustrates a downlink preemption procedure. As shown in FIG. 22, example 2200 includes STAs 2202, 2204, and 2206. STAs 2202, 2204, and 2206 may each be an AP STA or a non-AP STA.

As shown in FIG. 22, example 2200 begins with the arrival at STA 2202 of second data for transmission to STA 2206. In an example, the second data may be low latency data that requires urgent transmission to STA 2206. The arrival of the second data may occur before or during the transmission of a PPDU 2208 to STA 2204. In an implementation, PPDU 2208 may be one of multiple PPDUs being transmitted to STA 2204 to transmit first data to STA 2204. In an example, the first data may be non-low latency data.

In an example, to transmit the second data, STA 2202 may transmit a PPDU 2210 comprising the second data a SIFS after an end of PPDU 2208. As PPDU 2210 is transmitted a SIFS, instead of an xIFS, after PPDU 2208, PPDU 2210 preempts a PPDU 2212 that would have been transmitted to STA 2204 and that would have contained the first data. In an implementation, STA 2202 may be configured to transmit PPDU 2210 in this manner based on receiving a frame (e.g., from an AP) indicating that preemption is allowed for the following TXOP. The AP or STA 2202 may be the holder of the TXOP. In an embodiment, STA 2202 may indicate in PPDU 2208 that pre-emption is disabled for PPDU 2208. In example 2200, such an indication may include setting a Pre-emption Indication field to 0. The Pre-emption Indication field being set to 0 prevents another STA (e.g. STA 2204 or STA 2206) from pre-empting the transmission of PPDU 2212, which could have cause a collision with the pre-empting PPDU 2210. In an embodiment, STA 2202 may be configured to set a Pre-emption Indication field to 0 upon reception of a low latency data frame that is scheduled to be transmitted after PPDU 2208.

In an implementation, STA 2206 may acknowledge PPDU 2210 by transmitting a BA frame 2214 to STA 2202. BA frame 2214 may be transmitted a SIFS after an end of PPDU 2210. STA 2202 may then resume transmission of the multiple PPDUs to STA 2204. For example, STA 2202 may transmit a PPDU 2216 comprising a second portion of the first data to STA 2204. In an implementation, STA 2202 may transmit PPDU 2216 an xIFS or a SIFS after transmitting BA frame 2214 to STA 2204. In an example, when PPDU 2216 is the final PPDU of the multiple PPDUs transmitted to STA 2204, STA 2204 may send a BA frame (not shown in FIG. 22) to STA 2202 on receiving PPDU 2216, marking the end of the TXOP.

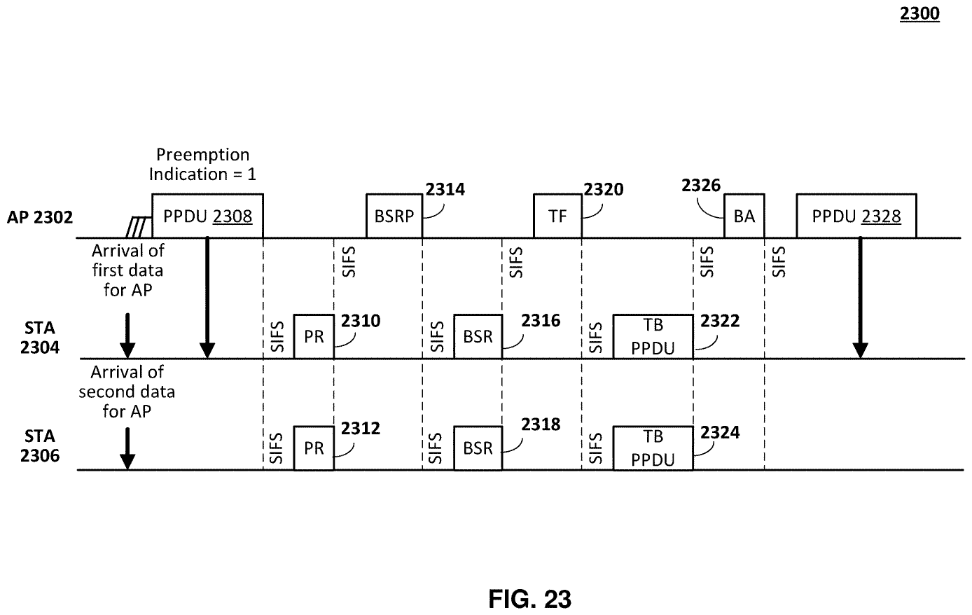

FIG. 23 is an example 2300 that illustrates an uplink preemption procedure using a preemption request. As shown in FIG. 23, example 2300 includes AP 2302, STA 2304, and STA 2306. STAs 2304 and 2306 may be associated with AP 2302.

As shown in FIG. 23, example 2300 may begin with the arrival at STA 2304 of first data for AP 2302 and at STA 2306 of second data for AP 2302. In an example, both the first data and the second data may be low latency data that requires urgent transmission to AP 2302. In an example, the arrival of the first data and the second data may occur before or during the transmission by AP 2302 of a PPDU 2308 to STA 2304. In an implementation, PPDU 2308 may be one of multiple PPDUs being transmitted to STA 2304 to transmit third data to STA 2304. In an example, the third data may be non-low latency data. PPDU 2308 may include a preemption indication that indicates whether preemption of the multiple PPDUs is allowed.

In example 2300, the preemption indication of PPDU 2308 may be set to 1 indicating that preemption of the multiple PPDUs is allowed. As such, based on the arrival of the first data and the second data respectively, STAs 2304 and 2306 may preempt a next PPDU (not shown in FIG. 23) from AP 2302 to STA 2304 to transmit respective preemption request (PR) frames 2310 and 2312 to AP 2302. In an implementation, PR frames 2310 and 2312 are transmitted a SIFS after an end of PPDU 2308 to preempt the next PPDU from AP 2302 to STA 2304.

In an implementation, PR frames 2310 and 2312 are transmitted concurrently and over the same channel. As such, the respective PPDUs carrying PR frames 2310 and 2312 must be identical to avoid interfering at AP 2302. In an implementation, PR frames 2310 and 2312 may have a similar format as the CTS frame format illustrated in FIG. 4. In an implementation, to ensure that the respective PPDUs carrying PR frames 2310 and 2312 are identical, STAs 2304 and 2306 may be configured to set the SIV of the respective PPDUs carrying PR frames 2310 and 2312 to the same value of the SIV part (bits 0-6) of the SERVICE field of PPDU 2308. Additionally, STAs 2304 and 2306 may be configured to set the RA field of PR frames 2310 and 2312 based on a transmitter address (TA) comprised in PPDU 2308.

As PR frames 2310 and 2312 may be overlapping and identical, AP 2302 may not know which STAs transmitted a PR frame. In an implementation, AP 2302 may respond to PR frames 2310 and 2312 by transmitting a buffer status report poll (BSRP) frame 2314. BSRP frame 2314 may be transmitted a SIFS after an end of PR frames 2310 and 2312. BSRP frame 2314 solicits buffer status report (BSR) frames from all STAs to allow AP 2302 to determine the STAs that have low latency traffic to transmit to AP 2302. In example 2300, as both STAs 2304 and 2306 have low latency traffic to transmit to AP 2302, STAs 2304 and 2306 may respond to BSRP frame 2314 with BSR frames 2316 and 2318 respectively. BSR frames 2316 and 2318 indicate to AP 2302 that STAs 2304 and 2306 have low latency traffic for AP 2302. BSR frames 2316 and 2318 may be transmitted a SIFS after an end of BSRP frame 2314.

Subsequently, based on receiving BSR frames 2316 and 2318, AP 2302 may transmit a trigger frame 2320 to STAs 2304 and 2306. Trigger frame 2320 solicits trigger-based (TB) uplink transmissions from STAs 2304 and 2306. Trigger frame 2320 may be transmitted a SIFS after an end of BSR frames 2316 and 2318. STAs 2304 and 2306 may respond to trigger frame 2320 by transmitting TB PPDUs 2322 and 2324 respectively. TB PPDUs 2322 and 2324 may be transmitted a SIFS after an end of trigger frame 2320. In an example, TB PPDUs 2322 and 2324 may be transmitted over orthogonal frequency resources.

In an example, AP 2302 may acknowledge TB PPDUs 2322 and 2324 by transmitting a BA frame 2326. BA frame 2326 may be transmitted a SIFS after an end of TB PPDUs 2322 and 2324. In an example, AP 2302 may resume transmission of the third data to STA 2304 by transmitting a PPDU 2328 a SIFS after an end of BA frame 2326.

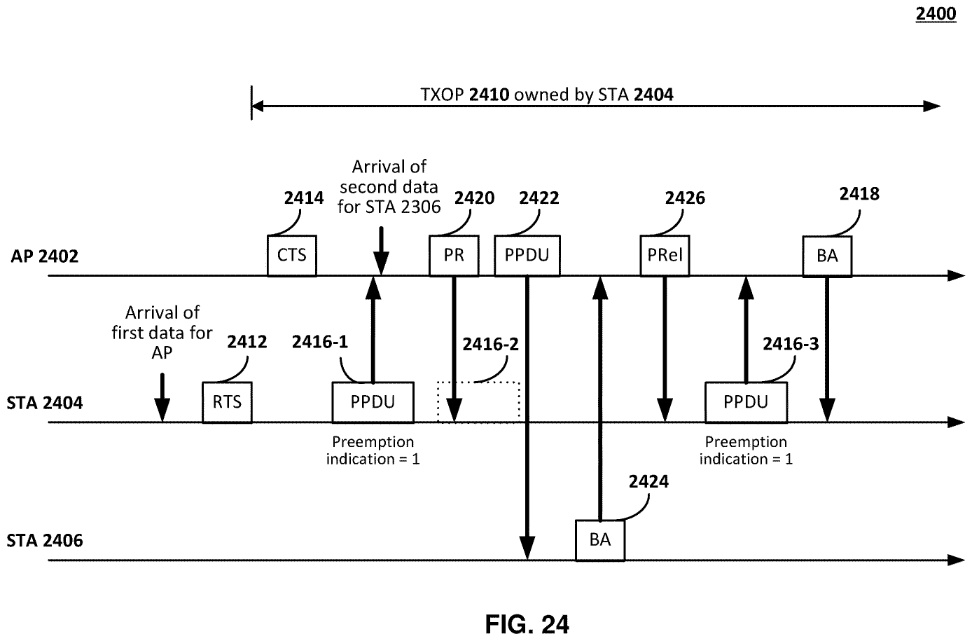

FIG. 24 is another example 2400 that illustrates a downlink preemption procedure using a preemption release. As further described below, the downlink preemption procedure may comprise procedures in which a TXOP owner may allow preemption within a TXOP that it obtains. The preemption procedure may further comprise procedures in which a transmitter that is not the TXOP owner may initiate a transmission (e.g., of low-latency data) within a TXOP when the TXOP owner allows preemption.

As shown in FIG. 24, example 2400 includes an AP 2402, a STA 2404, and a STA 2406. STAs 2404 and 2406 may be associated with AP 2402.

As shown in FIG. 24, example 2400 may begin with the arrival at STA 2404 of first data for AP 2402. The first data may be non-low latency data. To transmit the first data to AP 2402, STA 2404 may transmit an RTS frame 2412 to AP 2402. RTS frame 2412 may indicate a duration of a TXOP 2410 to transmit the first data to AP 2402 (and including any intervening interframe spaces and the transmission time of an ACK frame, if required). In an implementation, the first data may be transmitted using multiple PPDUs. In an implementation, the PPDUs may be designed to be shorter than a pre-defined size (e.g., 2 milliseconds). The multiple PPDUs may be configured to be transmitted successively on the wireless medium, separated from one another by an interframe space, xIFS.

In an implementation, the PPDUs may be configured to include an indication of whether preemption of the PPDUs is allowed. When preemption is allowed, a preempting PPDU may be transmitted in between the multiple PPDUs. Transmission of the remaining PPDUs may resume after transmission of the preempting PPDU. In example 2400, it is assumed that the multiple PPDUs include a preemption indication set to 1 to indicate that preemption of the PPDUs is allowed.

On receiving RTS frame 2412, and assuming that its NAV indicates idle, AP 2402 may respond to STA 2404 by transmitting a CTS frame 2414 to STA 2404. In an implementation, AP 2402 transmits CTS frame 2414 a SIFS after receiving RTS frame 2412. Subsequently, STA 2404 may begin transmitting one or more PPDUs comprising the first data to AP 2402. For example, STA 2404 may transmit a PPDU 2416-1 comprising a first portion of the first data to AP 2402. In an implementation, STA 2404 may transmit PPDU 2416-1 an xIFS after receiving CTS frame 2414 from STA 2404. In an example, PPDU 2416-1 may include a preemption indication that indicates whether preemption of the multiple PPDUs is allowed.

In example 2400, while STA 2404 transmits PPDU 2416-1 to AP 2402, AP 2402 may have second data arrive for transmission to STA 2406. In an example, the second data may be low latency data that requires urgent transmission to STA 2406. In an example, the arrival of the second data may occur before or during the transmission by STA 2404 of PPDU 2416-1 to AP 2402.

In example 2400, the preemption indication of PPDU 2416-1 may be set to 1 indicating that preemption of the multiple PPDUs is allowed. As such, based on the arrival of the second data, AP 2402 may preempt a next PPDU 2416-2 from STA 2404 to AP 2402 to transmit a preemption request (PR) frame 2420 to STA 2404. In an implementation, PR frame 2420 is transmitted a SIFS after an end of PPDU 2416-1 to preempt the next PPDU 2416-2 from STA 2404 to AP 2402.

In an implementation, PR frame 2420 may have a similar format as the CTS frame format illustrated in FIG. 15. In an implementation, AP 2402 may be configured to set a receiver address (RA) field of PR frame 2420 based on a transmitter address (TA) comprised in PPDU 2416-1.

Subsequently, AP 2402 may transmit to STA 2406 a PPDU 2422 comprising the second data a SIFS after an end of PR frame 2420. In an example, PPDU 2422 may comprise low latency data. In an example, STA 2406 may acknowledge PPDU 2422 by transmitting a BA frame 2424.

In example 2400, STA 2404 may or may not overhear BA frame 2424 from STA 2406. In an example, AP 2402 may transmit to STA 2404 a preemption release (PRel) frame 2426 to inform STA 2404 of the release of preemption. In an example, PRel frame 2426 may indicate that preemption by AP 2402 is complete.

Based on receiving PRel frame 2426 from AP 2402, STA 2404 may resume transmission of the first data by transmitting a PPDU 2416-3 comprising a second portion of the first data to AP 2402. PPDU 2416-3 may be transmitted a SIFS after an end of BA frame 2424. In an example, when PPDU 2416-3 is the final PPDU of the multiple PPDUs transmitted to AP 2402, AP 2402 may transmit a BA frame 2418 to STA 2404 on receiving PPDU 2416-3.

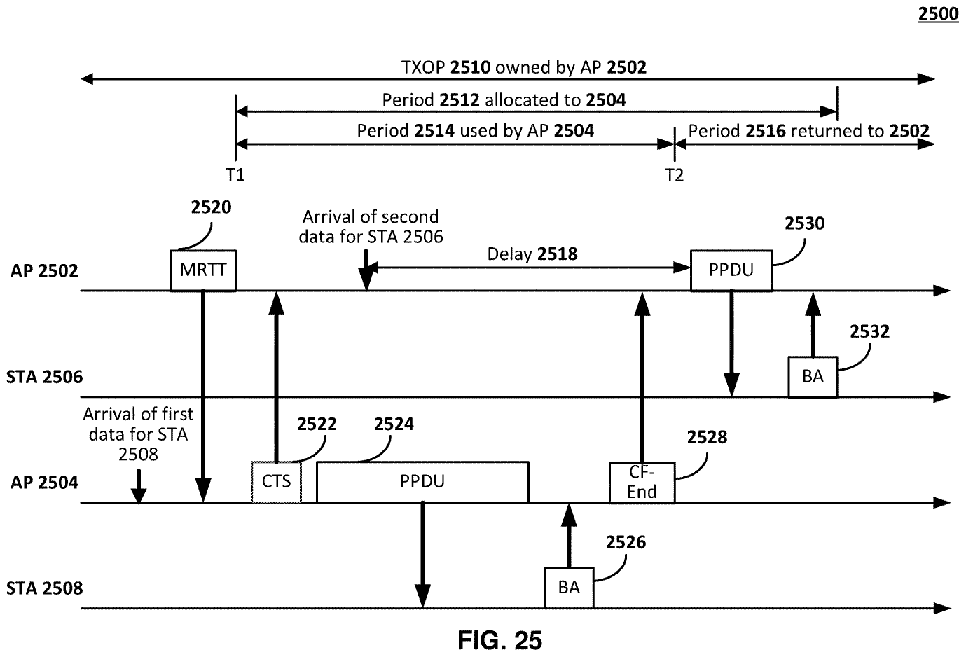

FIG. 25 is an example 2500 that illustrates an existing CTDMA procedure. As shown in FIG. 25, example 2500 may include APs 2502 and 2504 and STAs 2506 and 2508. AP 2502 and AP 2504 may be members of a multi-AP group. AP 2502 may be a sharing/master AP of the multi-AP group. AP 2504 may be a shared/slave AP of the multi-AP group. STA 2506 may be associated with AP 2502, and STA 2508 may be associated with AP 2504. In example 2500, it is assumed that APs 2502, 2504 and STAs 2506, 2508 are within communication range of each other.

As shown in FIG. 25, the procedure may begin with the arrival at AP 2504 of first data for transmission to STA 2508. The first data may be non-low latency data.

In an example, AP 2502 may transmit an MRTT frame 2520 after obtaining a TXOP 2510. In an example, MRTT frame 2520 may comprise an allocation for AP 2504. An allocation of MRTT frame 2520 may comprise an identifier of a shared AP and a duration (within the TXOP) allocated to the shared AP. In example 2500, MRTT frame 2520 may comprise an allocation for AP 2504. The allocation may comprise a period 2512 of TXOP 2510 allocated to AP 2504. Period 2512 may have a first duration starting at a time T1. The first duration of period 2512 may be indicated in an allocation duration subfield of a user info list field of MRTT frame 2520.

On receiving MRTT frame 2520, AP 2504 may determine that AP 2502 has shared TXOP 2510 with AP 2504 for the first duration of period 2512. AP 2504 may transmit a CTS frame 2522 to AP 2502, in response to MRTT frame 2520.

After transmitting CTS frame 2522, AP 2504 may use the TXOP for the remaining duration of the first duration of period 2512. In an example, AP 2504 may transmit a downlink frame to STA 2508. In another example, AP 2504 may trigger STA 2508 to transmit an uplink frame to AP 2504 (not shown in FIG. 25). In example 2500, after transmitting CTS frame 2522, AP 2504 may transmit a PPDU 2524 comprising the first data to STA 2508. PPDU 2524 may be longer than a pre-defined size (e.g., 2 milliseconds). In response to PPDU 2524, AP 2504 may transmit a BA frame 2526 to AP 2504.

In example 2500, while AP 2504 transmits PPDU 2524 to STA 2508, AP 2502 may have second data arrive for transmission to STA 2506. In an example, the second data may be low latency data that requires urgent transmission to STA 2506. In an example, the arrival of the second data may occur before or during the transmission by AP 2504 of PPDU 2524 to STA 2508.

In an example, after receiving BA frame 2526 from STA 2508, AP 2504 may not have further uplink and/or downlink transmissions to perform within the remainder of the first duration of period 2512 allocated to AP 2504. In an implementation, AP 2504 may return the remainder of period 2512 to AP 2502 (also referred to as truncating period 2512). In example 2500, AP 2504 may transmit a frame 2528 indicating a return by AP 2504 of period 2512 to AP 2502 (or indicating truncation by AP 2504 of period 2512). In an example, frame 2528 may be a contention free-end (CF-end) frame. In an example, CF-end frame 2528 may comprise a transmitter address (TA) indicating AP 2504. In an example, CF-end frame 2528 may be a broadcast frame. As shown in FIG. 25, AP 2504 may return period 2512 after using only a period 2514 of period 2512. Period 2514 may have a second duration starting at time T1 and ending at a time T2.

In an example, with the return of period 2512 to AP 2502, AP 2502 may initiate uplink and/or downlink transmissions for the remaining duration of TXOP 2510 (which includes the remainder of the first duration of period 2512) starting at time T2. As shown in FIG. 25, the remaining duration of TXOP 2510 may include a period 2516, which may comprise the returned portion of period 2512. In an example, AP 2502 may transmit a PPDU 2530 comprising the second data to STA 2506 to initiate a downlink transmission. In response to PPDU 2530, STA 2506 may transmit a BA frame 2532 to AP 2502.

In an example, after receiving BA frame 2532, AP 2502 may continue uplink and/or downlink transmissions within TXOP 2510. In another example, AP 2502 may share a remaining portion of TXOP 2510 with another shared AP.

As shown in FIG. 25, AP 2502 delivers the second data comprising low-latency traffic to STA 2506 with a delay 2518. Delay 2518 may result in significant latency for the CTDMA procedure. As such, the multi-AP operation may become inefficient.

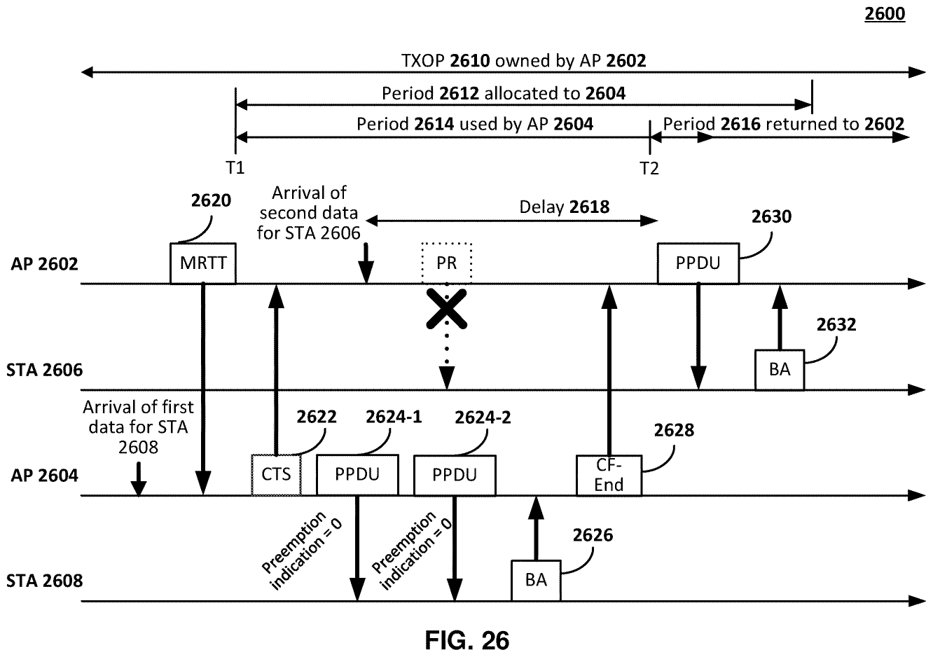

FIG. 26 is an example 2600 that illustrates an existing CTDMA procedure. As shown in FIG. 26, example 2600 may include APs 2602 and 2604 and STAs 2606 and 2608. AP 2602 and AP 2604 may be members of a multi-AP group. AP 2602 may be a sharing/master AP of the multi-AP group. AP 2604 may be a shared/slave AP of the multi-AP group. STA 2606 may be associated with AP 2602, and STA 2608 may be associated with AP 2604. In example 2600, it is assumed that APs 2602, 2604 and STAs 2606, 2608 are within communication range of each other.

As shown in FIG. 26, the procedure may begin with the arrival at AP 2604 of first data for transmission to STA 2608. The first data may be non-low latency data. In an implementation, the first data may be transmitted using multiple PPDUs. In an implementation, the PPDUs may be designed to be shorter than a pre-defined size (e.g., 2 milliseconds). The multiple PPDUs may be configured to be transmitted successively on the wireless medium, separated from one another by an interframe space, xIFS.

In an implementation, the PPDUs may be configured to include an indication of whether preemption of the PPDUs is allowed. When preemption is allowed, a preempting PPDU may be transmitted in between the multiple PPDUs. Transmission of the remaining PPDUs may resume after transmission of the preempting PPDU. In example 2600, it is assumed that the multiple PPDUs include a preemption indication set to 1 to indicate that preemption of the PPDUs is allowed. In example 2400, it is assumed that the multiple PPDUs include a preemption indication set to 0 to indicate that preemption of the PPDUs is disallowed.

In an example, AP 2602 may transmit an MRTT frame 2620 after obtaining a TXOP 2610. In an example, MRTT frame 2620 may comprise an allocation for AP 2604. An allocation of MRTT frame 2620 may comprise an identifier of a shared AP and a duration (within the TXOP) allocated to the shared AP. In example 2600, MRTT frame 2620 may comprise an allocation for AP 2604. The allocation may comprise a period 2612 of TXOP 2610 allocated to AP 2604. Period 2612 may have a first duration starting at a time T1. The first duration of period 2612 may be indicated in an allocation duration subfield of a user info list field of MRTT frame 2620.

On receiving MRTT frame 2620, AP 2604 may determine that AP 2602 has shared TXOP 2610 with AP 2604 for the first duration of period 2612. AP 2604 may transmit a CTS frame 2622 to AP 2602, in response to MRTT frame 2620.

After transmitting CTS frame 2622, AP 2604 may use the TXOP for the remaining duration of the first duration of period 2612. In an example, AP 2604 may transmit a downlink frame to STA 2608. In another example, AP 2604 may trigger STA 2608 to transmit an uplink frame to AP 2604 (not shown in FIG. 26). In example 2600, after transmitting CTS frame 2622, AP 2604 may transmit one or more PPDUs comprising the first data to STA 2608. For example, AP 2604 may transmit a PPDU 2624-1 comprising a first portion of the first data to STA 2608. In an implementation, AP 2604 may transmit PPDU 2624-1 an xIFS after transmitting CTS frame 2622 to AP 2602. In an example, PPDU 2624-1 may include a preemption indication that indicates whether preemption of the one or more PPDUs is allowed.

In example 2600, while AP 2604 transmits PPDU 2624-1 to STA 2608, AP 2602 may have second data arrive for transmission to STA 2606. In an example, the second data may be low latency data that requires urgent transmission to STA 2606. In an example, the arrival of the second data may occur before or during the transmission by AP 2604 of PPDU 2624-1 to STA 2608.

In example 2600, the preemption indication of PPDU 2624-1 may be set to 0 indicating that preemption of the one or more PPDUs being transmitted from AP 2604 to STA 2608 is disallowed. As such, based on the arrival of the second data, AP 2602 may not preempt a next PPDU 2624-2 from AP 2604 to STA 2608 to transmit a preemption request (PR) frame to AP 2604.

In an example, AP 2604 may continue transmission of a remaining portion of the first data to STA 2608 by transmitting a PPDU 2624-2 a SIFS after an end of PPDU 2624-1. In response to PPDUs 2624-1 and 2624-2, STA 2608 may transmit a BA frame 2626 to AP 2604.

In an example, after receiving BA frame 2626 from STA 2608, AP 2604 may not have further uplink and/or downlink transmissions to perform within the remainder of the first duration of period 2612 allocated to AP 2604. In an implementation, AP 2604 may return the remainder of period 2612 to AP 2602 (also referred to as truncating period 2612). In example 2600, AP 2604 may transmit a frame 2628 indicating a return by AP 2604 of period 2612 to AP 2602 (or indicating truncation by AP 2604 of period 2612). In an example, frame 2628 may be a contention free-end (CF-end) frame. In an example, CF-end frame 2628 may comprise a transmitter address (TA) indicating AP 2604. In an example, CF-end frame 2628 may be a broadcast frame. As shown in FIG. 26, AP 2604 may return period 2612 after using only a period 2614 of period 2012. Period 2614 may have a second duration starting at time T1 and ending at a time T2.

In an example, with the return of period 2612 to AP 2602, AP 2602 may initiate uplink and/or downlink transmissions for the remaining duration of TXOP 2610 (which includes the remainder of the first duration of period 2612) starting at time T2. As shown in FIG. 26, the remaining duration of TXOP 2610 may include a period 2616, which may comprise the returned portion of period 2612. In an example, AP 2602 may transmit a PPDU 2630 comprising the second data to STA 2606 to initiate a downlink transmission. In response to PPDU 2630, STA 2606 may transmit a BA frame 2632 to AP 2602.

In an example, after receiving frame 2632, AP 2602 may continue uplink and/or downlink transmissions within TXOP 2610. In another example, AP 2602 may share a remaining portion of TXOP 2610 with another shared AP.

As shown in FIG. 26, AP 2602 delivers the second data comprising low-latency traffic to STA 2606 with a delay 2618. Delay 2618 may result in significant latency for the CTDMA procedure. As such, the multi-AP operation may become inefficient.

Embodiments of the present disclosure, as further described below, address the above-described problems of existing CTDMA procedures.

In a one aspect, a first AP may receive from a second AP a first frame comprising a first field used to determine whether preemption within a first duration is allowed. The first frame may further indicate an identifier of the first AP. The first field may indicate a preference/recommendation of the second AP regarding preemption within the first duration. The first AP may transmit to the second AP a second frame comprising a second field used to determine whether preemption of a next frame is allowed, wherein a value of the second field is based on a value of the first field. In an embodiment, the first frame may indicate a threshold for determining whether preemption is allowed within the first duration. Preemption of the next frame may be allowed when a length of the second frame is larger than the threshold. In another embodiment, the first frame may indicate a first period. Preemption of the next frame may be allowed when the second frame is transmitted after the end of the first period. In a further embodiment, the first frame may indicate a second period. Preemption of the next frame may be allowed when the first AP does not return the first duration to the second AP earlier than the end of the second period.

In another aspect, a first AP may receive from a second AP a first frame requesting the first AP allow preemption. The first AP may transmit to the second AP a second frame in response to the first frame. In an embodiment, the first AP may transmit, during a first duration, a third frame comprising a second field used to determine whether preemption of a next frame is allowed. A value of the second field may be based on the second frame. In an embodiment, the first frame may request that the first AP allow preemption when the third frame is larger than a threshold. In another embodiment, the first frame may request that the first AP allow preemption when the third frame is transmitted after the end of a first period. In a further embodiment, the first frame may request that the first AP allow preemption when the first AP does not return the first duration to the second AP earlier than the end of a second period. In a further embodiment, the first frame may request that the first AP allow preemption within a third period, where the third period comprises a third starting time and a third duration. The first AP may accept or reject the request in response to the first frame. The second frame may further comprise a fourth period during which the first AP accepts to allow preemption, where the fourth period comprises a fourth starting time and a fourth duration. The first frame may further solicit from the first AP a third period during which the first AP accepts to allow preemption, wherein the third period, comprising a third starting time and a third duration, is for allocation to the first AP. The second frame may comprise the third period.

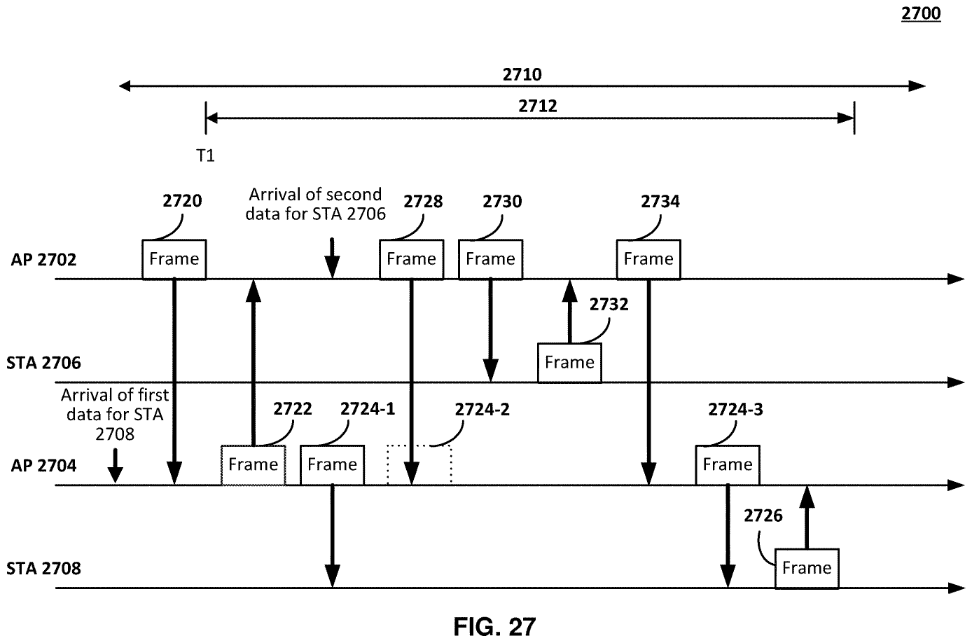

FIG. 27 is an example 2700 that illustrates a preemption coordination procedure according to an embodiment. Example 2700 is provided for the purpose of illustration only and is not limiting. As shown in FIG. 27, example 2700 includes an AP 2702, an AP 2704, a STA 2706, and a STA 2708. In an example, STA 2706 may be associated with AP 2702. In an example, STA 2708 may be associated with AP 2704. AP 2702, AP 2704, STA 2706, and/or STA 2708 may each comprise a multi-link device (MLD).

In an example, APs 2702 and 2704 may belong to the same ESS as described above in FIG. 1. In such a case, APs 2702 and 2704 may be connected by a DS to support ESS features. In an example, APs 2702 and 2704 belong to different BSSs. In an embodiment, AP 2702 may belong to a first BSS and AP 2704 may belong to a second BSS. In an embodiment, the second BSS may comprise an overlapping basic service set (OBSS) relative to the first BSS.

In an embodiment, AP 2702 and 2704 may form a multi-AP group. AP 2702 may be a sharing/master AP of the multi-AP group. AP 2704 may be a shared/slave AP of the multi-AP group. It is assumed in example 2700, APs 2702 and 2704 may complete a multi-AP setup procedure prior to the beginning of example 2700. In addition, as part of a multi-AP group, APs 2702 and 2704 may be connected by a backhaul. In an example, the backhaul may be a wireless backhaul.

Before example 2700 begins, AP 2702 and AP 2704 may complete a multi-AP selection phase such as multi-AP selection phase 1010 described in FIG. 10 above.

It is assumed in example 2700 that AP 2702 supports a preemption coordination capability. In an example, support of the preemption coordination capability allows AP 2702 to transmit a frame (such as frame 2720 described below) to indicate a preference/recommendation of AP 2702 regarding preemption within a first duration allocated by AP 2702 to another AP. AP 2702 may further support a preemption capability which allows AP 2702 to transmit frames (such as frames 2728, 2730, 2734 described below) to preempt frames of the other AP within the first duration.

It is also assumed in example 2700 that AP 2704 supports the preemption coordination capability. In an example, support of the preemption coordination capability allows AP 2704 to receive and process a frame (such as frame 2720) from another AP indicating a preference/recommendation of the other AP regarding preemption within a first duration allocated by the other AP to AP 2704 and to determine, based on the received frame, whether to allow preemption within the first duration. In an example, the preemption coordination capability may further allow AP 2704 to transmit frames (such as frames 2724-1 and 2724-3 described below) that comprise an indication of whether preemption of the frames (such as frame 2724-2) is allowed.

In an embodiment, prior to the beginning of example 2700, APs 2702 and 2704 may exchange a first frame and a second frame (not shown in FIG. 27) to exchange capability information. In an embodiment, the first frame may comprise the capability information of AP 2702, including a first indication of support by AP 2702 of the preemption coordination capability and/or the preemption capability. In an embodiment, the second frame may comprise the capability information of AP 2704, including a second indication of support by AP 2704 of the preemption coordination capability. In an embodiment, the first frame and the second frame may be exchanged during a multi-AP setup procedure or a multi-AP selection phase. In an embodiment, the first frame and the second frame may comprise a management frame.

As shown in FIG. 27, example 2700 may begin with the arrival at AP 2704 of first data for transmission to STA 2708. The first data may be non-low latency data. In an implementation, the first data may be transmitted using multiple PPDUs. In an implementation, the PPDUs may be designed to be shorter than a pre-defined size (e.g., 2 milliseconds). The multiple PPDUs may be configured to be transmitted successively on the wireless medium, separated from one another by an interframe space, xIFS.

In an implementation, the PPDUs may be configured to include an indication of whether preemption of the PPDUs is allowed. When preemption is allowed, a preempting PPDU may be transmitted in between the multiple PPDUs. Transmission of the remaining PPDUs may resume after transmission of the preempting PPDU. In example 2700, it is assumed that the multiple PPDUs include a preemption indication set to 1 to indicate that preemption of the PPDUs is allowed.

In an embodiment, AP 2702 may transmit a frame 2720 after obtaining a TXOP 2710.

In an embodiment, frame 2720 may comprise an allocation for AP 2704. An allocation of frame 2720 may comprise an identifier of a shared AP and a duration (within the TXOP) allocated to the shared AP. In an embodiment, the allocation of frame 2720 may comprise an identifier of AP 2704. In example 2700, frame 2720 may comprise an allocation for AP 2704. In an embodiment, the allocation may comprise a period 2712 of TXOP 2710 allocated to AP 2704. In an embodiment, period 2712 may have a first duration starting at a time T1. In an embodiment, the first duration of period 2712 may be indicated in an allocation duration subfield of a user info list field. In example 2700, period 2712 may start at time T1.

In an embodiment, frame 2720 may further comprise a first field used (e.g., by AP 2704) to determine whether preemption within the first duration of period 2712 is allowed. In an embodiment, the first field may indicate a preference/recommendation of AP 2702 regarding preemption within the first duration of period 2712. In an embodiment, where the first field indicates a preference/recommendation of AP 2702 for the allowance of preemption within the first duration, the first field may further indicate that AP 2702 is capable/configured to preempt within the first duration of period 2712 by initiating an uplink or downlink transmission for a second data. In an embodiment, the second data may be low latency data that requires urgent transmission. In an embodiment, the second data may be unscheduled. In an example, the first field may set to a value of 1 to indicate a preference/recommendation of AP 2702 for the allowance of preemption within the first duration. In an embodiment, the first field may further indicate that only AP 2702 is allowed to preempt within the first duration.

In an embodiment, frame 2720 may comprise a management frame. In an embodiment, the management frame may comprise a trigger frame. In an example, the trigger frame may comprise an MRTT frame.

On receiving frame 2720, AP 2704 may determine that AP 2702 has shared TXOP 2710 with AP 2704 for the first duration of period 2712. AP 2704 may transmit a frame 2722 to AP 2702, in response to frame 2720. In an example, frame 2722 may comprise a CTS frame.

After transmitting frame 2722, AP 2704 may use the TXOP for the remaining duration of the first duration of period 2712. In an example, AP 2704 may transmit a downlink frame to STA 2708. In another example, AP 2704 may trigger STA 2708 to transmit an uplink frame to AP 2704 (not shown in FIG. 27).

In example 2700, after transmitting frame 2722, AP 2704 may transmit one or more PPDUs comprising the first data to STA 2708.

In an embodiment, AP 2704 may transmit a frame 2724-1 during the first duration of period 2712. In an embodiment, frame 2724-1 may comprise a first portion of the first data. In an implementation, AP 2704 may transmit frame 2724-1 an xIFS after transmitting frame 2722 to AP 2702.

In an embodiment, frame 2724-1 may comprise a second field used (by another AP or STA) to determine whether preemption of a next frame 2724-2 following frame 2724-1 is allowed. In an embodiment, a value of the second field is based on a value of the first field comprised in frame 2720.

In example 2700, while AP 2704 transmits frame 2724-1 to STA 2708, AP 2702 may have second data arrive for transmission to STA 2706. In an example, the second data may be low latency data that requires urgent transmission to STA 2706. In an example, the arrival of the second data may occur before or during the transmission by AP 2704 of frame 2724-1 to STA 2708.

In example 2700, based on the preference/recommendation of AP 2702 indicated in frame 2720 indicating a preference/recommendation for the allowance of preemption, the second field of frame 2724-1 may be set to 1 indicating that preemption of next frame 2724-2 following frame 2724-1 is allowed. In an embodiment, the second field of frame 2724-1 may further indicate that only AP 2702 is allowed to preempt. In another embodiment, the second field of frame 2724-1 may further indicate that preemption is not allowed by a non-AP STA (such as STA 2708). In an example, the second field of frame 2724-1 may be set to 11 indicating that preemption of next frame 2724-2 following frame 2724-1 is allowed by AP 2702 only. This allows AP 2702 to use preemption to transmit arriving data and particularly to transmit low latency data with a low delay.

In an embodiment, based on the arrival of the second data, AP 2702 may preempt a next frame 2724-2 from AP 2704 to STA 2708 to transmit a frame 2728 to AP 2704. In an example, frame 2728 may comprise a preemption request (PR) frame. In an implementation, frame 2728 is transmitted a SIFS after an end of frame 2724-1 to preempt next frame 2724-2 from AP 2704 to STA 2708.

Subsequently, AP 2702 may transmit to STA 2706 a frame 2730 comprising the second data a SIFS after an end of frame 2728. In an example, frame 2730 may comprise a data frame. In an example, STA 2706 may acknowledge frame 2730 by transmitting a frame 2732. In an example, frame 2732 may comprise a BA frame.

In another example (not shown in FIG. 27), the second data may arrive at STA 2706. In an example, AP 2702 may solicit an uplink transmission comprising the second data from STA 2706 to AP 2702. For example, after sending frame 2728, AP 2702 may transmit a trigger frame to STA 2706 to trigger the uplink transmission from STA 2706 to AP 2702.

In example 2700, AP 2704 may or may not overhear frame 2732 from STA 2706. In an example, AP 2702 may transmit to AP 2704 a frame 2734 to inform AP 2704 of the release of preemption. In an example, frame 2734 may comprise a preemption release (PRel) frame. In an example, frame 2734 may indicate that preemption by AP 2702 is complete.

Based on receiving frame 2734 from AP 2702, AP 2704 may resume transmission of the first data by transmitting a frame 2724-3 comprising a second portion of the first data to AP 2702. Frame 2724-3 may be transmitted a SIFS after an end of frame 2734. In an example, when frame 2724-3 is the final PPDU of the multiple PPDUs transmitted to STA 2708, STA 2708 may transmit a frame 2726 to acknowledge frame 2724-3. In an example, frame 2726 may comprise a BA frame.

As a result, delay of transmission of low latency traffic may be avoided and the preemption for multi-AP procedure using CTDMA can be completed efficiently. Latency can be reduced for multi-AP communication.

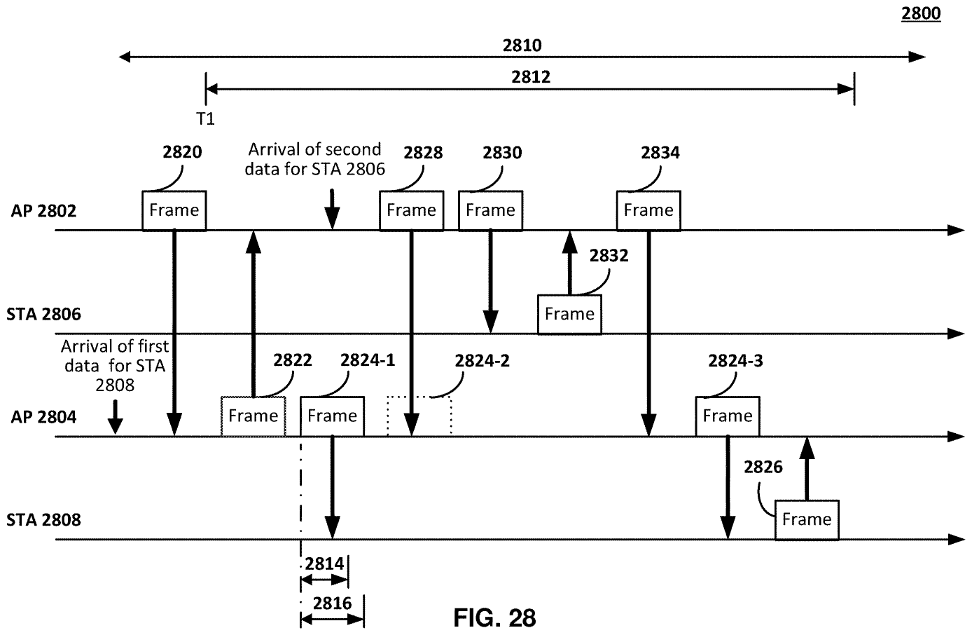

FIG. 28 is an example 2800 that illustrates a preemption coordination procedure according to an embodiment. Example 2800 is provided for the purpose of illustration only and is not limiting. As shown in FIG. 28, example 2800 includes an AP 2802, an AP 2804, a STA 2806, and a STA 2808. In an example, STA 2806 may be associated with AP 2802. In an example, STA 2808 may be associated with AP 2804. AP 2802, AP 2804, STA 2806, and/or STA 2808 may each comprise a multi-link device (MLD).

In an example, APs 2802 and 2804 may belong to the same ESS as described above in FIG. 1. In such a case, APs 2802 and 2804 may be connected by a DS to support ESS features. In an example, APs 2802 and 2804 belong to different BSSs. In an embodiment, AP 2802 may belong to a first BSS and AP 2804 may belong to a second BSS. In an embodiment, the second BSS may comprise an overlapping basic service set (OBSS) relative to the first BSS.

In an embodiment, AP 2802 and 2804 may form a multi-AP group. AP 2802 may be a sharing/master AP of the multi-AP group. AP 2804 may be a shared/slave AP of the multi-AP group. It is assumed in example 2800, APs 2802 and 2804 may complete a multi-AP setup procedure prior to the beginning of example 2800. In addition, as part of a multi-AP group, APs 2802 and 2804 may be connected by a backhaul. In an example, the backhaul may be a wireless backhaul.

Before example 2800 begins, AP 2802 and AP 2804 may complete a multi-AP selection phase such as multi-AP selection phase 1010 described in FIG. 10 above.

It is assumed in example 2800 that AP 2802 supports a preemption coordination capability. In an example, support of the preemption coordination capability allows AP 2802 to transmit a frame (such as frame 2820 described below) to indicate a threshold for determining whether preemption is allowed within a first duration allocated by AP 2802 to another AP. AP 2802 may further support a preemption capability which allows AP 2802 to transmit frames (such as frames 2828, 2830, 2834 described below) to preempt frames of the other AP within the first duration.

It is also assumed in example 2800 that AP 2804 supports the preemption coordination capability. In an example, support of the preemption coordination capability allows AP 2804 to receive and process a frame (such as frame 2820) from another AP indicating a threshold for determining whether preemption is allowed within a first duration allocated by the other AP to AP 2804 and to determine, based on the received frame, whether to allow preemption within the first duration. In an example, the preemption coordination capability may further allow AP 2804 to transmit frames (such as frames 2824-1 and 2824-3 described below) that comprise an indication of whether preemption of the frames (such as frame 2824-2) is allowed.

In an embodiment, prior to the beginning of example 2800, APs 2802 and 2804 may exchange a first frame and a second frame (not shown in FIG. 28) to exchange capability information. In an embodiment, the first frame may comprise the capability information of AP 2802, including a first indication of support by AP 2802 of the preemption coordination capability and/or the preemption capability. In an embodiment, the second frame may comprise the capability information of AP 2804, including a second indication of support by AP 2804 of the preemption coordination capability. In an embodiment, the first frame and the second frame may be exchanged during a multi-AP setup procedure or a multi-AP selection phase. In an embodiment, the first frame and the second frame may comprise a management frame.

As shown in FIG. 28, example 2800 may begin with the arrival at AP 2804 of first data for transmission to STA 2808. The first data may be non-low latency data. In an implementation, the first data may be transmitted using multiple PPDUs. In an implementation, the PPDUs may be designed to be shorter than a pre-defined size (e.g., 2 milliseconds). The multiple PPDUs may be configured to be transmitted successively on the wireless medium, separated from one another by an interframe space, xIFS.

In an implementation, the PPDUs may be configured to include an indication of whether preemption of the PPDUs is allowed. When preemption is allowed, a preempting PPDU may be transmitted in between the multiple PPDUs. Transmission of the remaining PPDUs may resume after transmission of the preempting PPDU. In example 2800, it is assumed that the multiple PPDUs include a preemption indication set to 1 to indicate that preemption of the PPDUs is allowed.

In an embodiment, AP 2802 may transmit a frame 2820 after obtaining a TXOP 2810.

In an embodiment, frame 2820 may comprise an allocation for AP 2804. An allocation of frame 2820 may comprise an identifier of a shared AP and a duration (within the TXOP) allocated to the shared AP. In an embodiment, the allocation of frame 2820 may comprise an identifier of AP 2804. In example 2800, frame 2820 may comprise an allocation for AP 2804. In an embodiment, the allocation may comprise a period 2812 of TXOP 2810 allocated to AP 2804. In an embodiment, period 2812 may have a first duration starting at a time T1. In an embodiment, the first duration of period 2812 may be indicated in an allocation duration subfield of a user info list field. In example 2800, period 2812 may start at time T1.

In an embodiment, frame 2820 may further comprise a threshold 2814 used (e.g., by AP 2804) to determine whether preemption within the first duration of period 2812 is allowed. In an example, threshold 2814 may be set to a time duration, e.g., in microseconds. In another example, threshold 2814 may be set to a length, e.g., in octets. In an embodiment, preemption may be allowed when a length 2816 of a frame 2824-1 is larger than threshold 2814. Length 2816 may indicate a time duration or a length in octets or bytes for example. In an embodiment, threshold 2814 may be comprised in a first field of frame 2820. In an embodiment, where the first field indicates a threshold for the allowance of preemption within the first duration, first field may further indicate that AP 2802 is capable/configured to preempt within the first duration of period 2812 by initiating an uplink or downlink transmission for a second data. In an embodiment, the second data may be low latency data that requires urgent transmission. In an embodiment, the second data may be unscheduled. In an embodiment, the first field may further indicate that only AP 2802 is allowed to preempt within the first duration.

In an embodiment, frame 2820 may comprise a management frame. In an embodiment, the management frame may comprise a trigger frame. In an example, the trigger frame may comprise an MRTT frame.

On receiving frame 2820, AP 2804 may determine that AP 2802 has shared TXOP 2810 with AP 2804 for the first duration of period 2812. AP 2804 may transmit a frame 2822 to AP 2802, in response to frame 2820. In an example, frame 2822 may comprise a CTS frame.

After transmitting frame 2822, AP 2804 may use the TXOP for the remaining duration of the first duration of period 2812. In an example, AP 2804 may transmit a downlink frame to STA 2808. In another example, AP 2804 may trigger STA 2808 to transmit an uplink frame to AP 2804 (not shown in FIG. 28).

In example 2800, after transmitting frame 2822, AP 2804 may transmit one or more PPDUs comprising the first data to STA 2808.

In an embodiment, AP 2804 may transmit a frame 2824-1 during the first duration of period 2812. In an embodiment, frame 2824-1 may comprise a first portion of the first data. In an implementation, AP 2804 may transmit frame 2824-1 an xIFS after transmitting frame 2822 to AP 2802.

In an embodiment, frame 2824-1 may comprise a second field used (by another AP or STA) to determine whether preemption of a next frame 2824-2 following frame 2824-1 is allowed. In an embodiment, a value of the second field is based on a value of the first field comprised in frame 2820.

In example 2800, while AP 2804 transmits frame 2824-1 to STA 2808, AP 2802 may have second data arrive for transmission to STA 2806. In an example, the second data may be low latency data that requires urgent transmission to STA 2806. In an example, the arrival of the second data may occur before or during the transmission by AP 2804 of frame 2824-1 to STA 2808.

In example 2800, when length 2816 of frame 2824-1 is larger than threshold 2814, the second field of frame 2824-1 may be set to 1 indicating that preemption of next frame 2824-2 following frame 2824-1 is allowed. In an embodiment, the second field of frame 2824-1 may further indicate that only AP 2802 is allowed to preempt. In another embodiment, the second field of frame 2824-1 may further indicate that preemption is not allowed by a non-AP STA (such as STA 2808). In an example, the second field of frame 2824-1 may be set to 11 indicating that preemption of next frame 2824-2 following frame 2824-1 is allowed by AP 2802 only. This allows AP 2802 to use preemption to transmit arriving data and particularly to transmit low latency data with a low delay.

In an embodiment, based on the arrival of the second data, AP 2802 may preempt a next frame 2824-2 from AP 2804 to STA 2808 to transmit a frame 2828 to AP 2804. In an example, frame 2828 may comprise a preemption request (PR) frame. In an implementation, frame 2828 is transmitted a SIFS after an end of frame 2824-1 to preempt the next frame 2824-2 from AP 2804 to STA 2808.

Subsequently, AP 2802 may transmit to STA 2806 a frame 2830 comprising the second data a SIFS after an end of frame 2828. In an example, frame 2830 may comprise a data frame. In an example, STA 2806 may acknowledge frame 2830 by transmitting a frame 2832. In an example, frame 2832 may comprise a BA frame.

In another example (not shown in FIG. 28), the second data may arrive at STA 2806. In an example, AP 2802 may solicit an uplink transmission comprising the second data from STA 2806 to AP 2802. For example, after sending frame 2828, AP 2802 may transmit a trigger frame to STA 2806 to trigger the uplink transmission from STA 2806 to AP 2802.

In example 2800, AP 2804 may or may not overhear frame 2832 from STA 2806. In an example, AP 2802 may transmit to AP 2804 a frame 2834 to inform AP 2804 of the release of preemption. In an example, frame 2834 may comprise a preemption release (PRel) frame. In an example, frame 2834 may indicate that preemption by AP 2802 is complete.

Based on receiving frame 2834 from AP 2802, AP 2804 may resume transmission of the first data by transmitting a frame 2824-3 comprising a second portion of the first data to AP 2802. Frame 2824-3 may be transmitted a SIFS after an end of frame 2834. In an example, when frame 2824-3 is the final PPDU of the multiple PPDUs transmitted to STA 2808, STA 2808 may transmit a frame 2826 to acknowledge frame 2824-3. In an example, frame 2826 may comprise a BA frame.

As a result, delay of transmission of low latency traffic may be avoided and the preemption for multi-AP procedure using CTDMA can be completed efficiently. Latency can be reduced for multi-AP communication.

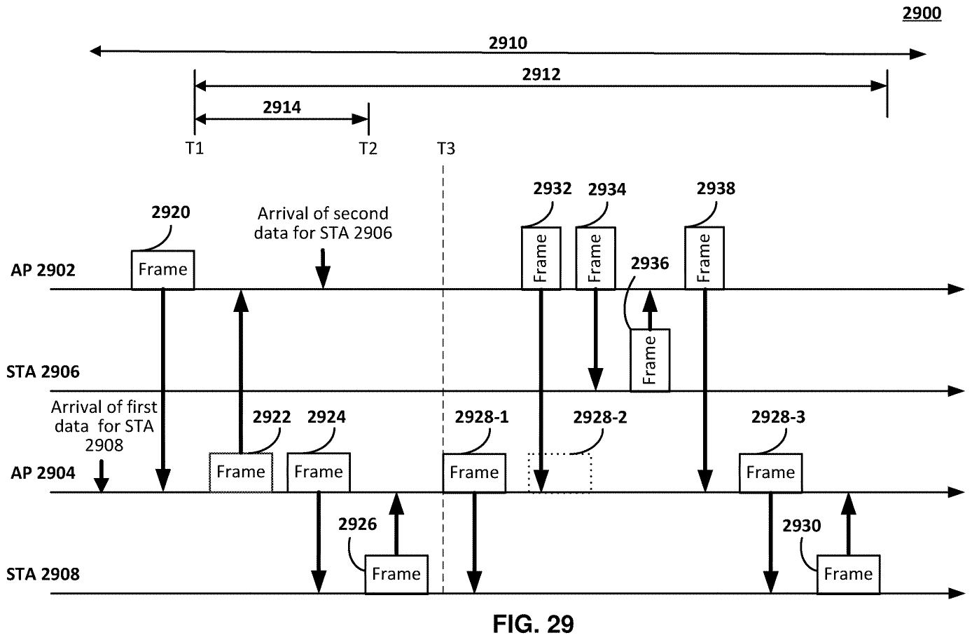

FIG. 29 is an example 2900 that illustrates a preemption coordination procedure according to an embodiment. Example 2900 is provided for the purpose of illustration only and is not limiting. As shown in FIG. 29, example 2900 includes an AP 2902, an AP 2904, a STA 2906, and a STA 2908. In an example, STA 2906 may be associated with AP 2902. In an example, STA 2908 may be associated with AP 2904. AP 2902, AP 2904, STA 2906, and/or STA 2908 may each comprise a multi-link device (MLD).

In an example, APs 2902 and 2904 may belong to the same ESS as described above in FIG. 1. In such a case, APs 2902 and 2904 may be connected by a DS to support ESS features. In an example, APs 2902 and 2904 belong to different BSSs. In an embodiment, AP 2902 may belong to a first BSS and AP 2904 may belong to a second BSS. In an embodiment, the second BSS may comprise an overlapping basic service set (OBSS) relative to the first BSS.

In an embodiment, AP 2902 and 2904 may form a multi-AP group. AP 2902 may be a sharing/master AP of the multi-AP group. AP 2904 may be a shared/slave AP of the multi-AP group. It is assumed in example 2900, APs 2902 and 2904 may complete a multi-AP setup procedure prior to the beginning of example 2900. In addition, as part of a multi-AP group, APs 2902 and 2904 may be connected by a backhaul. In an example, the backhaul may be a wireless backhaul.

Before example 2900 begins, AP 2902 and AP 2904 may complete a multi-AP selection phase such as multi-AP selection phase 1010 described in FIG. 10 above.

It is assumed in example 2900 that AP 2902 supports a preemption coordination capability. In an example, support of the preemption coordination capability allows AP 2902 to transmit a frame (such as frame 2920 described below) to indicate a first period for determining whether preemption is allowed within a first duration allocated by AP 2902 to another AP. AP 2902 may further support a preemption capability which allows AP 2902 to transmit frames (such as frames 2932, 2934, 2938 described below) to preempt frames of the other AP within the first duration.

It is also assumed in example 2900 that AP 2904 supports the preemption coordination capability. In an example, support of the preemption coordination capability allows AP 2904 to receive and process a frame (such as frame 2920) from another AP indicating a first period for determining whether preemption is allowed within a first duration allocated by the other AP to AP 2904 and to determine, based on the received frame, whether to allow preemption within the first duration. In an example, the preemption coordination capability may further allow AP 2904 to transmit frames (such as frames 2924, 2928-1 and 2928-3 described below) that comprise an indication of whether preemption of the frames (such as frame 2928-2) is allowed.

In an embodiment, prior to the beginning of example 2900, APs 2902 and 2904 may exchange a first frame and a second frame (not shown in FIG. 29) to exchange capability information. In an embodiment, the first frame may comprise the capability information of AP 2902, including a first indication of support by AP 2902 of the preemption coordination capability and/or the preemption capability. In an embodiment, the second frame may comprise the capability information of AP 2904, including a second indication of support by AP 2904 of the preemption coordination capability. In an embodiment, the first frame and the second frame may be exchanged during a multi-AP setup procedure or a multi-AP selection phase. In an embodiment, the first frame and the second frame may comprise a management frame.

As shown in FIG. 29, example 2900 may begin with the arrival at AP 2904 of first data for transmission to STA 2908. The first data may be non-low latency data. In an implementation, the first data may be transmitted using multiple PPDUs. In an implementation, the PPDUs may be designed to be shorter than a pre-defined size (e.g., 2 milliseconds). The multiple PPDUs may be configured to be transmitted successively on the wireless medium, separated from one another by an interframe space, xIFS.

In an implementation, the PPDUs may be configured to include an indication of whether preemption of the PPDUs is allowed. When preemption is allowed, a preempting PPDU may be transmitted in between the multiple PPDUs. Transmission of the remaining PPDUs may resume after transmission of the preempting PPDU. In example 2900, it is assumed that the multiple PPDUs include a preemption indication set to 1 to indicate that preemption of the PPDUs is allowed.

In an embodiment, AP 2902 may transmit a frame 2920 after obtaining a TXOP 2910.

In an embodiment, frame 2920 may comprise an allocation for AP 2904. An allocation of frame 2920 may comprise an identifier of a shared AP and a duration (within the TXOP) allocated to the shared AP. In an embodiment, the allocation of frame 2920 may comprise an identifier of AP 2904. In example 2900, frame 2920 may comprise an allocation for AP 2904. In an embodiment, the allocation may comprise a period 2912 of TXOP 2910 allocated to AP 2904. In an embodiment, period 2912 may have a first duration starting at a time T1. In an embodiment, the first duration of period 2912 may be indicated in an allocation duration subfield of a user info list field. In example 2900, period 2912 may start at time T1.

In an embodiment, frame 2920 may further comprise/indicate a first period 2914 used (e.g., by AP 2904) to determine whether preemption within the first duration of period 2912 is allowed. In an example, first period 2914 may start at time T1 and end at a time T2. In an embodiment, preemption of a frame (e.g., frame 2928-1) may be allowed when the frame is transmitted after the end of first period 2914. In an embodiment, first period 2914 may be comprised in a first field of frame 2920. In an embodiment, where the first field indicates first period 2914, the first field may further indicate that AP 2902 is capable/configured to preempt within the first duration of period 2912 by initiating an uplink or downlink transmission for a second data. In an embodiment, the second data may be low latency data that requires urgent transmission. In an embodiment, the second data may be unscheduled. In an embodiment, the first field may further indicate that only AP 2902 is allowed to preempt within the first duration.

In an embodiment, frame 2920 may comprise a management frame. In an embodiment, the management frame may comprise a trigger frame. In an example, the trigger frame may comprise an MRTT frame.

On receiving frame 2920, AP 2904 may determine that AP 2902 has shared TXOP 2910 with AP 2904 for the first duration of period 2912. AP 2904 may transmit a frame 2922 to AP 2902, in response to frame 2920. In an example, frame 2922 may comprise a CTS frame.

After transmitting frame 2922, AP 2904 may use the TXOP for the remaining duration of the first duration of period 2912. In an example, AP 2904 may transmit a downlink frame to STA 2908. In another example, AP 2904 may trigger STA 2908 to transmit an uplink frame to AP 2904 (not shown in FIG. 29).

In example 2900, after transmitting frame 2922, AP 2904 may transmit one or more PPDUs comprising the first data to STA 2908.

In an embodiment, AP 2904 may transmit a frame 2924 before time T2 during the first duration of period 2912. In an embodiment, frame 2924 may comprise a first portion of the first data. In an implementation, AP 2904 may transmit frame 2924 an xIFS after transmitting frame 2922 to AP 2902.

In an embodiment, frame 2924 may comprise a second field used (by another AP or STA) to determine whether preemption of a next frame 2926 following frame 2924 is allowed. In an embodiment, a value of the second field is based on a value of the first field comprised in frame 2920.

In example 2900, while AP 2904 transmits frame 2924 to STA 2908, AP 2902 may have second data arrive for transmission to STA 2906. In an example, the second data may be low latency data that requires urgent transmission to STA 2906. In an example, the arrival of the second data may occur before or during the transmission by AP 2904 of frame 2924 to STA 2908.

As shown in FIG. 29, frame 2924 may be transmitted before the end of first period 2914. In example 2900, based on first period 2914 indicated in frame 2920, the second field of frame 2924 may be set to 0 indicating that preemption of next frame 2926 following frame 2924 is disallowed. This disallows AP 2902 to use preemption to transmit arriving data. In an example, STA 2908 may transmit a frame 2926 to acknowledge frame 2924. In an example, frame 2926 may comprise a BA frame.

In an embodiment, AP 2904 may transmit a frame 2928-1 at a time T3 during the first duration of period 2912. In an embodiment, frame 2928-1 may comprise a second portion of the first data. In an implementation, AP 2904 may transmit frame 2928-1 an xIFS after receiving frame 2926 from STA 2908.

In an embodiment, frame 2928-1 may comprise a second field used (by another AP or STA) to determine whether preemption of a next frame 2928-2 following frame 2928-1 is allowed. In an embodiment, a value of the second field is based on a value of the first field comprised in frame 2920.

In example 2900, based on frame 2928-1 being transmitted after the end of first period 2914, the second field of frame 2928-1 may be set to 1 indicating that preemption of next frame 2928-2 following frame 2928-1 is allowed. In an embodiment, the second field of frame 2928-1 may further indicate that only AP 2902 is allowed to preempt. In another embodiment, the second field of frame 2928-1 may further indicate that preemption is not allowed by a non-AP STA (such as STA 2908). In an example, the second field of frame 2928-1 may be set to 11 indicating that preemption of next frame 2928-2 following frame 2928-1 is allowed by AP 2902 only. This allows AP 2902 to use preemption to transmit arriving data and particularly to transmit low latency data with a low delay.

In an embodiment, based on the arrival of the second data, AP 2902 may preempt frame 2928-2 from AP 2904 to STA 2908 to transmit a frame 2932 to AP 2904. In an example, frame 2932 may comprise a preemption request (PR) frame. In an implementation, frame 2932 is transmitted a SIFS after an end of frame 2928-1 to preempt next frame 2928-2 from AP 2904 to STA 2908.

Subsequently, AP 2902 may transmit to STA 2906 a frame 2934 comprising the third data a SIFS after an end of frame 2932. In an example, frame 2932 may comprise a data frame. In an example, STA 2906 may acknowledge frame 2934 by transmitting a frame 2936. In an example, frame 2936 may comprise a BA frame.

In another example (not shown in FIG. 29), the second data may arrive at STA 2906. In an example, AP 2902 may solicit an uplink transmission comprising the second data from STA 2906 to AP 2902. For example, after sending frame 2932, AP 2902 may transmit a trigger frame to STA 2906 to trigger the uplink transmission from STA 2906 to AP 2902.

In example 2900, AP 2904 may or may not overhear frame 2936 from STA 2906. In an example, AP 2902 may transmit to AP 2904 a frame 2938 to inform AP 2904 of the release of preemption. In an example, frame 2936 may comprise a preemption release (PRel) frame. In an example, frame 2938 may indicate that preemption by AP 2902 is complete.

Based on receiving frame 2938 from AP 2902, AP 2904 may resume transmission of the first data by transmitting a frame 2928-3 comprising a fourth portion of the first data to AP 2902. Frame 2928-3 may be transmitted a SIFS after an end of frame 2938. In an example, when frame 2928-3 is the final PPDU of the multiple PPDUs transmitted to STA 2908, STA 2908 may transmit a frame 2930 to acknowledge frame 2928-3. In an example, frame 2930 may comprise a BA frame.

As a result, delay of transmission of low latency traffic may be avoided and the preemption for multi-AP procedure using CTDMA can be completed efficiently. Latency can be reduced for multi-AP communication.

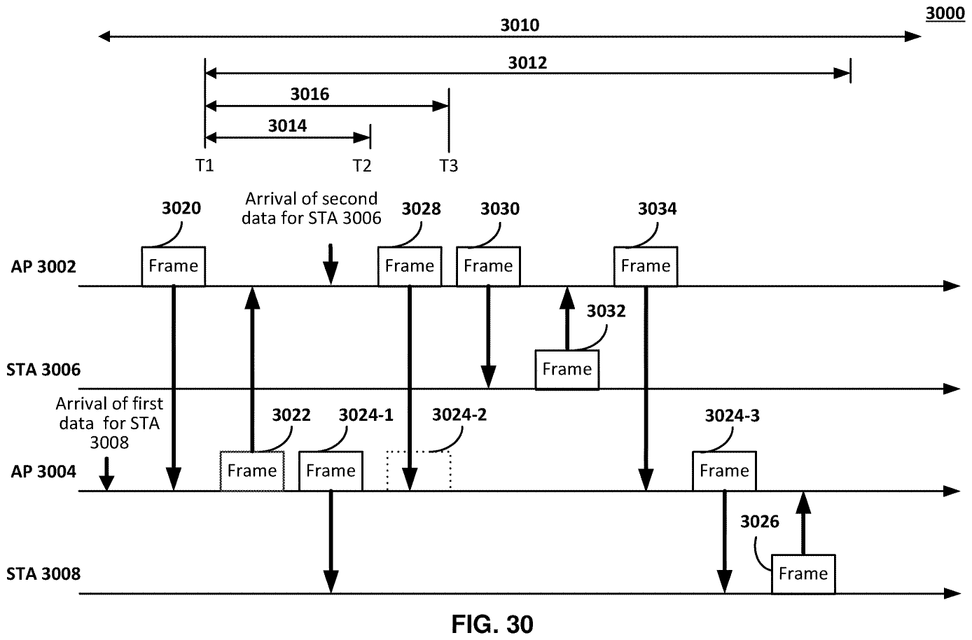

FIG. 30 is an example 3000 that illustrates a preemption coordination procedure according to an embodiment. Example 3000 is provided for the purpose of illustration only and is not limiting. As shown in FIG. 30, example 3000 includes an AP 3002, an AP 3004, a STA 3006, and a STA 3008. In an example, STA 3006 may be associated with AP 3002. In an example, STA 3008 may be associated with AP 3004. AP 3002, AP 3004, STA 3006, and/or STA 3008 may each comprise a multi-link device (MLD).

In an example, APs 3002 and 3004 may belong to the same ESS as described above in FIG. 1. In such a case, APs 3002 and 3004 may be connected by a DS to support ESS features. In an example, APs 3002 and 3004 belong to different BSSs. In an embodiment, AP 3002 may belong to a first BSS and AP 3004 may belong to a second BSS. In an embodiment, the second BSS may comprise an overlapping basic service set (OBSS) relative to the first BSS.

In an embodiment, AP 3002 and 3004 may form a multi-AP group. AP 3002 may be a sharing/master AP of the multi-AP group. AP 3004 may be a shared/slave AP of the multi-AP group. It is assumed in example 3000, APs 3002 and 3004 may complete a multi-AP setup procedure prior to the beginning of example 3000. In addition, as part of a multi-AP group, APs 3002 and 3004 may be connected by a backhaul. In an example, the backhaul may be a wireless backhaul.

Before example 3000 begins, AP 3002 and AP 3004 may complete a multi-AP selection phase such as multi-AP selection phase 1010 described in FIG. 10 above.

It is assumed in example 3000 that AP 3002 supports a preemption coordination capability. In an example, support of the preemption coordination capability allows AP 3002 to transmit a frame (such as frame 3020 described below) to indicate a second period for determining whether preemption is allowed within a first duration allocated by AP 3002 to another AP. AP 3002 may further support a preemption capability which allows AP 3002 to transmit frames (such as frames 3028, 3030, 3034 described below) to preempt frames of the other AP within the first duration.

It is also assumed in example 3000 that AP 3004 supports the preemption coordination capability. In an example, support of the preemption coordination capability allows AP 3004 to receive and process a frame (such as frame 3020) from another AP indicating a second period for determining whether preemption is allowed within a first duration allocated by the other AP to AP 3004 and to determine, based on the received frame, whether to allow preemption within the first duration. In an example, the preemption coordination capability may further allow AP 3004 to transmit frames (such as frames 3024-1 and 3024-3 described below) that comprise an indication of whether preemption of the frames (such as frame 3024-2) is allowed.

In an embodiment, prior to the beginning of example 3000, APs 3002 and 3004 may exchange a first frame and a second frame (not shown in FIG. 30) to exchange capability information. In an embodiment, the first frame may comprise the capability information of AP 3002, including a first indication of support by AP 3002 of the preemption coordination capability and/or the preemption capability. In an embodiment, the second frame may comprise the capability information of AP 3004, including a second indication of support by AP 3004 of the preemption coordination capability. In an embodiment, the first frame and the second frame may be exchanged during a multi-AP setup procedure or a multi-AP selection phase. In an embodiment, the first frame and the second frame may comprise a management frame.

As shown in FIG. 30, example 3000 may begin with the arrival at AP 3004 of first data for transmission to STA 3008. The first data may be non-low latency data. In an implementation, the first data may be transmitted using multiple PPDUs. In an implementation, the PPDUs may be designed to be shorter than a pre-defined size (e.g., 2 milliseconds). The multiple PPDUs may be configured to be transmitted successively on the wireless medium, separated from one another by an interframe space, xIFS.

In an implementation, the PPDUs may be configured to include an indication of whether preemption of the PPDUs is allowed. When preemption is allowed, a preempting PPDU may be transmitted in between the multiple PPDUs. Transmission of the remaining PPDUs may resume after transmission of the preempting PPDU. In example 3000, it is assumed that the multiple PPDUs include a preemption indication set to 1 to indicate that preemption of the PPDUs is allowed.

In an embodiment, AP 3002 may transmit a frame 3020 after obtaining a TXOP 3010.

In an embodiment, frame 3020 may comprise an allocation for AP 3004. An allocation of frame 3020 may comprise an identifier of a shared AP and a duration (within the TXOP) allocated to the shared AP. In an embodiment, the allocation of frame 3020 may comprise an identifier of AP 3004. In example 3000, frame 3020 may comprise an allocation for AP 3004. In an embodiment, the allocation may comprise a period 3012 of TXOP 3010 allocated to AP 3004. In an embodiment, period 3012 may have a first duration starting at a time T1. In an embodiment, the first duration of period 3012 may be indicated in an allocation duration subfield of a user info list field. In example 3000, period 3012 may start at time T1.

In an embodiment, frame 3020 may further comprise a second period 3014 used (e.g., by AP 3004) to determine whether preemption within the first duration of period 3012 is allowed. In an example, second period 3014 may start at a time T1 and end at a time T2. In an embodiment, preemption may be allowed when AP 3004 does not return the first duration to AP 3002 earlier than the end of second period 3014. In an embodiment, second period 3014 may be comprised in a first field of frame 3020. In an embodiment, where the first field indicates second period 3014, the first field may further indicate that AP 3002 is capable/configured to preempt within the first duration of period 3012 by initiating an uplink or downlink transmission for a second data. In an embodiment, the second data may be low latency data that requires urgent transmission. In an embodiment, the second data may be unscheduled. In an embodiment, the first field may further indicate only AP 3002 is allowed to preempt within the first duration.

In an embodiment, frame 3020 may comprise a management frame. In an embodiment, the management frame may comprise a trigger frame. In an example, the trigger frame may comprise an MRTT frame.

On receiving frame 3020, AP 3004 may determine that AP 3002 has shared TXOP 3010 with AP 3004 for the first duration of period 3012. AP 3004 may transmit a frame 3022 to AP 3002, in response to frame 3020. In an example, frame 3022 may comprise a CTS frame.

After transmitting frame 3022, AP 3004 may use the TXOP for the remaining duration of the first duration of period 3012. In an example, AP 3004 may transmit a downlink frame to STA 3008. In another example, AP 3004 may trigger STA 3008 to transmit an uplink frame to AP 3004 (not shown in FIG. 30).

In example 3000, after transmitting frame 3022, AP 3004 may transmit one or more PPDUs comprising the first data to STA 3008.

In an embodiment, AP 3004 may transmit a frame 3024-1 during the first duration of period 3012. In an embodiment, frame 3024-1 may comprise a first portion of the first data. In an implementation, AP 3004 may transmit frame 3024-1 an xIFS after transmitting frame 3022 to AP 3002.

In an embodiment, frame 3024-1 may comprise a second field used (by another AP or STA) to determine whether preemption of a next frame 3024-2 following frame 3024-1 is allowed. In an embodiment, a value of the second field is based on a value of the first field comprised in frame 3020.

In example 3000, while AP 3004 transmits frame 3024-1 to STA 3008, AP 3002 may have second data arrive for transmission to STA 3006. In an example, the second data may be low latency data that requires urgent transmission to STA 3006. In an example, the arrival of the second data may occur before or during the transmission by AP 3004 of frame 3024-1 to STA 3008.

As shown in FIG. 30, AP 3004 may wish to transmit a frame 3024-2 comprising a second portion of the first data. To transmit frames 3024-1 and 3024-2, AP 3004 may not intend to return the first duration of period 3012 to AP 3002 or may intend to return the first duration of period 3012 later than a time T3. In an example, T3 may be the earliest end of a period 3016 comprising a duration to complete the transmission of frames 3024-1 and 3024-2. In an example, the duration of period 3016 may not comprise the duration of frames acknowledging frames 3024-1 and/or 3024-2 and transmitted by STA 3008.

In example 3000, when AP 3004 does not intend to return the first duration of period 3012 to AP 3002 before the end of period 3014, the second field of frame 3024-1 may be set to 1 indicating that preemption of next frame 3024-2 following frame 3024-1 is allowed. In an embodiment, the second field of frame 3024-1 may further indicate that only AP 3002 is allowed to preempt. In another embodiment, the second field of frame 3024-1 may further indicate that preemption is not allowed by a non-AP STA (such as STA 3008). In an example, the second field of frame 3024-1 may be set to 11 indicating that preemption of next frame 3024-2 following frame 3024-1 is allowed by AP 3002 only. This allows AP 3002 to use preemption to transmit arriving data and particularly to transmit low latency data with a low delay.

In an embodiment, based on the arrival of the second data, AP 3002 may preempt a next frame 3024-2 from AP 3004 to STA 3008 to transmit a frame 3028 to AP 3004. In an example, frame 3028 may comprise a preemption request (PR) frame. In an implementation, frame 3028 is transmitted a SIFS after an end of frame 3024-1 to preempt the next frame 3024-2 from AP 3004 to STA 3008.

Subsequently, AP 3002 may transmit to STA 3006 a frame 3030 comprising the second data a SIFS after an end of frame 3028. In an example, frame 3030 may comprise a data frame. In an example, STA 3006 may acknowledge frame 3030 by transmitting a frame 3032. In an example, frame 3032 may comprise a BA frame.

In another example (not shown in FIG. 30), the second data may arrive at STA 3006. In an example, AP 3002 may solicit an uplink transmission comprising the second data from STA 3006 to AP 3002. For example, after sending frame 3028, AP 3002 may transmit a trigger frame to STA 3006 to trigger the uplink transmission from STA 3006 to AP 3002.

In example 3000, AP 3004 may or may not overhear frame 3032 from STA 3006. In an example, AP 3002 may transmit to AP 3004 a frame 3034 to inform AP 3004 of the release of preemption. In an example, frame 3034 may comprise a preemption release (PRel) frame. In an example, frame 3034 may indicate that preemption by AP 3002 is complete.

Based on receiving frame 3034 from AP 3002, AP 3004 may resume transmission of the first data by transmitting a frame 3024-3 comprising a second portion of the first data to AP 3002. Frame 3024-3 may be transmitted a SIFS after an end of frame 3034. In an example, when frame 3024-3 is the final PPDU of the multiple PPDUs transmitted to STA 3008, STA 3008 may transmit a frame 3026 to acknowledge frame 3024-3. In an example, frame 3026 may comprise a BA frame.

As a result, delay of transmission of low latency traffic may be avoided and the preemption for multi-AP procedure using CTDMA can be completed efficiently. Latency can be reduced for multi-AP communication.

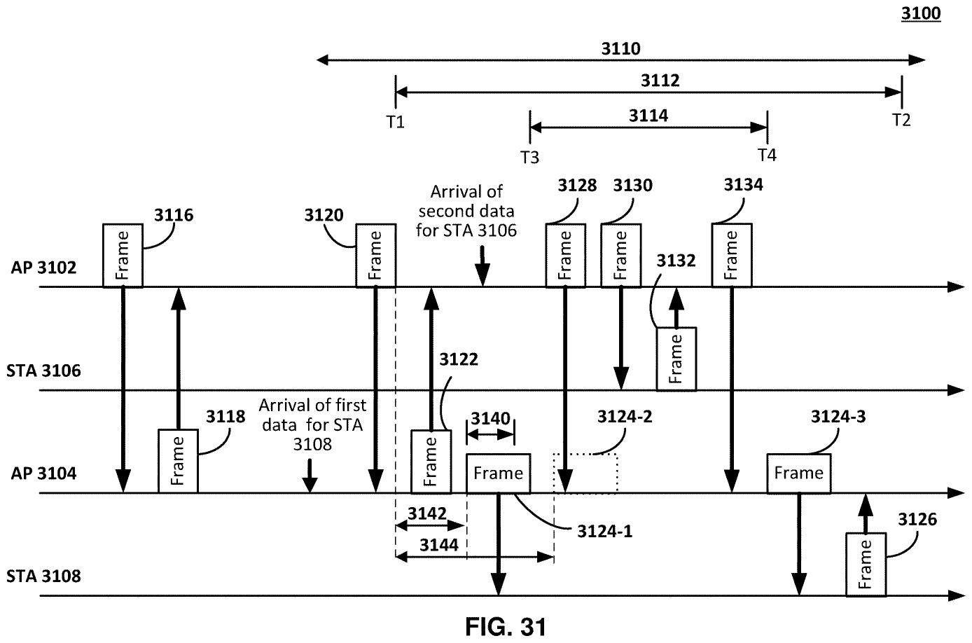

FIG. 31 is an example 3100 that illustrates a preemption coordination procedure according to an embodiment. Example 3100 is provided for the purpose of illustration only and is not limiting. As shown in FIG. 31, example 3100 includes an AP 3102, an AP 3104, a STA 3106, and a STA 3108. In an example, STA 3106 may be associated with AP 3102. In an example, STA 3108 may be associated with AP 3104. AP 3102, AP 3104, STA 3106, and/or STA 3108 may each comprise a multi-link device (MLD).

In an example, APs 3102 and 3104 may belong to the same ESS as described above in FIG. 1. In such a case, APs 3102 and 3104 may be connected by a DS to support ESS features. In an example, APs 3102 and 3104 belong to different BSSs. In an embodiment, AP 3102 may belong to a first BSS and AP 3104 may belong to a second BSS. In an embodiment, the second BSS may comprise an overlapping basic service set (OBSS) relative to the first BSS.

In an embodiment, AP 3102 and 3104 may form a multi-AP group. AP 3102 may be a sharing/master AP of the multi-AP group. AP 3104 may be a shared/slave AP of the multi-AP group. It is assumed in example 3100, APs 3102 and 3104 may complete a multi-AP setup procedure prior to the beginning of example 3100. In addition, as part of a multi-AP group, APs 3102 and 3104 may be connected by a backhaul. In an example, the backhaul may be a wireless backhaul.

Before example 3100 begins, AP 3102 and AP 3104 may complete a multi-AP selection phase such as multi-AP selection phase 1010 described in FIG. 10 above.

It is assumed in example 3100 that AP 3102 supports a preemption coordination capability. In an example, support of the preemption coordination capability allows AP 3102 to transmit a frame (such as frame 3116 described below) requesting that another AP allow preemption and to receive and process frames (such as frames 3118 described below) in response to the request. AP 3102 may further support a preemption coordination capability which allows AP 3102 to transmit frames (such as frame 3120 described below) to determine an allocation for another AP within a first duration. AP 3102 may further support a preemption capability which allows AP 3102 to transmit frames (such as frames 3128, 3130, 3134 described below) to preempt frames of the other AP within the first duration.

It is also assumed in example 3100 that AP 3104 supports the preemption coordination capability. In an example, support of the preemption coordination capability allows AP 3104 to receive and process a frame (such as frame 3116) from another AP requesting that AP 3104 allow preemption and to determine whether to allow preemption and to transmit a frame (such as frame 3118) to the other AP in response to the request. In an example, the preemption coordination capability may further allow AP 3104 to transmit frames (such as frames 3124-1 and 3124-3 described below) that comprise an indication of whether preemption of the frames (such as frame 3124-2) is allowed.

In an embodiment, prior to the beginning of example 3100, APs 3102 and 3104 may exchange a first frame and a second frame (not shown in FIG. 31) to exchange capability information. In an embodiment, the first frame may comprise the capability information of AP 3102, including a first indication of support by AP 3102 of the preemption coordination capability and/or the preemption capability. In an embodiment, the second frame may comprise the capability information of AP 3104, including a second indication of support by AP 3104 of the preemption coordination capability. In an embodiment, the first frame and the second frame may be exchanged during a multi-AP setup procedure or a multi-AP selection phase. In an embodiment, the first frame and the second frame may comprise a management frame.

As shown in FIG. 31, example 3100 may begin with AP 3102 transmitting a frame 3116 requesting that AP 3104 allow preemption. In an embodiment, frame 3116 may further request that AP 3104 allow preemption by AP 3102 only. In an embodiment, AP 3104 may determine whether preemption is to be allowed and may transmit to AP 3102 a frame 3118 in response to frame 3116. In an embodiment, frame 3118 may comprise a decision of AP 3104. In an embodiment, frame 3118 may accept the request. In another embodiment, frame 3118 may reject the request.

In an embodiment, frame 3116 or 3118 may comprise a management frame. In an embodiment, the management frame may comprise an action frame. In an example, the action frame may comprise a request/response frame.

Subsequently, first data may arrive at AP 3104 for transmission to STA 3108. The first data may be non-low latency data. In an implementation, the first data may be transmitted using multiple PPDUs. In an implementation, the PPDUs may be designed to be shorter than a pre-defined size (e.g., 2 milliseconds). The multiple PPDUs may be configured to be transmitted successively on the wireless medium, separated from one another by an interframe space, xIFS.

In an implementation, the PPDUs may be configured to include an indication of whether preemption of the PPDUs is allowed. When preemption is allowed, a preempting PPDU may be transmitted in between the multiple PPDUs. Transmission of the remaining PPDUs may resume after transmission of the preempting PPDU. In example 3100, it is assumed that the multiple PPDUs include a preemption indication set to 1 to indicate that preemption of the PPDUs is allowed.

In an embodiment, AP 3102 may transmit a frame 3120 after obtaining a TXOP 3110.

In an embodiment, frame 3120 may comprise an allocation for AP 3104. An allocation of frame 3120 may comprise an identifier of a shared AP and a duration (within the TXOP) allocated to the shared AP. In an embodiment, the allocation of frame 3120 may comprise an identifier of AP 3104. In example 3100, frame 3120 may comprise an allocation for AP 3104. In an embodiment, the allocation may comprise a period 3112 of TXOP 3110 allocated to AP 3104. In an embodiment, period 3112 may have a first duration starting at a time T1. In an embodiment, the first duration of period 3112 may be indicated in an allocation duration subfield of a user info list field. In example 3100, period 3112 may start at time T1.

In an embodiment, the AP 3102 may determine the first duration of period 3112 based on frame 3118. In example 3100, based on the decision indicated in frame 3118 indicating acceptance of the request for the allowance of preemption, AP 3102 may set the first duration to be larger than a first value (e.g., 2 milliseconds). As shown in FIG. 31, the first duration of period 3112 is allocated until T2, which may be sufficiently long for AP 3104 to participate in CTDMA with preemption. In another example, based on the decision indicated in frame 3118 indicating rejection of the request for the allowance of preemption, AP 3102 may set the first duration to be shorter than the first value (not shown in FIG. 31).

In an embodiment, frame 3120 may comprise a management frame. In an embodiment, the management frame may comprise a trigger frame. In an example, the trigger frame may comprise an MRTT frame.

On receiving frame 3120, AP 3104 may determine that AP 3102 has shared TXOP 3110 with AP 3104 for the first duration of period 3112. AP 3104 may transmit a frame 3122 to AP 3102, in response to frame 3120. In an example, frame 3122 may comprise a CTS frame.

After transmitting frame 3122, AP 3104 may use the TXOP for the remaining duration of the first duration of period 3112. In an example, AP 3104 may transmit a downlink frame to STA 3108. In another example, AP 3104 may trigger STA 3108 to transmit an uplink frame to AP 3104 (not shown in FIG. 31).

In example 3100, after transmitting frame 3122, AP 3104 may transmit one or more PPDUs comprising the first data to STA 3108.

In an embodiment, AP 3104 may transmit a frame 3124-1 during the first duration of period 3112. In an embodiment, frame 3124-1 may comprise a first portion of the first data. In an implementation, AP 3104 may transmit frame 3124-1 an xIFS after transmitting frame 3122 to AP 3102.

In an embodiment, frame 3124-1 may comprise a second field used (by another AP or STA) to determine whether preemption of frame 3124-1 is allowed. In an embodiment, a value of the second field is based on frame 3120.

In example 3100, while AP 3104 transmits frame 3124-1 to STA 3108, AP 3102 may have second data arrive for transmission to STA 2406. In an example, the second data may be low latency data that requires urgent transmission to STA 2406. In an example, the arrival of the second data may occur before or during the transmission by AP 3104 of frame 3124-1 to STA 3108.

In example 3100, based on the decision indicated in frame 3118, the second field of frame 3124-1 may be set to 1 indicating that preemption of a next frame 3124-2 following frame 3124-1 is allowed. In an embodiment, the second field of frame 3124-1 may further indicate that preemption is allowed by AP 3102 only. In another embodiment, the second field of frame 3124-1 may further indicate that preemption is not allowed by a non-AP STA (such as STA 3108). In an example, the second field of frame 3124-1 may be set to 11 indicating that preemption of next frame 3124-2 following frame 3124-1 is allowed by AP 2802 only. This allows AP 3102 to use preemption to transmit arriving data and particularly to transmit low latency data with a low delay.

In an embodiment, based on the arrival of the second data, AP 3102 may preempt a next frame 3124-2 from AP 3104 to STA 3108 to transmit a frame 3128 to AP 3104. In an example, frame 3128 may comprise a preemption request (PR) frame. In an implementation, frame 3128 is transmitted a SIFS after an end of frame 3124-1 to preempt the next frame 3124-2 from AP 3104 to STA 3108.

Subsequently, AP 3102 may transmit to STA 3106 a frame 3130 comprising the second data a SIFS after an end of frame 3128. In an example, frame 3130 may comprise a data frame. In an example, STA 3106 may acknowledge frame 3130 by transmitting a frame 3132. In an example, frame 3132 may comprise a BA frame.

In another example (not shown in FIG. 31), the second data may arrive at STA 3106. In an example, AP 3102 may solicit an uplink transmission comprising the second data from STA 3106 to AP 3102. For example, after sending frame 3128, AP 3102 may transmit a trigger frame to STA 3106 to trigger the uplink transmission from STA 3106 to AP 3102.

In example 3100, AP 3104 may or may not overhear frame 3132 from STA 3106. In an example, AP 3102 may transmit to AP 3104 a frame 3134 to inform AP 3104 of the release of preemption. In an example, frame 3134 may comprise a preemption release (PRel) frame. In an example, frame 3134 may indicate that preemption by AP 3102 is complete.

Based on receiving frame 3134 from AP 3102, AP 3104 may resume transmission of the first data by transmitting a frame 3124-3 comprising a second portion of the first data to AP 3102. Frame 3124-3 may be transmitted a SIFS after an end of frame 3134. In an example, when frame 3124-3 is the final PPDU of the multiple PPDUs transmitted to STA 3108, STA 3108 may transmit a frame 3126 to acknowledge frame 3124-3. In an example, frame 3126 may comprise a BA frame.

As a result, delay of transmission of low latency traffic may be avoided and the preemption for multi-AP procedure using CTDMA can be completed efficiently. Latency can be reduced for multi-AP communication.

As would be understood by a person of skill in the art based on the teachings herein, embodiments of the present disclosure are not limited by the above-described examples. Further example embodiments are described below.

In an embodiment, frame 3116 may request that AP 3104 allow preemption when AP 3104 intends to transmit using frames that are larger than a threshold 3140. In an embodiment, threshold 3140 may be similar to threshold 2814 described in FIG. 28. In an example, threshold 3140 may be indicated in frame 3116. In another example, threshold 3140 may be indicated during a multi-AP setup or a multi-AP selection phase 1010 described in FIG. 10. In an embodiment, AP 3104 may determine whether preemption is allowed and transmit to AP 3102 a frame 3118 in response to frame 3116. In an embodiment, frame 3118 may comprise a decision of AP 3104. In an embodiment, frame 3118 may accept or reject the request.

In an embodiment, AP 3102 may determine the first duration of period 3112 based on frame 3118. In example 3100, the decision indicated in frame 3118 indicates acceptance of the request for the allowance of preemption when AP 3104 intends to transmit using frames larger than threshold 3140. As such, AP 3102 may set the first duration to be greater than a first value (e.g., 2 milliseconds). As shown in FIG. 31, the first duration of period 3112 is allocated until T2, which may be sufficiently long for AP 3104 to participate in CTDMA with preemption. In another example, the decision indicated in frame 3118 indicates rejection of the request for the allowance of preemption when AP 3104 intends to transmit using frames shorter than threshold 3140. As such, AP 3102 may set the first duration to be shorter than the first value. In an implementation, AP 3102 may set the first duration to correspond to threshold 3140.

In another embodiment, frame 3116 may request that AP 3104 allow preemption when AP 3104 intends to transmit using frames after the end of a first period 3142. In an embodiment, first period 3142 may be similar to first period 2914 described in FIG. 29. In an example, first period 3142 may be indicated in frame 3116. In another example, first period 3142 may be indicated during a multi-AP setup or a multi-AP selection phase 1010 described in FIG. 10. In an embodiment, AP 3104 may determine whether preemption is allowed and transmit to AP 3102 a frame 3118 in response to frame 3116. In an embodiment, frame 3118 may comprise a decision of AP 3104. In an embodiment, frame 3118 may accept or reject the request.

In an embodiment, AP 3102 may determine the first duration of period 3112 based on frame 3118. In example 3100, the decision indicated in frame 3118 indicate acceptance of the request for the allowance of preemption when AP 1304 intents to transmit using frames after the end of first period 3142, As such, AP 3102 may set the first duration to be greater than a first value (e.g., 2 milliseconds). As shown in FIG. 31, the first duration of period 3112 is allocated until T2, which may be sufficiently long for AP 3104 to participate in CTDMA with preemption. In another example, the decision indicated in frame 3118 indicate rejection of the request for the allowance of preemption when AP 3104 intents to transmit using frames before the end of a first period 3142, AP 3102 may set the first duration relative short (not shown in FIG. 31). In an implementation, AP 3102 may set the first duration to correspond to first period 3142.

In a further embodiment, frame 3116 may request that AP 3104 allow preemption when AP 3104 does not return an allocated duration (e.g., the first duration of period 3112) to AP 3102 earlier than a second period 3144. In an embodiment, second period 3144 may be similar to second period 3014 described in FIG. 30. In an example, second period 3144 may be indicated in frame 3116. In another example, second period 3144 may be indicated during a multi-AP setup or a multi-AP selection phase 1010 described in FIG. 10. In an embodiment, AP 3104 may determine whether preemption is allowed and transmit to AP 3102 a frame 3118 in response to frame 3116. In an embodiment, frame 3118 may comprise a decision of AP 3104. In an embodiment, frame 3118 may accept or reject the request.

In an embodiment, AP 3102 may determine the first duration of period 3112 based on frame 3118. In example 3100, the decision indicated in frame 3118 indicates acceptance of the request for the allowance of preemption when AP 3104 does not return the first duration of period 3112 to AP 3102 earlier than a second period 3144, AP 3102 may set the first duration to be longer than a first value (e.g., 2 milliseconds). As shown in FIG. 31, the first duration of period 3112 is allocated until T2, which may be sufficiently long for AP 3104 to participate in CTDMA with preemption. In another example, the decision indicated in frame 3118 indicate rejection of the request for the allowance of preemption, AP 3102 may set the first duration to be shorter than the first value. In an implementation, AP 3102 may set the first duration corresponding to second period 3144.

In an additional embodiment, frame 3116 may request that AP 3104 allow preemption within a third period, where the third period comprises a third starting time and a third duration ending. In an example, third period 3114 may be indicated in frame 3116. In another example, third period 3114 may be indicated during a multi-AP setup or a multi-AP selection phase 1010 described in FIG. 10. In an embodiment, AP 3104 may determine whether preemption is allowed and transmit to AP 3102 a frame 3118 in response to frame 3116. In an embodiment, frame 3118 may comprise a decision of AP 3104.

In an example, the third period may be same as period 3112 described in FIG. 31. In an embodiment, frame 3118 may accept the request. In an embodiment, AP 3102 may determine the first duration of period 3112 based on frame 3118. In example 3100, based on the decision indicated in frame 3118 indicating acceptance of the request for the allowance of preemption within the third period, AP 3102 may set the first duration to be the same as the duration of the third period. As shown in FIG. 31, the first duration of period 3112 is allocated between T1 and T2, which may be sufficiently long for AP 3104 to participate in CTDMA with preemption.

In another example, the third period may be same as period 3114. As shown in FIG. 31, period 3114 may start at a time T3 and end by a time T4. In an embodiment, frame 3118 may reject the request. In an embodiment, frame 3118 may further comprise a fourth period during which AP 3104 accepts to allow preemption, where the fourth period comprises a fourth starting time and a fourth duration. In an example, the fourth period may be same as period 3112 described in FIG. 31. In an embodiment, AP 3102 may determine the first duration of period 3112 based on frame 3118. In example, based on frame 3118 indicating rejection of the request for the allowance of preemption within the third period and indicating the fourth period, AP 3102 may set the first duration equal the fourth period.

In an embodiment, frame 3116 may solicit from AP 3104 a fifth period during which AP 3104 accepts to allow preemption. In an example, the fifth period may comprise a third starting time and a third duration. In an example, the fifth period may be same as period 3112 described in FIG. 31. In an embodiment, frame 3118 may accept the request and comprise the fifth period. In an embodiment, AP 3102 may determine the first duration of period 3112 based on frame 3118. In example 3100, based on the decision indicated in frame 3118 indicating acceptance of the request for the allowance of preemption within the third period, AP 3102 may set the first duration equal to the fifth period. As shown in FIG. 31, the first duration of period 3112 is allocated between T1 and T2, which may be sufficiently long for AP 3104 to participate in CTDMA with preemption. In an embodiment, frame 3116 may comprise a control frame. In an embodiment, the control frame may comprise a trigger frame. In an embodiment, frame 3118 may comprise a management frame. In an embodiment, the management frame may comprise an action frame.

In an embodiment, frame 2720 described in FIG. 27, frames 2820 described in FIG. 28, frames 2920 described in FIG. 29, and frame 3020 described in FIG. 30, may be control frames, such as trigger frames.

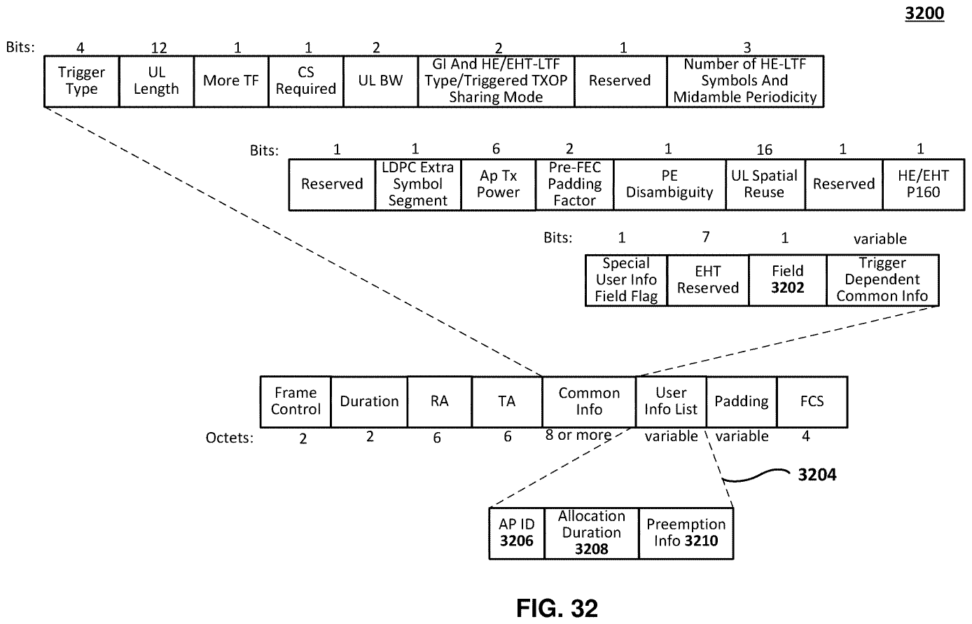

FIG. 32 illustrates an example trigger frame 3200 which may be used according to embodiments. For example, trigger frame 3200 may be an embodiment of frames 2720, 2820, 2920, and 3020.

In an embodiment, trigger frame 3200 may comprise an MU-RTS TXS trigger (MRTT) frame. In an embodiment, trigger frame 3200 may comprise a TXS preemption coordination trigger frame.

As shown in FIG. 32, trigger frame 3200 may include a frame control field, a duration field, a RA field, a TA field, a common info field, a user info list field, a padding field, and an FCS field.

In an embodiment, trigger frame 3200 may include information supporting preemption coordination.

In an embodiment, the information supporting preemption coordination may comprise an allocation by a first AP transmitting frame 3200. In an example, the allocation may comprise a portion of a TXOP obtained by the first AP. In an example, the allocation may comprise a first period. In an embodiment, the first period may have a first duration starting a first starting time.

The first AP may be an embodiment of AP 2702 described in FIG. 27, AP 2802 described in FIG. 28, AP 2902 described in FIG. 29, or AP 3002 described in FIG. 30.

In an embodiment, the information supporting preemption coordination may comprise an identifier of a second AP. In an embodiment, the first AP may allocate the first period to the second AP.

The second AP may be an embodiment of AP 2704 described in FIG. 27, AP 2804 described in FIG. 28, AP 2904 described in FIG. 29, or AP 3004 described in FIG. 30.

In an embodiment, the information supporting preemption coordination may comprise a first field used to determine whether preemption within a first duration is allowed. In an embodiment, the first field may comprise a preemption information field 3204.

In an embodiment, the first duration of the first period may be indicated in an allocation duration subfield of a user info list field.

As shown in FIG. 32, trigger frame 3200 may include a common info field and a user info list field.

In an embodiment, the common info field may include a field 3202 indicating the presence of a field 3204 in the user info list field. In an example, field 3202 may comprise a preemption coordination field. In an embodiment, the common info field may include the information supporting preemption coordination. The format of subfields carrying the information in common info field may be similar to field 3204 in the user info list field.

In an embodiment, field 3204 may include an AP ID subfield 3206 for an identifier of the second AP, an allocation duration subfield 3208 for the first duration, and a first/preemption information subfield 3210 for the preemption information.

In an embodiment, AP ID subfield 3206 may indicate the identifier of the second AP.

In an embodiment, allocation duration subfield 3208 may indicate the first duration allocated to the second AP indicated in subfield 3206.

In an embodiment, preemption information subfield 3210 may be used to determine whether preemption within the first duration indicated in subfield 3208 is allowed. In an embodiment, preemption information subfield 3210 may indicate that only the first is allowed to preempt within the first duration.

In an embodiment, preemption information subfield 3210 may indicate a preference/recommendation of the first AP regarding preemption within the first duration indicated in subfield 3208. In an example, frame 3200 may be an embodiment of frame 2720 described in FIG. 27.

In an embodiment, preemption information subfield 3210 may indicate a threshold for determining whether preemption is allowed within the first duration indicated in subfield 3208. In an example, preemption may be allowed when a length of the second frame is larger than the threshold. In an example, frame 3200 may be an embodiment of frame 2820 described in FIG. 28.

In an embodiment, preemption information subfield 3210 may indicate a second period for determining whether preemption is allowed within the first duration indicated in subfield 3208. In an example, preemption of a next frame following a second frame may be allowed when the second frame is transmitted by the second AP after the end of the second period. In an example, frame 3200 may be an embodiment of frame 2920 described in FIG. 29. In another example, preemption of a next frame following a second frame may be allowed when the second AP does not return the first duration indicated in subfield 3208 to the first AP earlier than the end of the second period. In an example, frame 3200 may be an embodiment of frame 3020 described in FIG. 30.

In an embodiment, frames 3116 and 3118 described in FIG. 31 may comprise a management frame. In an example, the management frame may comprise an action frame.

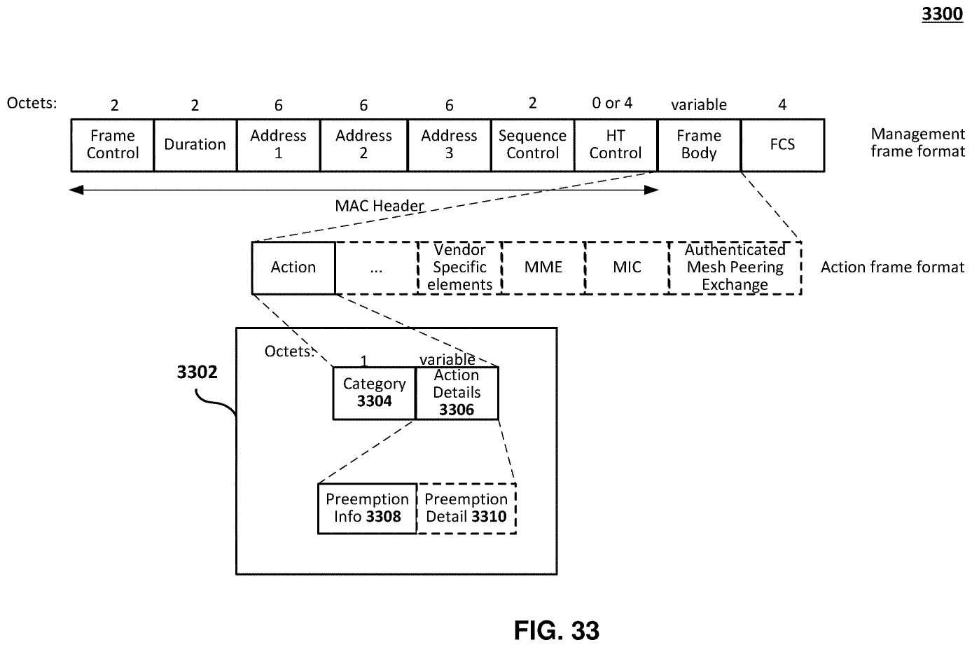

FIG. 33 illustrates an example action frame 3300 which may be used according to embodiments. For example, action frame 3300 may be an embodiment of frames 3116 and 3118. In an example, action frame 3300 may comprise a public action frame.

In an embodiment, frame 3300 may be used by a first AP to request that a second AP allow preemption. In an embodiment, frame 3300 may comprise a request frame. In an example, frame 3300 may comprise a preemption coordination request frame. In an embodiment, frame 3300 may be an unsolicited frame, such as frame 3116 described in FIG. 31.

In an embodiment, frame 3300 may be used by a first AP to respond to a request frame from a second AP requesting that the first AP allow preemption. In an embodiment, frame 3300 may comprise a response frame. In an example, frame 3300 may comprise a preemption coordination response frame. In an embodiment, frame 3300 may be an unsolicited frame, such as frame 3118 described in FIG. 31.

For example, the first AP may be an embodiment of AP 3102 described in FIG. 31. The second AP may be an embodiment of AP 3104 described in FIG. 31.

As shown in FIG. 33, action frame 3300 may include a frame control field, a duration field, one or more address fields, a sequence control field, an HT control field, a frame body, and an FCS field.

As shown in FIG. 33, the frame body of action frame 3300 may include an action field 3302. In an embodiment, action field 3302 may comprise information supporting preemption coordination. In an embodiment, the information supporting preemption coordination may include a request by a first AP that a second AP allow preemption. In an embodiment, action field 3306 may indicate a response to or a request from the second AP. In an embodiment, action field 3306 may be a preemption coordination action field.

In an embodiment, action field 3306 may include a category subfield 3304 that indicates that action frame 3300 is for preemption coordination.

In an embodiment, action field 3302 may include an action details field 3306.

In an embodiment, action detail field 3306 may comprise a preemption information subfield 3308, and an optional preemption detail subfield 3310.

In an embodiment, preemption information subfield 3308 may be used to request that preemption be allowed. In an embodiment, preemption information subfield 3308 may request that preemption within the first duration be allowed by the first AP only.

In an embodiment, preemption information subfield 3308 may indicate a threshold. In example, subfield 3308 may comprise a duration, e.g., in seconds, or a length, e.g., in octets. In an embodiment, frame 3300 may request that the second AP allow preemption when a third frame transmitted by the second AP is larger than the threshold indicated in subfield 3308.

In an embodiment, preemption information subfield 3308 may indicate a first period. In an embodiment, the second period may comprise a first starting time and a first duration.

In an embodiment, optional preemption detail subfield 3310 may indicate a second period. In an embodiment, the second period may comprise a second starting time and a second duration. In an embodiment, frame 3300 may respond to a request frame requesting that the second AP allow preemption within the first period indicated in subfield 3308. In an embodiment, frame 3300 may respond to a request frame soliciting that the second AP allow preemption within the second period.

As would be understood by a person of skill in the art based on the teachings herein, the embodiments as described by the above examples may be readily extended to cases including more than two STAs.

As would be understood by a person of skill in the art based on the teachings herein, the embodiments as described by the above examples may be readily extended to cases including more than two APs.

As would be understood by a person of skill in the art based on the teachings herein, the embodiments as described by the above examples may be readily extended to scenarios in which any of the APs or any of the STAs may comprise an MLD, comprising at least one affiliated AP or affiliated STA.

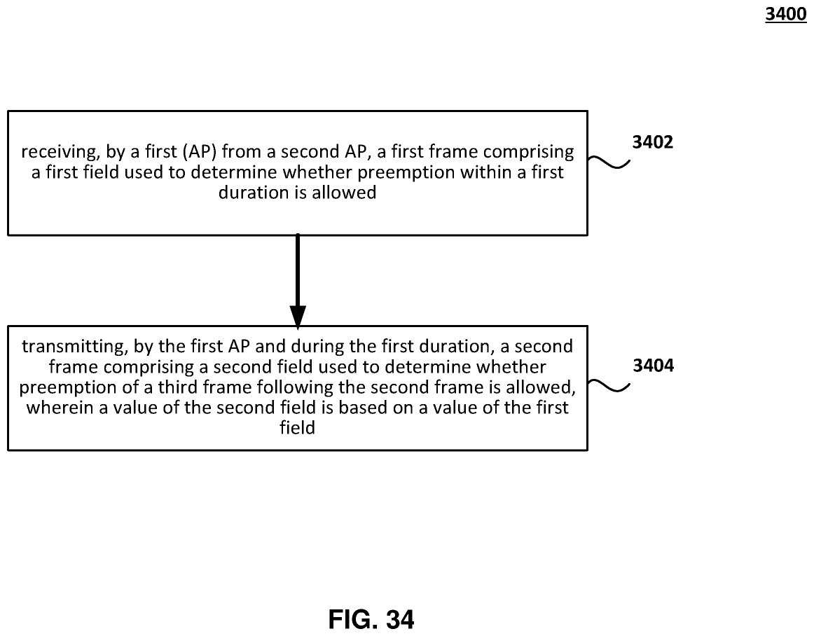

FIG. 34 illustrates an example process 3400 according to an embodiment. Example process 3400 is provided for the purpose of illustration only and is not limiting of embodiments. Process 3400 may be performed by a first AP.

As shown in FIG. 34, process 3400 begins in step 3402, which includes receiving, by the first AP from a second AP, a first frame comprising a first field used to determine whether preemption within a first duration is allowed.

In an embodiment, step 3402 further comprises receiving, by the first AP from the second AP, the first frame during a transmit opportunity (TXOP) obtained by the second AP. The first frame may further comprise an allocation duration field indicating the first duration. The first duration may be allocated to the first AP and may be within the TXOP.

In an embodiment, step 3402 further comprises transmitting, by the first AP and during the first duration, a fourth frame in response to the first frame.

In step 3404, process 3400 includes transmitting, by the first AP and during the first duration, a second frame comprising a second field used to determine whether preemption of a third frame following the second frame is allowed. In an embodiment, a value of the second field is based on a value of the first field.

In an embodiment, the first frame further indicates an identifier of the first AP.

In an embodiment, the first field indicates a preference/recommendation of the second AP regarding preemption within the first duration.

In an embodiment, the first frame indicates a threshold for determining whether preemption is allowed within the first duration.

In an embodiment, preemption of the third frame following the second frame is allowed when a length of the second frame is larger than the threshold.

In an embodiment, the first frame indicates a first period.

In an embodiment, preemption of the third frame following the second frame is allowed when the second frame is transmitted after the end of first period.

In an embodiment, the first frame indicates a second period.

In an embodiment, preemption of the third frame following the second frame is allowed when the first AP does not return the first duration to the second AP earlier than the end of second period.

In an embodiment, the first field further indicates that the second AP is capable/configured to preempt within the first duration by initiating an uplink or downlink transmission for a second data.

In an embodiment, the first field is for allowance of preemption within the first duration, and the first field further indicates that only the second AP is allowed to preempt within the first duration.

In an embodiment, the first frame comprises a trigger frame.

In an embodiment, the value of the second field indicates allowance of preemption of the third frame following the second frame within the first duration.

In an embodiment, the second field further indicates that preemption is allowed by the second AP only.

In an embodiment, the value of the second field indicates disallowance of preemption of the third frame following the second frame within the first duration.

In an embodiment, the second field further indicates that preemption is disallowed by a non-AP STA.

In an embodiment, the second frame comprises a data frame.

In an embodiment, process 3400 further comprises receiving, by the first AP from the second AP, a first indication of support by the second AP of a preemption coordination capability.

In an embodiment, process 3400 further comprises transmitting, by the first AP to the second AP, a second indication of support by the first AP of a preemption capability.

In an embodiment, the first AP and the second AP form a multi-AP group.

In an embodiment, the first AP belongs to a basic service set (BSS) and the second AP belongs to an overlapping basic service set (OBSS) relative to the BSS.

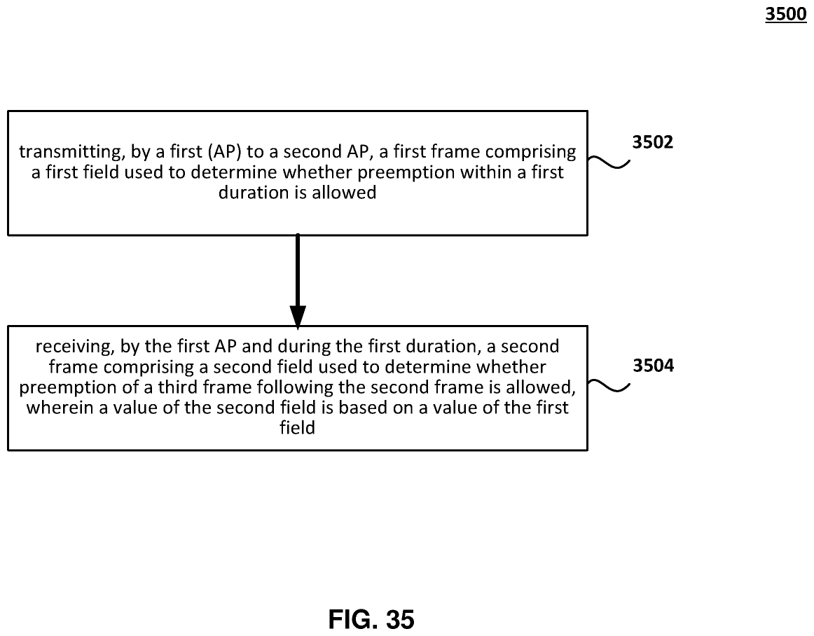

FIG. 35 illustrates an example process 3500 according to an embodiment. Example process 3500 is provided for the purpose of illustration only and is not limiting of embodiments. Process 3500 may be performed by a first AP.

As shown in FIG. 35, process 3500 begins in step 3502, which includes transmitting, by the first AP to a second AP, a first frame comprising a first field used to determine whether preemption within a first duration is allowed.

In an embodiment, step 3502 further comprises transmitting, by the first AP to the second AP, the first frame during a transmit opportunity (TXOP) obtained by the first AP. The first frame may further comprise an allocation duration field indicating the first duration. The first duration may be allocated to the second AP and may be within the TXOP.

In an embodiment, step 3502 further comprises receiving, by the first AP from the second AP and during the first duration, a fourth frame in response to the first frame.

In step 3504, process 3500 includes receiving, by the first AP from the second AP and during the first duration, a second frame comprising a second field used to determine whether preemption of a third frame following the second frame is allowed. In an embodiment, a value of the second field is based on a value of the first field.

In an embodiment, the first frame further indicates an identifier of the second AP.

In an embodiment, the first field indicates a preference/recommendation of the first AP regarding preemption within the first duration.

In an embodiment, the first frame indicates a threshold for determining whether preemption is allowed within the first duration.

In an embodiment, preemption of the third frame following the second frame is allowed (by the second AP) when a length of the second frame is larger than the threshold.

In an embodiment, the first frame indicates a first period.

In an embodiment, preemption of the third frame following the second frame is allowed (by the second AP) when the second frame is transmitted after the end of first period.

In an embodiment, the first frame indicates a second period.

In an embodiment, preemption of the third frame following the second frame is allowed (by the second AP) when the second AP does not return the first duration to the first AP earlier than the end of second period.

In an embodiment, the first field further indicates that the first AP is capable/configured to preempt within the first duration by initiating an uplink or downlink transmission for a second data.

In an embodiment, the first field is for allowance of preemption within the first duration, and the first field further indicates that only the first AP is allowed to preempt within the first duration.

In an embodiment, the first frame comprises a trigger frame.

In an embodiment, the value of the second field indicates allowance of preemption of the third frame following the second frame within the first duration.

In an embodiment, the second field further indicates that preemption is allowed by the first AP only.

In an embodiment, the value of the second field indicates disallowance of preemption of the third frame following the second frame within the first duration.

In an embodiment, the second field further indicates that preemption is disallowed by a non-AP STA.

In an embodiment, the second frame comprises a data frame.

In an embodiment, process 3500 further comprises transmitting, by the first AP to the second AP, a first indication of support by the first AP of a preemption coordination capability.

In an embodiment, process 3500 further comprises receiving, by the first AP from the second AP, a second indication of support by the second AP of a preemption capability.

In an embodiment, the first AP and the second AP form a multi-AP group.

In an embodiment, the first AP belongs to a basic service set (BSS) and the second AP belongs to an overlapping basic service set (OBSS) relative to the BSS.

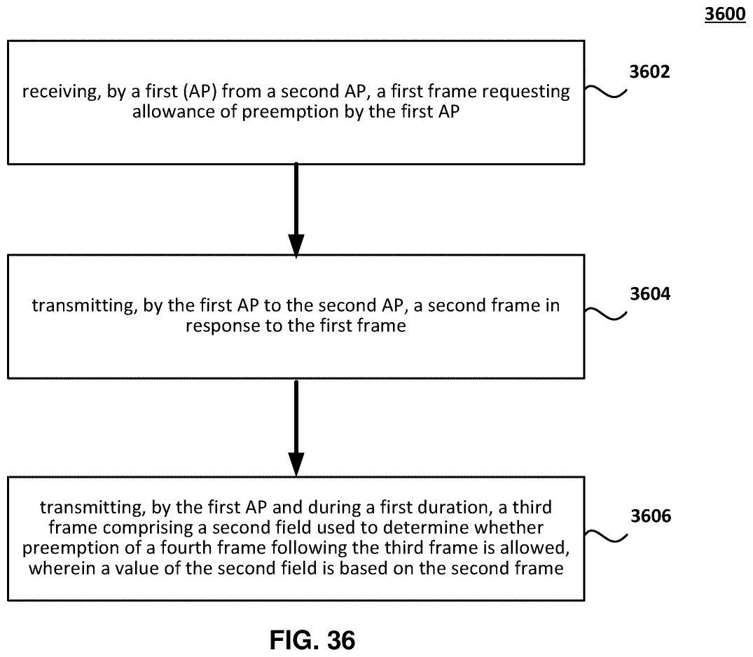

FIG. 36 illustrates an example process 3600 according to an embodiment. Example process 3600 is provided for the purpose of illustration only and is not limiting of embodiments. Process 3600 may be performed by a first AP.

As shown in FIG. 36, process 3600 begins in step 3602, which includes receiving, by the first AP from a second AP, a first frame requesting allowance of preemption by the first AP.

In step 3604, process 3600 includes transmitting, by the first AP to the second AP, a second frame in response to the first frame.

In step 3606, process 3600 includes transmitting, by the first AP and during a first duration, a third frame comprising a second field used to determine whether preemption of a fourth frame following the third frame is allowed. In an embodiment, a value of the second field is based on the second frame.

In an embodiment, process 3600 further comprises receiving, by the first AP from the second AP, a fifth frame during a transmit opportunity (TXOP) obtained by the second AP. The fifth frame may comprise an allocation duration field indicating the first duration. The first duration may be allocated to the first AP and may be within the TXOP.

In an embodiment, the first duration is determined by the second AP based on the second frame.

In an embodiment, process 3600 further comprises transmitting, by the first AP and during the first duration, a sixth frame in response to the fifth frame.

In an embodiment, the first frame further requests that the first AP allows preemption by the second AP only.

In an embodiment, the first frame requests that the first AP allow preemption when the third frame is larger than a threshold.

In an embodiment, the first frame requests that the first AP allow preemption when the third frame is transmitted after the end of a first period.

In an embodiment, the first frame requests that the first AP allow preemption when the first AP does not return the first duration to the second AP earlier than the end of a second period.

In an embodiment, the first frame requests that the first AP allow preemption within a third period, wherein the third period comprises a third starting time and a third duration.

In an embodiment, the second frame accepts the request in response to the first frame.

In an embodiment, the second frame rejects the request in response to the first frame.

In an embodiment, the second frame further comprises a fourth period during which the first AP accepts to allow preemption, wherein the fourth period, comprising a fourth starting time and a fourth duration.

In an embodiment, the first frame further solicits from the first AP a third period during which the first AP accepts to allow preemption, wherein the third period, comprising a third starting time and a third duration, is for allocation to the first AP.

In an embodiment, the second frame comprises the third period.

In an embodiment, the value of the second field indicates allowance of preemption of the third frame following the second frame within the first duration.

In an embodiment, the second field further indicates that preemption is allowed by the second AP only.

In an embodiment, the value of the second field indicates disallowance of preemption of the third frame following the second frame within the first duration.

In an embodiment, the second field further indicates that preemption is disallowed by a non-AP STA.

In an embodiment, the first frame comprises a management frame further comprising an action frame.

In an embodiment, the first frame comprises a control frame further comprising a trigger frame.

In an embodiment, the second frame comprises a management frame further comprising an action frame.

In an embodiment, the second frame comprises a data frame.

In an embodiment, the third frame comprises a data frame.

In an embodiment, process 3600 further comprises receiving, by the first AP from the second AP, a first indication of support by the second AP of a preemption coordination capability; and transmitting, by the first AP to the second AP, a second indication of support by the first AP of a preemption coordination capability.

In an embodiment, the first AP and the second AP form a multi-AP group.

In an embodiment, the first AP belongs to a basic service set (BSS) and the second AP belongs to an overlapping basic service set (OBSS) relative to the BSS.

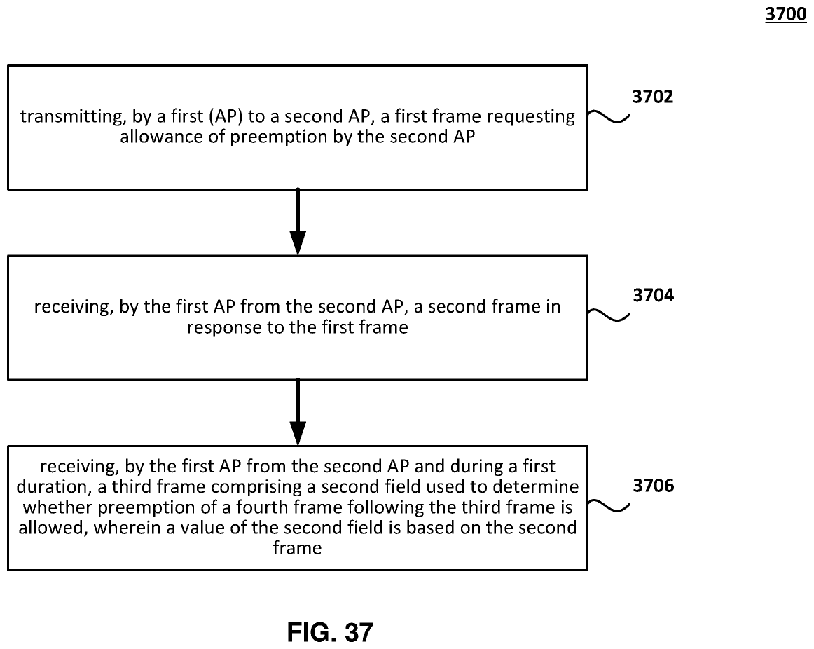

FIG. 37 illustrates an example process 3700 according to an embodiment. Example process 3700 is provided for the purpose of illustration only and is not limiting of embodiments. Process 3700 may be performed by a first AP.

As shown in FIG. 37, process 3700 begins in step 3702, which includes transmitting, by the first AP to a second AP, a first frame requesting allowance of preemption by the second AP.

In step 3704, process 3700 includes receiving, by the first AP from the second AP, a second frame in response to the first frame.

In step 3706, process 3700 includes receiving, by the first AP from the second AP and during a first duration, a third frame comprising a second field used to determine whether preemption of a fourth frame following the third frame is allowed. In an embodiment, a value of the second field is based on the second frame.

In an embodiment, process 3700 further comprises transmitting, by the first AP to the second AP, a fifth frame during a transmit opportunity (TXOP) obtained by the second AP. The fifth frame may comprise an allocation duration field indicating the first duration. The first duration may be allocated to the second AP and may be within the TXOP.

In an embodiment, the first duration is determined by the first AP based on the second frame.

In an embodiment, process 3700 further comprises receiving, by the first AP from the second AP and during the first duration, a sixth frame in response to the fifth frame.

In an embodiment, the first frame further requests that the second AP allows preemption by the first AP only.

In an embodiment, the first frame further indicates an identifier of the second AP.

In an embodiment, the first frame requests that the second AP allow preemption when the third frame is larger than a threshold.

In an embodiment, the first frame requests that the second AP allow preemption when the third frame is transmitted after the end of a first period.

In an embodiment, the first frame requests that the second AP allow preemption when the second AP does not return the first duration to the first AP earlier than the end of a second period.

In an embodiment, the first frame requests that the second AP allow preemption within a third period, wherein the third period comprises a third starting time and a third duration.

In an embodiment, the second frame accepts the request in response to the first frame.

In an embodiment, the second frame rejects the request in response to the first frame.

In an embodiment, the second frame further comprises a fourth period during which the second AP accepts to allow preemption, wherein the fourth period, comprising a fourth starting time and a fourth duration.

In an embodiment, the first frame further solicits from the second AP a third period during which the second AP accepts to allow preemption, wherein the third period, comprising a third starting time and a third duration, is for allocation to the second AP.

In an embodiment, the second frame comprises the third period.

In an embodiment, the value of the second field indicates allowance of preemption of the third frame following the second frame within the first duration.

In an embodiment, the second field further indicates that preemption is allowed by the first AP only.

In an embodiment, the value of the second field indicates disallowance of preemption of the third frame following the second frame within the first duration.

In an embodiment, the second field further indicates that preemption is disallowed by a non-AP STA.

In an embodiment, the first frame comprises a management frame further comprising an action frame.

In an embodiment, the first frame comprises a control frame further comprising a trigger frame.

In an embodiment, the second frame comprises a management frame further comprising an action frame.

In an embodiment, the second frame comprises a data frame.

In an embodiment, the third frame comprises a data frame.

In an embodiment, process 3700 further comprises transmitting, by the first AP to the second AP, a first indication of support by the first AP of a preemption coordination capability; and receiving, by the first AP from the second AP, a second indication of support by the second AP of a preemption coordination capability.

In an embodiment, the first AP and the second AP form a multi-AP group.

In an embodiment, the first AP belongs to a basic service set (BSS) and the second AP belongs to an overlapping basic service set (OBSS) relative to the BSS.

What is claimed is:

1. A first station (STA) comprising:
one or more processors; and
memory storing instructions that, when executed by the one or more processors, cause the first STA to:
transmit, by the first STA to a second STA, a first frame indicating that the first STA supports a first mode relating to transmission of low latency data;
receive, by the first STA from the second STA and in response to the first frame, a second frame indicating that the second STA supports the first mode;
receive, by the first STA from the second STA and based on the first STA supporting the first mode, a trigger frame comprising a first indication of whether the first STA is allowed to include, in a third frame, a second indication relating to low latency data;
transmit, by the first STA to the second STA and in response to the trigger frame, the third frame, wherein based on the first indication indicating the first STA is allowed to include the second indication relating to low latency data, the third frame comprises the second indication; and
transmit, by the first STA and after transmitting the third frame, a physical layer protocol data unit (PPDU) comprising data.

2. The first STA of claim 1, wherein the second indication indicates that the first STA has low latency data for transmission.

3. The first STA of claim 2, wherein the PPDU comprises the low latency data.

4. The first STA of claim 2, wherein the first STA receives the trigger frame during a transmission opportunity (TXOP) obtained by the second STA.

5. The first STA of claim 4, wherein the first STA transmits the PPDU during the TXOP obtained by the second STA.

6. The first STA of claim 5, wherein the first STA transmits the PPDU, during the TXOP obtained by the second STA, to one of: (i) the second STA or (ii) a peer-to-peer third STA.

7. The first STA of claim 6, wherein the second STA comprises an access point (AP).

8. A first station (STA) comprising:
one or more processors; and
memory storing instructions that, when executed by the one or more processors, cause the first STA to:
receive, by the first STA from a second STA, a first frame indicating that the second STA supports a first mode relating to transmission of low latency data;
transmit, by the first STA to the second STA and in response to the first frame, a second frame indicating that the first STA supports the first mode;
transmit, by the first STA to the second STA and based on the second STA supporting the first mode, a trigger frame comprising a first indication of whether the second STA is allowed to include, in a third frame, a second indication relating to low latency data; and
receive, by the first STA from the second STA and in response to the trigger frame, the third frame, wherein based on the first indication indicating the second STA is allowed to include the second indication relating to low latency data, the third frame comprises the second indication.

9. The first STA of claim 8, wherein the memory stores instructions that, when executed by the one or more processors, cause the first STA to: receive, from the second STA and after receiving the third frame, a physical layer protocol data unit (PPDU) comprising data.

10. The first STA of claim 9, wherein the second indication indicates that the second STA has low latency data for transmission.

11. The first STA of claim 10, wherein the PPDU comprises the low latency data.

12. The first STA of claim 10, wherein the memory stores instructions that, when executed by the one or more processors, cause the first STA to: obtain, by the first STA, a transmission opportunity (TXOP).

13. The first STA of claim 12, wherein the first STA transmits the trigger frame during the TXOP obtained by the first STA and wherein the first STA receives the PPDU during the TXOP.

14. The first STA of claim 13, wherein the first STA comprises an access point (AP).

15. A non-transitory computer-readable medium comprising instructions that, when executed by one or more processors of a first station (STA), cause the first STA to:
transmit, by the first STA to a second STA, a first frame indicating that the first STA supports a first mode relating to transmission of low latency data;
receive, by the first STA from the second STA and in response to the first frame, a second frame indicating that the second STA supports the first mode;
receive, by the first STA from the second STA and based on the first STA supporting the first mode, a trigger frame comprising a first indication of whether the first STA is allowed to include, in a third frame, a second indication relating to low latency data;
transmit, by the first STA to the second STA and in response to the trigger frame, the third frame, wherein based on the first indication indicating the first STA is allowed to include the second indication relating to low latency data, the third frame comprises the second indication; and
transmit, by the first STA and after transmitting the third frame, a physical layer protocol data unit (PPDU) comprising data.

16. The non-transitory computer-readable medium of claim 15, wherein the second indication indicates that the first STA has low latency data for transmission.

17. The non-transitory computer-readable medium of claim 16, wherein the PPDU comprises the low latency data.

18. The non-transitory computer-readable medium of claim 16, wherein the first STA receives the trigger frame during a transmission opportunity (TXOP) obtained by the second STA.

19. The non-transitory computer-readable medium of claim 18, wherein the first STA transmits the PPDU during the TXOP obtained by the second STA.

20. The non-transitory computer-readable medium of claim 19, wherein the first STA transmits the PPDU, during the TXOP obtained by the second STA, to one of: (i) the second STA or (ii) a peer-to-peer third STA.
